(19) United States
(12) Patent Application Publication
(10) Pub. No.: US 2008/0184930 A1
(43) Pub. Date: Aug. 7, 2008

(54) INK-JET RECORDING DEVICE

(76) Inventor: Koji FURUKAWA, Kanagawa (JP)

Correspondence Address: BIRCH STEWART KOLASCH & BIRCH, PO BOX 747, FALLS CHURCH, VA, 22040-0747, US

(21) Appl. No.: 12/023,942

(22) Filed: Jan. 31, 2008

(30) Foreign Application Priority Data
Feb. 1, 2007 (JP) 2007-023024
Feb. 1, 2007 (JP) 2007-023146

(51) Int. Cl. B05C 9/04

(52) U.S. Cl. 118/46; 118/642

(57) ABSTRACT

The ink-jet recording device includes a transport unit for transporting a recording medium, an undercoating liquid applying unit for applying an undercoating liquid to the transported recording medium and an image forming unit that is disposed downstream of the undercoating liquid applying unit in a direction of travel by the recording medium, and has an ink-jet head which ejects an ink containing at least a colorant to form an image on the recording medium to which the undercoating liquid has been applied. The undercoating liquid applying unit has a coating roll for applying the undercoating liquid to the recording medium, and a drive unit which rotates the coating roll in a direction opposite to the transporting direction of the recording medium.

### BACKGROUND OF THE INVENTION

The present invention relates to an ink-jet recording device which records images on a recording medium by ejecting ink droplets from an ink-jet head.

One method of forming images on a recording medium involves image formation by ejecting ink droplets from an ink-jet head.

Image recording devices which use an ink-jet head include, for example, the ink-jet recording device described in JP 2003-11341 A which employs an ink-jet recording method that entails printing an active light-curable compound-containing ink onto a recording medium by an ink-jet technique, then curing the ink. In this ink-jet recording method, image formation is carried out with inks of two or more colors. After all of the ink required for image formation has been ejected onto the recording medium, the image is irradiated with active light for up to 10 seconds.

JP 2003-11341 A also notes that any multi-channel ink-jet head known in the art may be used as the ink-jet head.

JP 2004-42525 A describes an ink-jet printer which has an ink-jot head that ejects onto a recording medium an ink which is curable by irradiation with active light, and has means for coating onto a recording medium by a technique other than an ink-jet technique a white ink that is curable by irradiation with active light. The printer is capable of continuously carrying out coating of the white ink and printing with the ink-jet head.

JP 2004-42525 A also describes an ink-jet printer which further includes a first irradiating means that irradiates active light for curing the white ink after the white ink has been coated onto the recording medium, and a second irradiating means that irradiates active light for curing the ink after the ink has been ejected onto the recording medium.

Methods that may be used for coating the white ink onto the recording medium include methods that involve spray coating, roll coating, gravure coating, air knife coating, extrusion coating, curtain coating, wire bar coating and felt coating.

### SUMMARY OF THE INVENTION

Here, as described in JP 2004-42525 A, by initially coating a white ink onto the surface of the recording medium, i.e., by initially forming a surface layer on the surface of the recording medium, then ejecting ink onto the recording medium on which the surface layer has been formed so as to form an image, it is possible to form an image having a good visibility even on translucent recording media, recording media having a low lightness and metal surfaces.

Moreover, as described in JP 2004-42525 A, by employing a method other than one using an ink-jet head to coat white ink onto the recording medium, a surface layer without conspicuous streaks can be formed in an even shorter period of time than when an ink-jet head is used.

Hence, by initially forming a surface layer of white ink or the like on the recording medium, it is possible to create an image having good visibility even on translucent recording media, recording media having a low degree of lightness and metal surfaces. However, in the coating method described in JP 2004-42525 A, coating the liquid evenly onto the recording medium so as to form a surface layer which is free of unevenness or has a reduced degree of unevenness is difficult.

When the surface layer formed on the recording medium is uneven, visibility at the surface of the recording medium may change from place to place. Specifically, changes in color may be observed depending on the position of the recording medium, or the recording medium may appear to be hazy. Such effects may make it impossible to produce high-quality and high-resolution prints.

This problem becomes especially acute when the recording medium is transported at a high velocity and/or the undercoating liquid has a high viscosity.

Although it is possible with the device described in JP 2004-42525 A to form an image having a good legibility even on translucent recording media, recording media having a low degree of lightness and metal surfaces, disruptions may occur in the images formed on the recording medium coated with white ink, making it impossible to record high-resolution images.

Moreover, when a liquid is coated over the entire surface of the recording medium and penetration of the liquid into the recording medium occurs, the color of the recording medium may vary from position to position thereon and areas where the liquid has penetrated may appear to be wet even after the liquid has been dried or cured. Such variations in the color of the recording medium and the presence of areas on the recording medium that appear to be wet also lower the quality of images formed on the recording medium. Problems of this sort are especially acute when recording media that are readily permeable to liquids are used.

It is therefore one object of the invention to provide an inexpensive ink-jet recording device which resolves the above-described problems in the existing art and is capable of creating high-resolution and high-quality prints at a high speed.

Another object of the invention is to provide an ink-jet recording device which, in addition to the foregoing object, is able to form high-resolution images on recording media, regardless of the particular type of recording medium.

A further object of the invention is to provide an ink-jet recording device which resolves the above-described problems in the existing art, which is able to form high-resolution images on various types of recording media, and which is capable of creating high-resolution and high-quality prints.

In order to achieve the above objects, a first aspect of the invention provides an ink-jet recording device comprising:

transport means for transporting a recording medium;

undercoating liquid applying means for applying an undercoating liquid to the recording medium transported by the transport means; and

image forming means that is disposed downstream of the undercoating liquid applying means in a direction of travel by the recording medium, and has an ink-jet head which ejects an ink containing at least a colorant to form an image on the recording medium to which the undercoating liquid has been applied;

wherein the undercoating liquid applying means has a coating roll for applying the undercoating liquid to the recording medium, and a drive unit which rotates the coating roll in a direction opposite to the direction in which the transport means transports the recording medium.

The drive unit preferably rotates the coating roll so as to satisfy a condition 0.5≦W/V≦5.0, where V is a velocity of travel in millimeters per second by the recording medium when passing through a position in proximity to the undercoating liquid applying means and W is a circumferential velocity in millimeters per second of the coating roll.

The coating roll preferably has on a surface thereof recessed features which retain the undercoating liquid.

Preferably, the ink-jet recording device further comprises positioning means which is disposed upstream or downstream or both upstream and downstream of the coating roll and on a side of the recording medium opposite to a side to be coated with the undercoating liquid, and which supports the recording medium from the side opposite to the side to be coated with the undercoating liquid.

It is preferable that the undercoating liquid be a liquid which cures on exposure to active energy rays, and that the device further comprise undercoating liquid semi-curing means which is disposed on a downstream side of the undercoating liquid applying means in the direction of travel by the recording medium, and which irradiates with active energy rays the undercoating liquid coated onto the recording medium so as to semi-cure the undercoating liquid coated onto the recording medium.

A travel distance X and a travel velocity V preferably satisfy a relation X≦5V, where X is the travel distance in millimeters that the recording medium is transported by the transport means from an undercoating liquid applying position where the undercoating liquid applying means applies the undercoating liquid to an irradiation position where the undercoating liquid is irradiated with the active energy rays emitted by the undercoating liquid semi-curing means, and V is the velocity of travel in millimeters per second by the recording medium between the undercoating liquid applying position and the irradiation position owing to the transport means.

In order to achieve the above objects, a second aspect of the invention provides an ink-jet recording device comprising:

transport means for transporting a recording medium;

undercoating liquid applying means for applying an undercoating liquid to be cured by exposure to active energy rays onto one side of the recording medium which is transported by the transport means;

undercoating liquid semi-curing means which is disposed downstream of the undercoating liquid applying means in a direction of travel by the recording medium, and which irradiates with the active energy rays the recording medium to which the undercoating liquid has been applied, thereby semi-curing the undercoating liquid applied to the recording medium; and

image forming means that is disposed downstream of the undercoating liquid semi-curing means in the direction of travel by the recording medium, and has an ink-jet head which ejects an ink containing at least a colorant to form an image on the recording medium to which the undercoating liquid has been applied;

wherein a travel distance X and a travel velocity V satisfy a relation X≦5V, where X is the travel distance in millimeters that the recording medium is transported by the transport means from an undercoating liquid applying position where the undercoating liquid applying means applies the undercoating liquid to an irradiation position where the undercoating liquid is irradiated with the active energy rays emitted by the undercoating liquid semi-curing means, and V is the velocity of travel in millimeters per second by the recording medium between the undercoating liquid applying position and the irradiation position owing to the transport means.

In the ink-jet recording device of the second aspect of the invention, when a liquid droplet having a viscosity of 10 mPa·s and a volume of 10 pL is deposited on the recording medium, a time required by an entire liquid droplet to pass through the recording medium is preferably at least 100 ms.

Preferably, the ink-jet recording device further comprises shielding means which is disposed between the undercoating liquid applying means and the undercoating liquid semi-curing means, and shields against the active energy rays which are irradiated front the undercoating liquid semi-curing means toward the undercoating liquid applying means.

In the ink-jet recording device according to each of the embodiments, it is preferable that the ink ejected from the ink-jet head be an ink which cures on exposure to the active energy rays, and that the image forming means further have image curing means which irradiates with the active energy rays the image formed on the recording medium and thereby cures the ink constituting the image.

It is preferable that the image forming means have at least two ink-jet heads which eject inks of differing colors, and that the ink-jet recording device further comprise ink semi-curing means which is disposed between the at least two ink-jet heads, and semi-cures ink constituting an image formed by one oaf the at least two ink-jet heads disposed upstream from the ink semi-curing means in the direction of travel by the recording medium.

The undercoating liquid preferably includes a radical-polymerizable composition.

According to the first aspect of the inventions an undercoating liquid can be rapidly and uniformly coated onto the surface of a recording medium. That is, there can be provided an ink-jet recording device which is capable of forming on a recording medium an undercoat having a low surface roughness, thus enabling the high-speed creation of prints obtained by recording high-resolution images on various recording media.

By irradiating the undercoating liquid with ultraviolet light, the undercoating liquid that has been coated onto the recording medium is semi-cured, enabling a high-resolution image to be formed on the recording medium.

According to the second aspect of the invention, undercoating liquid that has been coated onto the surface of a recording medium can be prevented from penetrating the recording medium, making it possible to prevent color irregularities, gloss unevenness and haze at the surface of the recording medium.

In addition, ink bleed by the ink droplets that have been ejected from the ink-jet head and deposited on the recording medium can be effectively prevented, making it possible to increase the image uniformity between various recording media and suppress problems such as non-uniform linewidth and color irregularities that arise due to the intermingling of droplets.

That is, the present invention can provide an ink-jet recording device which is able, regardless of the type of recording medium, to generate high-resolution and high-quality prints.

### BRIEF DESCRIPTION OF THE DRAWINGS

In the accompanying drawings:

FIG. 1 is a front view showing, in simplified form, an embodiment of an ink-jet recording device according to the invention;

FIG. 2 is a sectional view of a coating roll and a drive unit in the ink-jet recording device shown in FIG. 1;

FIG. 3 is a simplified perspective view of the vicinity of a positioning section in the ink-jet recording device shown in FIG. 1;

FIG. 4 is a top view of a recording head unit and UV irradiation units in the ink-jet recording device shown in FIG.

FIG. 5 is a schematic sectional view of a recording medium where ink drops have been deposited onto a semi-cured undercoating liquid;

FIGS. 6A and 6B are schematic sectional views of recording media where ink drops have been deposited onto an undercoating liquid that is in an uncured state;

FIG. 6C is a schematic sectional view of a recording medium where ink droplets have been deposited onto an undercoating liquid that is in a completely cured state;

FIG. 7 is a schematic sectional view of a recording medium where ink droplets have been deposited onto a semi-cured ink liquid;

FIGS. 8A and 8E are schematic sectional views of recording media where ink droplets have been deposited onto an ink liquid that is in an uncured state;

FIG. 8C is a schematic sectional view of a recording medium where ink droplets have been deposited onto an ink liquid that is in a completely cured state;

FIGS. 9A to 9D are schematic diagrams showing steps in the formation of an image on a recording medium;

FIG. 10 is a front view showing, in simplified form, another embodiment or an ink-jet recording device according to the invention;

FIG. 11 is a front view showing, in simplified form, a further embodiment of an ink-jet recording device according to the invention;

FIG. 12 is a front view showing, in simplified form; A still further embodiment of an ink-jet recording device according to the invention;

FIG. 13 is a front view showing an undercoat forming section, an undercoating liquid semi-curing section and their peripheral portions in the ink-jet recording device shown in FIG. 12;

FIGS. 14A to 14D are schematic diagrams showing steps in the formation of an image on a recording medium;

FIG. 15 is a front view showing, in simplified form, an embodiment of a digital label printer which uses the ink-jet recording device of the invention;

FIG. 16 is a block diagram depicting a control unit for controlling the digital label printer shown in FIG. 15;

FIG. 17 is a longitudinal sectional view of a recording medium for printing labels such as may be used in the digital label printer shown in FIG. 11;

FIG. 18 is a cross-sectional view of a die cutter having slitting blades arranged on a cylindrical surface thereof, and a perspective view showing the condition of slits made in a pressure-sensitive adhesive sheet by continuously rotating the die cutter;

FIG. 19 is a perspective view showing the condition of slits made in a pressure-sensitive adhesive sheet with the die cutter;

FIG. 20 is a front view showing, in simplified form, another embodiment of a digital label printer which employs the ink-jet recording device according to the invention;

FIG. 21 is a block diagram depicting a control unit for controlling the digital label printer shown in FIG. 20; and

FIG. 22 is a front view showing, in simplified form, yet another embodiment of a digital label printer which uses the ink-jet recording device of the invention.

### DETAILED DESCRIPTION OF TEE INVENTION

The ink-jet recording devices according to the present invention are described more fully below based on the embodiments shown in the accompanying diagrams.

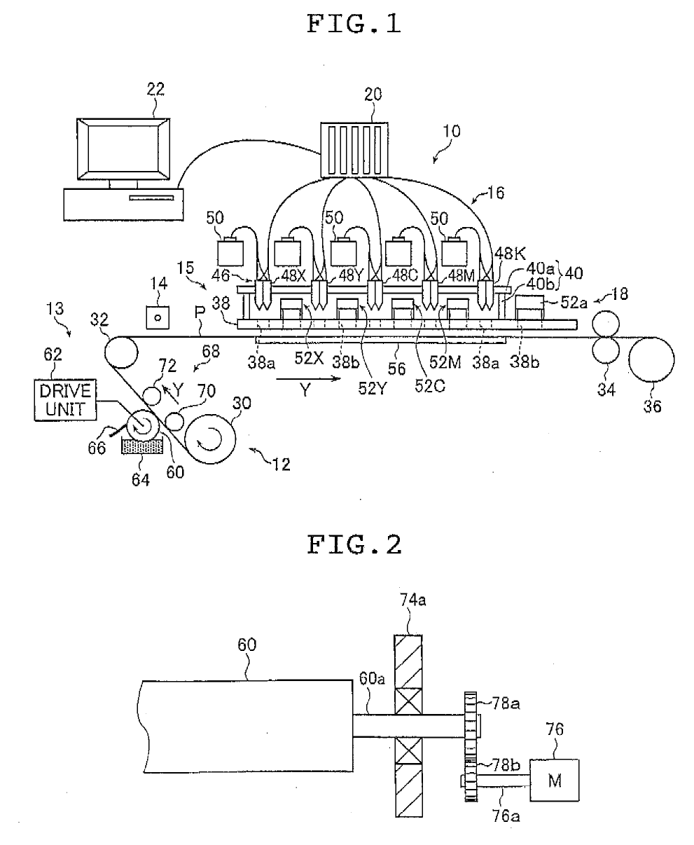

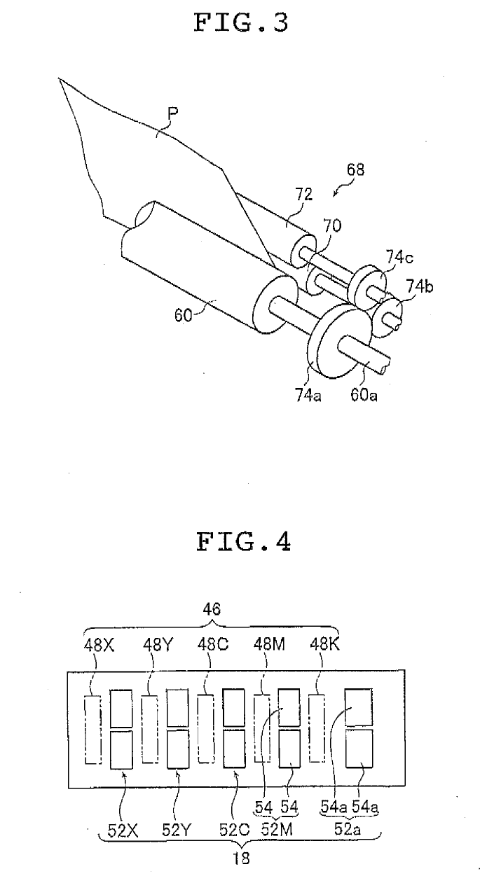

FIG. 1 is a front view showing, in simplified form an embodiment of an ink-jet recording device 10 according to the present invention FIG. 2 is a simplified sectional view of the vicinity of a coating roll 60 and a drive unit 62 in an undercoat forming section 13 of the ink-jet recording device 10 shown in FIG. 1. FIG. 3 is a simplified perspective view of the vicinity of the coating roll 60 and a positioning unit 68 in the undercoat forming section 13 of the ink-jet recording device 10 shown in FIG. 1. FIG. 4 is a top view of a recording head unit 46 and UV irradiation units 52X, 52Y, 52C, 52M of the ink-jet recording device 10 shown in FIG. 1.

In the aspects of the invention discussed below, active light-curable ink-jet recording devices which use an ultraviolet light-curable ink (UV-curable ink) as the active light-curable ink (also referred to as “active energy ray-curable ink”) that cures under irradiation with active light (also referred to as “active energy rays”) are described as embodiments. However, the invention is not limited to these embodiments, and may apply to ink-jet recording devices in which various types of active light-curable inks are used.

As shown in FIG. 1, the ink-jet recording device 10 has a transport section 12 which transports a recording medium P, the undercoat forming section 13 which coats an undercoating liquid onto the recording medium P, an undercoating liquid semi-curing section 14 which semi-cures the undercoating liquid that has been coated onto the recording medium P, a support section 15 disposed opposite a path of travel by the recording medium P which is transported by the transport section 12, an image recording section 16 which is supported by the support section 15 and which records an image on the recording medium r, an image fixing section 18 which is supported by the support section 15 and which fixes the image recorded on the recording medium P, and a control unit 20 which controls the ejection of ink droplets from the image recording section 16.

An input unit 22 is connected to the control unit 20 of the ink-jet recording device 10. The input unit 22 may be an image reading unit such as a scanner or any of various types of devices which transmit image data, including image processing devices such as a personal computer. Any of various connection methods, whether wired or wireless, may be used to connect the input unit 22 and the control unit 20.

The transport section 12, which has a feed roll 30, a transport roll 32, a transport roller pair 34 and a recovery roll 36, feeds, transports and recovers the recording medium P.

The feed roll 30 has a web-type recording medium P wrapped thereon in the form of a roll, and feeds the recording medium P.

The transport roll 32 is disposed on the downstream side of the feed roll 30 in the direction of travel by the recording medium P, and transports the recording medium P that has been let out from the feed roll 30 to the downstream side in the direction of travel.

The transport roller pair 34 is a pair of rollers which are disposed on the downstream side of the transport roll 32 in the travel path of the recording medium P and which grip therebetween the recording medium P that has passed around the transport roll 32 and transport it to the downstream side in the direction of travel.

The recovery roll 36 is disposed the furthest downstream on the travel path of the recording medium P The recovery roll 36 takes up the recording medium P which has been fed from the feed roll 30, has been transported by the transport roll 32 and the transport roller pair 34, and has passed through positions facing the subsequently described undercoat forming section 13, undercoating liquid semi-curing section 14, image recording section 16 and image fixing section 18.

Here, the transport roll 32, the transport roller pair 34 and the recovery roll 36 are connected to drive units (not shown) and rotated by the drive units.

Here, the transport roll 32 is disposed above the feed roll 30 in a vertical direction, and at a position farther from the recovery roll 36 than from the feed roll 30 in a horizontal direction. Moreover, the transport roll 32, the transport roller pair 34 and the recovery roll 36 are disposed linearly in a direction parallel to the horizontal direction.

That is, the transport section 12 transports the recording medium P upward while inclined at a given angle with respect to the vertical direction toward the side away from the recovery roll 36, following which the transport section 12 changes the direction of travel by the recording medium P at the transport roll 32 so that, after the recording medium P has passed the transport roll 32, it is transported horizontally toward the recovery roll 36. In other words, after the recording medium P has been let out from the feed roll 30, it is moved in an upwardly inclined direction with the surface on which images are to be recorded facing downward. After passing around the transport roll 32, the recording medium P is moved in a horizontal direction with the surface on which images are to be recorded facing upward.

The undercoat forming section 13 is situated between the feed roll 30 and the transport roll 32; that is, on the downstream side of the feed roll 30 and on the upstream side of the transport roll 32 in the direction of travel by the recording medium P.

The undercoat forming section 13 has the coating roll 60 for coating an undercoating liquid onto the recording medium P, a drive unit 62 which drives the coating roll 60, a reservoir 64 which supplies the undercoating liquid to the coating roll 60, a blade 66 which adjusts the amount of undercoating liquid picked up by the coating roll 60, and the positioning unit 68 which supports the recording medium P so that the recording medium P assumes a predetermined position relative to the coating roll 60.

The coating roll 60 is disposed between the teed roll 30 and the transport roll 32 so as to be in touching contact with the surface of the recording medium P on which images are to be formed. That is, the coating roll 60 is in touching contact with the downwardly facing surface of the recording medium P being transported from the feed roll 30 to the transport roll 32.

The coating roll 60, which is a roll that is longer than the width of the recording medium P, is a so-called gravure roller on the surface (peripheral face) of which recessed features are formed at fixed, i.e., uniform, intervals.

Here, the shapes of the recessed features formed on the coating roll 60 are not subject to any particular limitation. Any of various shapes may be used, including round, rectangular, polygonal or star-like shapes. Alternatively, the recessed features may be formed as grooves extending over the entire circumference of the coating roll.

The drive unit 62, as shown in FIG. 2, has a motor 76, and first and second gears 78a and 78b which transmit rotation by the motor 76 to the coating roll 60.

As shown in FIG. 2, the first gear 78a is mounted on a shaft 60a of the coating roll 60, and the second gear 78b is mounted on a rotary shaft 76a of the motor 76. The respective gears rotate together with the respective shafts. Moreover, the first gear 78a and the second gear 78b are disposed at positions where the teeth on one gear mesh with the teeth on the other gear.

By means of the foregoing arrangement, the drive unit 62 causes the motor 76 to rotate, in turn causing the second gear 78b mounted on the rotary shaft 76a to rotate, which rotation is transmitted to the first gear 78a. Rotation of the first gear 70a causes the shaft 60a having the first gear 78a mounted thereon, and in turn the coating roll 60, to rotate.

The drive unit 62 thus rotates the coating roll 60.

However, the drive unit 62 is not limited to the present embodiment. Any of various other drive mechanisms may instead be used to rotate the coating roll 60, including pulley driving, belt driving and direct driving.

As indicated by the arrow in FIG. 1, the drive unit 62 causes the coating roll 60 to rotate in the direction opposite to the direction of travel by the recording medium P at the contact point therebetween (i.e., in the clockwise direction in FIG. 1). This will be explained later.

The reservoir 64 has a dish-like shape open at the top, and holds at the interior thereof the undercoating liquid. The reservoir 64 is disposed underneath and adjacent to the coating roll 60, such that a portion of the coating roll 60 is immersed in the undercoating liquid held within the reservoir 64. When necessary, the undercoating liquid is fed to the reservoir 64 from a feed tank (not shown).

The blade 66 is disposed so as to be in touching contact with the surface of the coating roll 60. More specifically, the blade 66 is disposed, in the direction of rotation by the coating roll 60, on the downstream side of the reservoir 64 and on the upstream side of the recording medium P.

That is, the blade 66 comes into contact with a portion of the coating roll 60 that has been immersed in the reservoir 64, before that portion comes into contact with the recording medium P.

The blade 66 scrapes off that portion of the undercoating liquid picked up by the coating roll 60 when immersed in the reservoir 64 which is not needed, thereby setting the quantity of undercoating liquid adhering to the coating roll 60 to a fixed amount. Specifically, except for the undercoating liquid retained in the recessed features formed on the surface of the coating roll 60, the blade 66 scrapes off undercoating liquid adhering to other portions of the coating roll 60. That is, the blade 66 scrapes off undercoating liquid adhering to areas of the coating roll 60 other than the recessed features (i.e., surplus undercoating liquid).

The undercoating liquid retained in the portion of the coating roll 60 which comes into contact with the recording medium P can in this way be limited to only the undercoating liquid retained in the recessed features, thus enabling the amount of undercoating liquid which comes into contact with the recording medium P to be made constant.

The positioning unit 68 has a first positioning roll 70 and a second positioning roll 72, and supports the recording medium P in such a way as to ensure that the recording medium P comes into contact with the coating roll 60 at a specific position. That is, the positioning unit 68 sets the travel path of the recording medium P where the coating roll 60 and the recording medium P come into contact to a specific position.

The first positioning roll 70 is situated on the opposite side of the recording medium P from the side where images are to be formed (i.e., the side to be coated with undercoating liquid) and, in the direction of travel by the recording medium P, between the feed roll 30 and the coating roll 60.

The second positioning roll 72 is situated on the opposite side of the recording medium P from the side where images are to be formed and, in the direction of travel by the recording medium P, between the coating roll 60 and the transport roll 32.

Hence, the first and second positioning rolls 70 and 72 are each situated on the opposite side of the recording medium P from the coating roll 60 and, in the direction of travel by the recording medium P, on either side of the coating roll 60; that is, one is situated on the upstream side, and the other is situated on the downstream side, of the coating roll 60.

These first and second positioning rolls 70 and 72 support the recording medium P from the side of the recording medium P opposite to the side on which images are to be formed.

Here, in the undercoat terming section 13 of the present embodiment, as shown in FIG. 3, a first bearing 74a which supports the shaft 60a of the coating roll 60 is in contact with a second bearing 74b which supports the shaft of the first positioning roll 70. In addition, the first bearing 74a is in contact with a third bearing 74c which supports the shaft of the second positioning roll 72.

By thus placing the bearings 74a, 74b and 74c which respectively support the coating roll 60, the first positioning roll 70 and the second positioning roll 72 in mutual contact, departures from the correct positional relationships between the coating roll 60 and the positioning rolls 70 and 72 can be prevented from occurring.

Moreover, even in cases where any one, or all, of the coating roll 60, the first positioning roll 70 and the second positioning roll 72 are placed in a movable state, by adopting an arrangement in which the bearings are placed in mutual contact, departures from the correct positional relationships between the coating roll 60 and the positioning rolls 70 and 72 can be prevented from occurring.

In the present embodiment, the bearings have been placed in mutual contact. However, the invention is not limited in this regard. That is, use may be made of any arrangement in which members that individually support, respectively, the coating roll 60 and the first and second positioning rolls 70 and 72 are placed in mutual contact. For example, an arrangement may be used wherein fixing members which fix in place the bearings are placed in mutual contact.

In the foregoing arrangement of the undercoat forming section 13, the drive unit 62 causes the coating roll 60 to rotate in the direction opposite to the direction of travel by the recording medium P. After being immersed in the undercoating liquid which has accumulated in the reservoir 64, the surface of the rotating coating roll 60 comes into touching contact with the blade 66, thereby setting the amount of undercoating liquid retained on the surface to a fixed amount, then comes into contact with the recording medium P, thereby coating the undercoating liquid onto the recording medium P. By thus rotating the coating roll 60 in the direction opposite to the direction of travel by the recording medium P and coating the undercoating liquid onto the recording medium P, a layer of undercoating liquid (referred to below as the “undercoat”) that has been smoothened and has a good, even, coating surface state can be formed on the recording medium P. This is explained in greater detail later.

The coating roll 60 which has come into contact with the recording medium P is further rotated and again immersed within the undercoating liquid in the reservoir 64.

In this way, the undercoat forming section 13, by rotating the coating roll 60 and coating the undercoating liquid onto the surface of the recording medium P, forms an undercoat on the surface of the recording medium P.

Next, the undercoating liquid semi-curing section 14 is described.

The undercoating liquid semi-curing section 14 has a UV lamp and is disposed so as to face the travel path of the recording medium P. Here, the UV lamp is a light source which emits ultraviolet light. Examples of UV light sources that may be used include metal halide lamps and high-pressure mercury vapor lamps.

The undercoating liquid semi-curing section 14 irradiates the entire width of the recording medium P which passes through a position opposed thereto with UV light.

The undercoating liquid semi-curing section 14 exposes to UV light the recording medium P which has been coated on the surface with the undercoating liquid and passes through a position opposed thereto, thereby rendering the undercoating liquid coated onto the surface of the recording medium P into a semi-cured state. That is, the undercoating liquid semi-curing section 14 renders the undercoating liquid that has been coated onto the recording medium P into a semi-cured state.

In the practice of the invention, the term “semi-cured” as used herein signifies partial curing, and refers to the undercoating liquid in a partially cured, i.e., an incompletely cured, state. When the undercoating liquid that has been applied onto the recording medium (base material) P is semi-cured, the degree of curing may be non-uniform; preferably, the degree of curing proceeds in the depth direction of the undercoating liquid. In the present embodiment, the undercoating liquid which is semi-cured is an undercoating liquid which forms an undercoat.

For example, when a radical-polymerizable undercoating liquid is cured in air or air that is partially substituted with an inert gas, due to the radial polymerization-suppressing effect of oxygen, radical polymerization tends to be inhibited at the surface of the undercoating liquid. As a result, semi-curing is non-uniform, there being a tendency for curing to proceed at the interior of the undercoating liquid and to be delayed at the surface.

In the practice of the invention, by using a radical-photopolymerizable undercoating liquid in the presence of oxygen which tends to inhibit radical polymerization, the undercoating liquid partially photocures, enabling the degree of cure of the undercoating liquid to be higher at the interior than at the exterior.

Alternatively, in cases where a cationic-polymerizable undercoating liquid is cured in air containing humidity, because moisture has a cationic polymerization-inhibiting effect, there is a tendency for curing to proceed at the interior of the undercoating liquid and to be delayed at the surface.

It is likewise possible for the degree of cure in the undercoating liquid to be made higher at the interior than at the exterior by using this cationic-polymerizable undercoating liquid under humid conditions that have a cationic polymerization-inhibiting effect so as to induce partial photocuring.

By thus semi-curing the undercoating liquid and depositing ink droplets on the semi-cured undercoating liquid, technical effects that are advantageous for the quality of the resulting print can be achieved. The mechanism of action can be confirmed by examining a cross-section of the print.

The semi-curing of the undercoating liquid (i.e., the undercoat formed of undercoating liquid on the recording medium) is described in detail below. As one illustration, high-density areas obtained by depositing about 12 pL of liquid ink (that is, droplets of ink) on the undercoating liquid in a semi-cured state having a thickness of about 5 μm that has been provided on a recording medium P are described below.

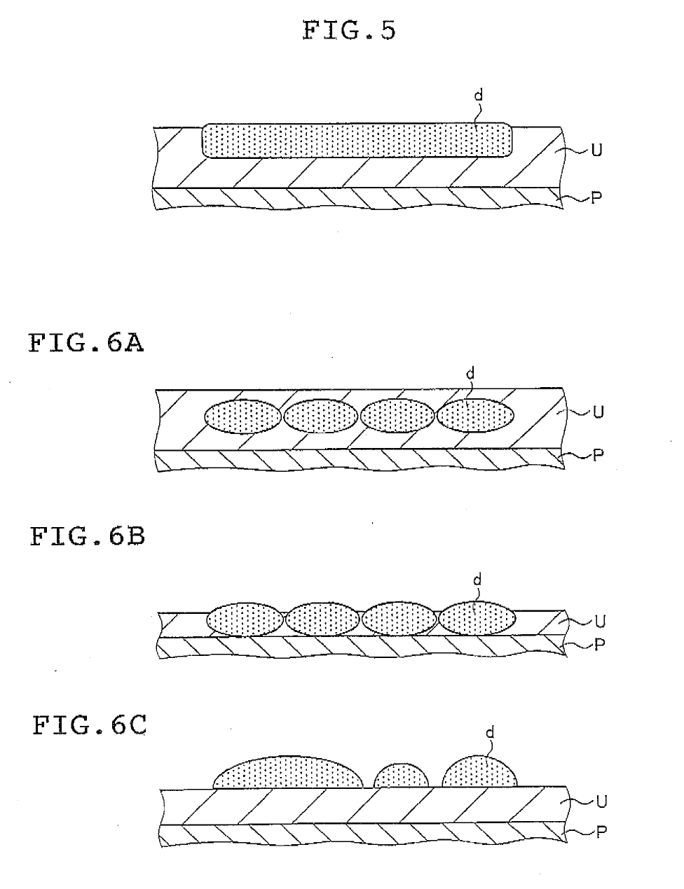

FIG. 5 is a schematic sectional view of a recording medium where ink droplets have been deposited onto a semi-cured undercoating liquid. FIGS. 6A and 6B are schematic sectional views of recording media where ink droplets have been deposited onto an undercoating liquid that is in an uncured state, and FIG. 6C is a schematic sectional view of a recording medium where ink droplets have been deposited onto an undercoating liquid that is in a completely cured state.

When the undercoating liquid is semi-cured according to the invention, the degree of cure on the recording medium P side is higher than the degree of cure at the surface layer. In this case, three features are observable. That is, as shown in FIG. 5, when ink d is deposited as droplets on a semi-cured undercoating liquid U, (1) a portion of the ink d emerges at the surface of the undercoating liquid U, (2) a portion of the ink d lies within the undercoating liquid U, and (3) the undercoating liquid is present between the bottom side of the ink d and the recording medium P.

When the ink d is deposited on the undercoating liquid U, if the undercoating liquid U and the ink d satisfy the above states (1), (2) and (3), the undercoating liquid U can be regarded as being in a semi-cured state.

By semi-curing the undercoating liquid U, that is, by curing the undercoating liquid U so that it satisfies above (1), (2) and (3), the droplets of ink d (i.e., the ink droplets) which have been deposited to a high density mutually connect, forming a film of the ink d (i.e., an ink film or ink layer), and thus providing a uniform and high color density.

By contrast, when the ink is deposited on the undercoating liquid which is in an uncured state, either or both of the following occurs: all of the ink d lies within the undercoating liquid U as shown in FIG. 6A; a state arises where, as shown in FIG. 6B, the undercoating liquid U is not present below the ink d.

In this case, even when the ink is applied to a high density, the liquid droplets are mutually independent, causing the color density to decrease.

When the ink is deposited on an undercoating liquid that is completely cured, as shown in FIG. 6C, a state will arise where the ink d does not lie within the undercoating liquid U.

In this case, interference in the deposition of the droplets arises, as a result of which a uniform ink film cannot be formed and a high color reproducibility cannot be achieved (i.e., this leads to a decrease in color reproducibility).

Here, when the droplets of ink are applied to a high density, the droplets are not independent of each other. To form a uniform ink film, and also to suppress the occurrence of deposition interference, the quantity of regions where the undercoating liquid (i.e., the undercoat) is uncured per unit surface area is preferably smaller, and more preferably substantially smaller, than the maximum quantity of droplets of ink applied per unit surface area. That is, the relationship between the weight Mᵤ (also referred to as M_{undercoating liquid}) of uncured regions of the undercoat per unit surface area and the maximum weight mᵢ (also referred to as mᵢₙₖ) of the ink ejected per unit surface area preferably satisfies the condition (mᵢ/30)<Mᵤ, <mᵢ, more preferably satisfies the condition (mᵢ/20)<Mᵤ<(mᵢ/3), and most preferably satisfies the condition (mᵢ/10)<Mᵤ<(mᵢ/5). As used herein, the “maximum weight of the ink ejected per unit surface area” refers to the maximum weight per color.

By letting (mᵢ/30)<Mᵤ, deposition interference can be prevented from occurring. Moreover, a high dot size reproducibility can be achieved. By letting Mᵤ<mᵢ, the ink film can be uniformly formed and a decrease in density can be prevented.

Here, the weight of uncured regions of the undercoating liquid per unit surface area is determined by a transfer test. Specifically, after completion of the semi-curing step (e.g., after exposure to active energy rays) and before deposition of the ink droplets, a permeable medium such as plain paper is pressed against the undercoating liquid which is in a semi-cured state, and the amount of the undercoating liquid that transfers to the permeable medium is determined by weight measurement. The measured value is defined as the weight of the uncured regions of the undercoating liquid.

For example, if the maximum amount of ink ejected is set to 12 picoliters per pixel at a deposition density of 600×600 dpi, the maximum weight mᵢ of the ink ejected per unit surface area becomes 0.04 g/cm² (assuming the density of the ink is about 1.1 g/cm³). Therefore, in this case, the weight Mᵤ per unit surface area of uncured regions of the undercoating liquid is preferably greater than 0.0013 g/cm² but less than 0.04 g/cm², more preferably greater than 0.002 g/cm² but less than 0.013 g/cm², and most preferably greater than 0.004 g/cm² but less than 0.008 g/cm².

Next, the support section 15, the image recording section 16 and the image fixing section 18 are described.

The support section 15, which has a body plate 38 and a head plate 40, supports the image recording section 16 and the image fixing section 10.

The body plate 38 is a plate-like member which is situated between the transport roll 32 and the transport roller pair 34, and is parallel to and spaced at a given interval from the travel path of the recording medium P. In other words, the body plate 38 is disposed at a position facing the side of the recording medium P transported by the transport section 12 on which images are to be recorded (also referred to below as the “image recording side”).

The body plate 38 has openings 38a formed therein at positions facing respective recording heads 48X, 48Y, 43C, 48M and 43K in the subsequently described image recording section 16, and has openings 38b formed therein at positions opposite respective UV irradiators 54 and 54a in the subsequently described image fixing section 18.

The head plate 40, which has a plate member 40a and legs 40b, is disposed on the opposite side of the body plate 38 from the side where the recording medium P is located and is coupled to the body plate 38.

The plate member 40a is arranged at a given interval on the opposite side of the body plate 38 from the recording medium P side, and holds the recording heads 48X, 48Y, 48C, 48M and 48K of the subsequently described image recording section 16. The legs 40b are situated at the four corners of the plate member 40a, and are coupled to the body plate 38.

The image recording section 16 has a recording head unit 46 and ink tanks 50.

The recording head unit 46 has the recording heads 48X, 48Y, 48C, 48M and 48K.

The recording heads 48X, 48Y, 48C, 48M and 483E are arranged in this order from the upstream side to the downstream side in the direction of travel by the recording medium P. Moreover, the recording heads 48X, 48Y, 48C, 48M and 48K are held by the head plate 40, also, the tips of the respective ink ejection portions are disposed so as to face the path of travel by the recording medium P; that is, so as to face the recording medium P which is transported over the travel path by the transport section 12 (also referred to below as simply “facing the recording medium P”).

The recording heads 48X, 48Y, 48C, 40M and 48K are full-line, piezoelectric ink-jet heads in which a plurality of orifices (nozzles, ink ejection portions) are arranged at fixed intervals throughout in a direction perpendicular to the direction of travel by the recording medium P, that is, over the entire width of the recording medium P. These recording heads are connected to the subsequently described control unit 20 and the ink tanks 50. The amount of ink droplets ejected by the recording heads 48K, 48Y, 48C, 48M and 48K and the ejection timing of the droplets are controlled by the control unit 20.

A color image can be formed on the recording medium P by ejecting inks of various colors—special color (X), yellow (Y) cyan (C), magenta (M) and black (K)—from the respective recording heads 48X, 48Y, 48C, 48M and 48K toward the recording medium P while at the same time having the transport section 12 transport the recording medium P.

In the present embodiment, the recording heads are piezoelectric (piezo) elements. However, the invention is not limited in this regard. Any of various types of systems may be used in place of a piezo system, such as a thermal jet system which uses a heating element such as a heater to heat the ink and generate bubbles. In this latter system, the pressure of the bubbles propels the droplets of ink.

Any of various inks, such as white, orange, violet or green ink may be used as the special colored ink discharged from the recording head 48X.

The inks ejected from the recording heads in the present embodiment are UV-curable inks.

The ink tanks 50 are provided for the recording heads 48X, 48Y, 48C, 48M and 48K. The respective ink tanks 50 store inks of various colors for the recording heads, and supplies the stored inks to the corresponding recording heads 48X, 48Y, 48C, 48M and 48K.

In addition, a tabular platen 56 is disposed at a position facing the recording heads 48X, 48Y, 48C, 48M and 48K on the side of the recording medium P where images will not be formed.

The platen 56 supports the recording medium P which is transported through positions facing the respective recording heads from the side of the recording medium P on which images will not be formed; that is, from the opposite side of the recording medium P to that on which the recording head unit 46 is disposed. In this way, the distance between the recording medium P and the respective recording heads can be made constant, enabling high-resolution images to be formed on the recording medium P.

The shape of the platen 56 is not limited to a flat plate, and may have a raised, curved surface shape on the recording head side. In such a case, the recording heads 48X, 48Y, 48C, 48M and 48K are disposed at fixed distances from the platen.

The image raining section 18, which has the UV irradiation units 52X, 52Y, 52C and 52M, and a final UV irradiation unit for curing 52a, irradiates UV light onto the image formed on the recording medium P by the recording head unit 46, thereby semi-curing or curing the image (that is, the ink), and thus fixing the image.

In the practice of the invention, as in the case of the undercoating liquid, “semi-curing the ink” signifies partial curing, and refers to a state where the liquid ink (i.e., ink, colored liquid) is in a partially cured, but not a completely cured, state. When the ink liquid ejected onto the undercoating liquid is semi-cured, the degree of cure may be non-uniform; preferably, the degree of curing proceeds in the depth direction of the ink liquid. In the present embodiment, the ink that is to be semi-cured is in the form of ink droplets which land on the undercoat or recording medium and form an ink layer.

When this ink is semi-cured and an ink of a different hue is deposited on top of the semi-cured ink, there can be achieved a technical effect which is advantageous to the quality of the resulting print. The mechanism of action may be confirmed by examining a cross-section of the print.

Semi-curing of the ink (i.e., the ink droplets which have landed on the recording medium or the undercoat, or the ink layer formed from ink droplets which have landed) is explained below.

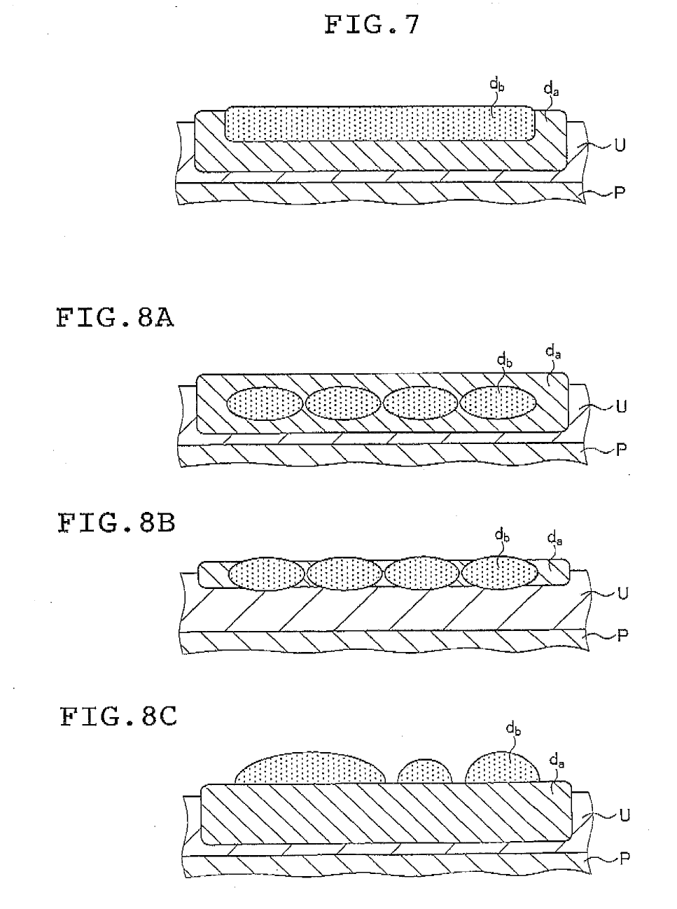

FIG. 7 is a schematic sectional view of a recording medium where a second ink d_{b} has been deposited onto a semi-cured first ink do. FIGS. 5A and 5B are schematic sectional views of recording media where droplets of the second ink d_{b} have been deposited onto the first ink dₐ that is in an uncured state, and FIG. 8C is a schematic sectional view of a recording medium where droplets of the second ink d_{b} have been deposited onto the first ink dₐ that is in a completely cured state.

When a secondary color is formed by depositing droplets of the second ink d_{b} onto the first ink dₐ that has been earlier deposited as droplets, it is preferable to apply the second ink d_{b} onto the first ink dₐ with the latter in a semi-cured state.

Here, the “semi-cured state” of the first ink dₐ is similar to the above-described semi-cured state of the undercoating liquid. As shown in FIG. 7, this is a state where, when the second ink d_{b} is deposited as droplets onto the first ink dₐ, (1) a portion of the second ink d_{b} emerges at the surface of the first ink dₐ, (2) a portion of the second ink d_{b} lies within the first ink dₐ, and (3) the first ink dₐ is present below the second ink d_{b}.

By semi-curing the ink in this way, a cured film (colored film A) of the first ink dₐ and a cured film (colored film B) of the second ink d_{b} can be suitably superimposed, enabling good color reproduction to be achieved.

By contrast, when the second ink d_{b} is deposited as droplets on the first ink dₐ with the latter in an uncured state, either or both of the following occurs: all of the second ink d_{b} lies within the first ink dₐ as shown in FIG. 8A; a state arises where, as shown in FIG. 8B, the first ink dₐ, is not present below the second ink d_{b}. In this case, even when the second ink d_{b} is applied to a high density, the droplets are independent of each other, causing the color saturation of the secondary color to decrease.

When the second ink d_{b} is deposited as droplets on the first ink dₐ which is completely cured, as shown in FIG. 5C, a state will arise where the second ink d_{b} does not lie within the first ink dₐ. This causes interference in the deposition of the droplets to arise, as a result of which a uniform ink film cannot be formed, leading to a decline in color reproducibility.

Here, when the droplets of the second ink d_{b} are applied to a high density, the droplets are not independent of each other. To form a uniform film of the second ink die and also to suppress the occurrence of deposition interference, the quantity of regions where the first ink dₐ is uncured per unit surface area is preferably smaller, and more preferably substantially smaller, than the maximum quantity of droplets of the second ink d_{b} applied thereon per unit surface area. That is, the relationship between the weight M_{da} (also referred to as M_{ink A}) of uncured regions of the first ink dₐ layer per unit surface area and the maximum weight max (also referred to as m_{ink B}) of the second ink d_{b} ejected thereon per unit surface area preferably satisfies the condition (m_{db}/30)<M_{da}<m_{db}, more preferably satisfies the condition (m_{db}/20)<M_{da}<(m_{db}/3), and most preferably satisfies the condition (m_{db}/10)<M_{da}<(m_{db}/5).

By letting (m_{db}/30)<M_{da}, deposition interference can be prevented from occurring. Moreover, a high dot size reproducibility can be achieved. By letting M_{da}<m_{db}, a film of the first ink dₐ can be uniformly formed and a decrease in density can be prevented.

Here, as in the case of the undercoating liquid described above, the weight of the uncured regions of the first ink dₐ per unit surface area is determined by a transfer test. Specifically, after completion of the semi-curing step (e.g., after exposure to active energy rays) and before deposition of the droplets of the second ink d_{b}, a permeable medium such as plain paper is pressed against the layer of the first ink dₐ which is in a semi-cured state, and the quantity of the first ink dₐ that transfers to the permeable medium is determined by weight measurement. The measured value is defined as the weight of the uncured regions of the ink liquid.

For example, if the maximum amount of the second ink d_{b} ejected is set to 12 picoliters per pixel at a deposition density of 600×600 dpi, the maximum weight m_{db} of the second ink d_{b} ejected per unit surface area becomes 0.04 g/cm² (assuming the density of the second ink d_{b} to be about 1.1 g/cm³). Therefore, in this case, the weight M_{da} per unit surface area of uncured regions of the first ink dₐ layer is preferably greater than 0.0013 g/cm² but less than 0.04 g/cm², more preferably greater than 0.002 g/m² but less than 0.013 g/cm², and most preferably greater than 0.004 g/cm² but less than 0.008 g/cm².

The UV irradiation units 52X, 52Y, 52C and 52M are disposed on the opposite side of the body plate 38 from the recording medium P, and on the downstream sides of the respective recording heads 48X, 48Y, 48C and 46M along the travel path of the recording medium P. In addition, the final UV irradiation unit for curing 52a is disposed on the opposite side of the body plate 38 from the recording medium P, and on the downstream side of the recording head 48K along the travel path of the recording medium P. That is, the final UV irradiation unit for curing 52a is positioned on the downstream side of the recording head situated the furthest downstream of all the recording heads along the travel path of the recording medium P.

In other words, as shown in FIG. 4, the respective recording heads 48X, 48Y, 48C, 48M and 40K, the respective UV irradiation units 52X, 52Y, 52C and 52M, and the final UV irradiation unit for curing 52a are disposed in the following order, from the upstream to the downstream side of the travel path: recording head 48X, UV irradiation unit 52X, recording head 48Y, UV irradiation unit 52Y, recording head 48C, UV irradiation unit 52C, recording head 48M, UV irradiation unit 52M, recording head 48K, final UV irradiation unit for curing 52a.

Here, the UV irradiation units 52X, 52Y, 52C and 52M and the final UV irradiation unit for curing 52a differ only in the size of the units and the target to be irradiated with UV light. Specifically, the UV irradiation units 52X, 52Y, 52C and 52M cure the images formed by the respective recording heads, whereas the final UV irradiation unit for curing 52a differs only in that it irradiates higher intensity light than the other UV irradiation units so as to reliably cure both the undercoating liquid coated onto the recording medium P and images of all the respective inks. Because the final UV irradiation unit for curing 52a has the same basic construction as the UV irradiation units 52X, 52Y, 52C and 52M, the description given below for the UV irradiation unit 52X applies collectively to all of the above UV irradiation units, including the final UV irradiation unit for curing 52a.

Referring to FIG. 4, the UV irradiation unit 52X has two UV irradiators 54. The UV irradiators 54 are disposed serially in a straight line in the width direction of the recording medium P. The UV irradiation unit 52X irradiates the entire width of the recording medium P with UV light from the two UV irradiators 54.

The UV irradiators 54 have UV lamps and are disposed on the opposite side of the body plate 38 from the recording medium P so as to face the travel path by the recording medium P.

The UV lamps are ultraviolet light-emitting light sources which face the recording medium P side and irradiate the recording medium P with UV light, Examples of UV lamps which may be used for this purpose include various UV light sources, such as metal halide lamps and high-pressure mercury vapor lamps.

The UV lamps are situated at positions which face the openings 38b in the body plate 38. UV light emitted from the UV lamps passes through the openings 38b and reaches the recording medium P.

The control unit 20 is connected to the respective recording heads 48X, 48Y, 48C, 48M and 48K of the recording head unit 46 and, using image data sent from the input unit 22 as the image recording signals, controls ink ejection/non-ejection by the respective recording heads 48X, 48Y, 48C, 48M and 48K so as to form images on the recording medium P.

The ink-jet recording device of the invention is described below in further detail by referring to the operation of the ink-jet recording device 10, that is, its recording action on the recording medium P.

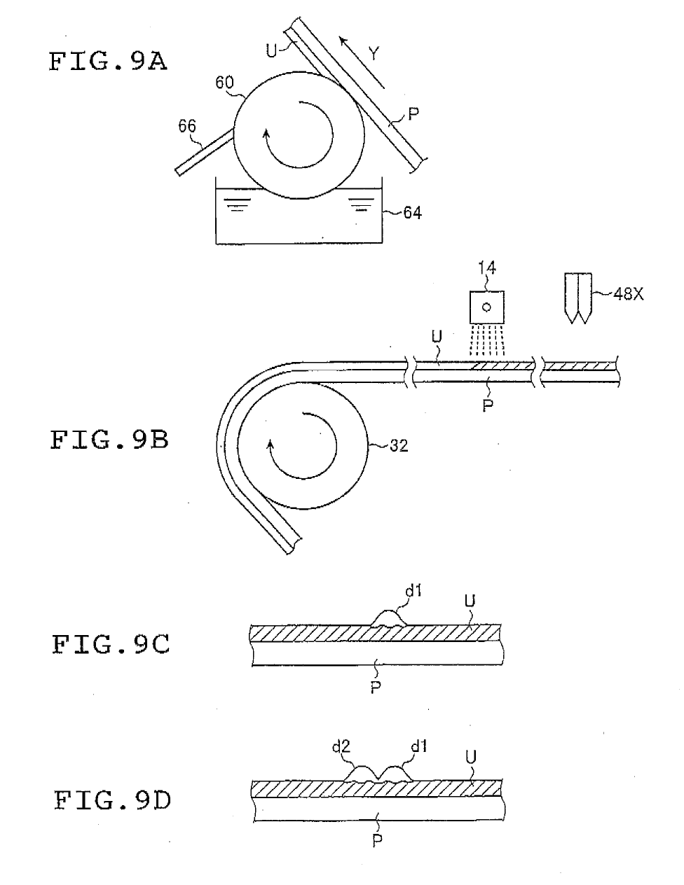

FIGS. 9A to 9D are views schematically showing steps of forming an image on a recording medium, respectively.

The recording medium P having been let out from the feed roll 30 is transported in a specified direction (direction “Y” in FIG. 1) by rotation of the transport roll 32 and the transport roller pair 34. As described above, the recording medium P in this embodiment is a web with a certain length or more and is transported without being cut.

As shown in FIG. 9A, the recording medium P having been let out from the feed roll 30 comes into contact with the coating roll 60 of the undercoat forming section 13 and the undercoating liquid is applied onto the surface thereof to form an undercoat U.

The drive unit 62 causes the coating roll 60 to rotate in the direction opposite to the direction of travel by the recording medium P. More specifically, the drive unit 62 causes the coating roll 60 to rotate in the direction in which the surface portion where a fixed amount of the undercoating liquid is applied by immersion in the reservoir 64 comes into contact with the recording medium P from the downstream side in the direction of travel by the recording medium P. In other words, the drive unit 62 causes the coating roll 60 to rotate so that the direction of movement of the coating roll 60 surface and the direction of travel of the recording medium P are opposite to each other at the position where the coating roll 60 contacts the recording medium P.

The recording medium P on which the undercoat U has been formed by application of the undercoating liquid is further transported by the transport roll 32 and the transport roller pair 34 of the transport section 12 and passes through the position facing the undercoating liquid semi-curing section 14.

As shown in FIG. 9B, the undercoating liquid semi-curing section 14 irradiates with ultraviolet light, the recording medium P onto which the undercoating liquid has been applied and which is passing through the position facing the section 14, thereby semi-curing the undercoat U on the recording medium P.

The recording medium P having thereon the semi-cured undercoating liquid is further transported by the transport roll 32 and the transport roller pair 34 of the transport section 12 and passes through the position facing the recording head 48X.

The recording head 48X ejects ink droplets from its ejection orifices to form an image on the recording medium P which is being transported by the transport section 12 and passing through the position opposed thereto.

More specifically, the recording head 48X ejects a first ink droplet d1 onto the recording medium P. As shown in FIG. 9C, the first ink droplet d1 ejected from the recording head 48x is deposited onto the surface of the undercoat U. The undercoat U is in a semi-cured state and has an uncured surface, and is therefore receptive to the ink droplet d1.

As shown in FIG. 5D, the recording head 48X ejects a second ink droplet d2 in proximity to the position where the previously ejected first ink droplet d1 was deposited. In this case, the undercoat U is also in a semi-cured state and has an uncured surface, and is therefore receptive to the ink droplet d2.

In the case where the ink droplets d1 and d2 have been deposited in proximity to each other on the recording medium P, a force acts to make the ink droplets d1 and d2 coalesce, but interference between the ink droplets having been deposited onto the recording medium P is suppressed by the resistance force of the undercoat U against coalescence of the ink droplets because the undercoat U is semi-cured and has an increased viscosity.

Ink droplets are thus ejected from the recording head 48X in accordance with the control by the control unit 20 and deposited onto the recording medium P to form an image.

The recording medium P having the image formed by the recording head 49X is further transported by the transport section 12 and passes through the position facing the UV irradiation unit 52X disposed downstream from the recording head 48X.

The UV irradiation unit 52X irradiates the recording medium P passing through the position opposed thereto with ultraviolet light to semi-cure the image formed by the recording head 48X on the recording medium P, that is, semi-cure only the interiors of the ink droplets having been deposited onto the recording medium P.

Thereafter, the recording medium P is further transported and passes in order through the positions facing the recording head 48Y, the UV irradiation unit 52Y, the recording head 48C, the UV irradiation unit 52C, the recording head 48M, the UV irradiation unit 52M, and the recording head 48K, respectively. As in the case where the recording medium P passed through the positions facing the recording head 48X and its corresponding UV irradiation unit 52X, formation of an image and semi-curing of the formed image are performed each time the recording medium P passes through the positions facing the recording head of each color and its corresponding UV irradiation unit.

After an image has been formed by the recording head 45K, the recording medium P passes through the position facing the final UV irradiation unit for curing 52a.

The final UV irradiation unit for curing 52a irradiates the recording medium P with more intense ultraviolet light than the other UV irradiation units to cure the whole of the images on the recording medium P formed by the various recording heads including the image recorded by the recording head 48K as well as the undercoating liquid.

A color image is thus formed on the recording medium P.

The recording medium P having the color image formed thereon is further transported by the transport roll 32 and the transport roller pair 34 to be taken up onto the recovery roll 36.

The ink-jet recording device 10 thus forms images on the recording medium P.

By thus forming the undercoat on the recording medium with the ink-jet recording device 10, the ink droplets having been deposited onto the recording medium can be prevented from permeating the recording medium to cause image blurring, thus enabling a high-resolution image to be formed. It also becomes possible to use a recording medium which has a low adhesion to ink droplets, namely, may repel ink droplets having been deposited thereonto. In other words, image recording on various recording media becomes possible.

By using the coating roll 60 and, moreover, by rotating the coating roll 60 in a direction opposite to the recording medium P direction of travel to coat undercoating liquid onto the recording medium P, the undercoat U having an improved surface state can be formed on the recording medium P. That is, by rotating the coating roll 60 in the direction opposite to the direction of travel by the recording medium P, disruption of the surface of the undercoating liquid on the recording medium P when the coating roll 60 separates from the recording medium P after having applied undercoating liquid to the recording medium P can be prevented, enabling the undercoat U having a smooth surface and a low surface roughness to be formed on the recording medium P.

Because the surface of the undercoat can be given a smooth shape in this way, it is possible to prevent the visibility at the surface of the recording medium, and more precisely at the surface of the undercoat, from varying with position; that is, even when a white liquid is used as the undercoating liquid, it is possible to prevent the recording medium from being perceived as changing color with position and from being perceived as hazy. By thus preventing color irregularities and haze from arising in the recording medium, prints of a high resolution and a high quality can be produced.

Also, by using the coating roll 60 to coat the undercoating liquid, the undercoating liquid can be coated at a high speed, enabling productivity to be increased and also making it possible to simplify the device configuration while reducing the cost.

Even in cases where a clear liquid is used as the undercoating liquid and a clear recording medium is used as the recording medium, because it is possible to form on the recording medium P the undercoat U having a smooth surface, i.e., a low surface roughness, the clarity of the recording medium P and the undercoating liquid can be sustained. That is, the recording medium on which an undercoat has been formed can be prevented from being perceived as hazy, making it possible to achieve a recording medium on which an undercoat of high clarity has been formed.

It is also possible to use a liquid having a high viscosity as the undercoating liquid.

When a high viscosity liquid is used as the undercoating liquid, in a system where, for example, the liquid is ejected from an ink-jet head, because ejection as droplets is difficult and clogging of the ejection orifices tends to arise, evenly and uniformly coating the recording medium is a challenge. Moreover, owing to the high viscosity, the undercoating liquid that has been coated onto the recording medium does not readily yield a low surface roughness with the passage of time; i.e., it does not easily flatten under its own weight after being coated. Hence, it has been difficult to use high-viscosity liquids as the undercoating liquid, and especially to form high-resolution images using such high-viscosity liquids.

However, as mentioned above, by rotating the coating roll in a direction opposite P the direction of travel by the recording medium P and coating the undercoating liquid onto the recording medium P, even when a high-viscosity undercoating liquid is employed, the undercoating liquid can be uniformly coated onto the recording medium P, thus enabling an undercoat having a low surface roughness to be formed. Moreover, by using a roll to carry out such coatings it is possible to carry out the coating operation at a high speed.

Also, using a high-viscosity liquid as the undercoating liquid enables the recording medium selectivity to be further increased. That is, recording media made of materials having various surface energies can be used as the recording medium.

Hence, according to the invention, even when a high-viscosity liquid is used as the undercoating liquid, an undercoat having a low surface roughness can be formed, enabling high-resolution images to be formed on various types of recording media. Moreover, because an undercoat can be rapidly formed on the recording medium, it is possible to produce prints at higher speeds.

The undercoating liquid has a viscosity of preferably at least 10 mPa·s but not more than 500 mPa·s, and more preferably at least 50 mPa·s but not more than 300 mPa·s.

At an undercoating liquid viscosity of at least 10 mPa·s, and more preferably at least 50 mPa·s, as noted above, it is possible to coat the undercoating liquid onto even a recording medium to which liquid does not readily adhere.

At an undercoating liquid viscosity of not more than 500 mPa·s, and more preferably not more than 300 mPa·s, it is possible to more reliably achieve a lower surface roughness in the undercoat that is formed on the recording medium P.

Moreover, it is preferable for the drive unit 62 to rotate the coating roll 60 in such a way as to satisfy the condition 0.5≦W/V≦5.0, where V denotes the velocity of travel (velocity of movement) in millimeters per second (mm/s) by the recording medium P when passing through a position where it comes into contact with the coating roll 60, i.e., the velocity of travel by the recording medium P between the feed roll 30 and the transport roll 32, and W denotes the circumferential velocity in millimeters per second (mm/s) of the coating roll 30. Here, the circumferential velocity W is the velocity in a direction tangential to the outer peripheral surface of the coating roll 30, and can be expressed as W=2πrN, where N is the rotational velocity of the coating roll 30 in revolutions per sec (rps) and r is the radius of the coating roll 30 in millimeters (mm).

By having the above ratio W/V be 0.5 or higher, at least a fixed amount of undercoating liquid can be supplied to the recording medium P, making it possible to prevent the retention of an inadequate amount of undercoating liquid on the coating roll 60 at the position where the coating roll 60 comes into contact with the recording medium P and to prevent the undercoat formed on the recording medium P from being uneven; that is, irregular coating of the undercoating liquid can be kept from arising.

On the other hand, by having the above ratio W/V be 5.0 or less, it is possible to prevent an excessive amount of undercoating liquid from being fed to the recording medium P and to prevent the undercoat formed on the recording medium P from being uneven, that is, irregular coating of the undercoating liquid can be kept from arising.

Moreover, the undercoating liquid can be efficiently coated.

To suitably and reliably achieve the above effects, it is even more preferable for the W/V ratio to satisfy the condition 1.0≦W/V≦3.0.

It is preferable to set the velocity at which the recording medium P is transported by the transport section to at least 200 mm/s but not more than 600 mm/s. In this way, high-resolution images can be efficiently formed on the recording medium. Moreover, prints can be produced at a high speed. That is, a large amount of recording medium can be printed in a short time.

Also, by using as the coating roll a roll in which recessed features have been formed at fixed intervals in the surface, that is, by using a gravure roll, the amount of undercoating liquid retained on the surface of the coating roll in areas that come into contact with the recording medium P can be made constants allowing a fixed amount of undercoating liquid to be coated onto the recording medium, and thus enabling more even formation of the undercoat on the recording medium.

In addition, by providing a blade, the amount of undercoating liquid coated onto the recording medium can be more reliably held constant, enabling the undercoat to be more evenly formed on the recording medium.

By thus forming the undercoat more evenly on the recording medium, a higher resolution can be achieved in the images formed on the recording medium.

To make the amount of undercoating liquid constant, it is desirable that the coating roll be given a shape in which recessed features are formed on the surface at fixed intervals. However, the invention is not limited in this regard; that is, use may also be made of a coating roll which does not have recessed features formed on the surface.

Also, while providing a blade in the ink-jet recording device of the invention is desirable, it is not critical for such a blade to be included.

By providing the positioning unit 68, i.e., the first positioning roll 70 and the second positioning roll 72, the recording medium P can be prevented from shifting out of the desired position where it comes into contact with the coating roll 60. That is, the transport path by the recording medium P can be prevented from changing, the positional relationship between the coating roll 60 and the recording medium P can be stabilized, and the undercoating liquid coated by the coating roll 60 onto the recording medium P can be made more uniform.

By semi-curing the undercoat in the undercoating liquid semi-curing section as in the present embodiment, even when ink droplets having portions which mutually overlap are deposited on the recording medium, the coalescence of these neighboring ink droplets can be suppressed through interactions between the undercoating liquid and the ink droplets.

That is, by forming a semi-cured undercoat on the recording medium, the migration of ink droplets can be prevented in cases where ink droplets ejected from the recording heads are deposited in close proximity on the recording medium, such as when ink droplets of a single color having portions which mutually overlap are deposited on a recording medium or even when ink droplets of different colors having portions which mutually overlap are deposited on a recording medium.

In this way, image bleed, line width non-uniformities such as of fine lines in the image, and color unevenness on colored surfaces can be effectively prevented from occurring, enabling the formation of uniform-width, sharp line shapes, and thus making it possible to carry out the recording of ink-jet images of a high deposition density, such as reversed letters, with good reproducibility of fine features such as fine lines. That is, high-resolution images can be formed on the recording medium.

By placing a UV irradiation unit between the respective recording heads and semi-curing the ink droplets deposited onto (i.e., the image formed on) the recording medium using the respective recording heads, it is possible to prevent different-color ink droplets deposited at adjacent positions from overlapping and to keep the deposited ink droplets from migrating.

It is preferred to irradiate the recording medium with ultraviolet light in a period of several hundred milliseconds to 5 seconds after the ink droplets have been deposited from the recording head on the recording medium to semi-cure the ink droplets deposited thereon.

By thus semi-curing the ink droplets in the period of several hundred milliseconds to 5 seconds after their deposition, the ink droplets on the recording medium can be prevented from getting out of shape, enabling a high-resolution image to be formed.

When the semi-cured state of the undercoating liquid and/or the ink is realized by a polymerization reaction of a polymerizable compound that is initiated by the irradiation of active energy rays or heating, to enhance the scuff resistance of the print, the unpolymerization ratio (i.e., A_{after polymerization}/A_{before polymerization}) is preferably at least 0.2 but not more than 0.9, more preferably at least 0.3 but not more then 0.9, and most preferably at least 0.5 but not more than 0.9.

Here, A_{before polymerization} is the infrared absorption peak absorbance attributable to polymerizable groups before the polymerization reaction, and A_{after polymerization} is the infrared absorption peak absorbance attributable to polymerizable groups after the polymerization reaction.

For example, when the polymerizable compound included in the undercoating liquid and/or the ink is an acrylate monomer or a methacrylate monomer, absorption peaks based on polymerizable groups (acrylate groups, methacrylate groups) can be observed near 810 cm⁻¹. Accordingly, the above unpolymerization ratio is preferably defined in terms of the absorbances of these peaks. When the polymerizable compound is an oxetane compound, an absorption peak based on polymerizable groups (oxetane rings) can be observed near 986 cm⁻¹. The above unpolymerization ratio is thus preferably defined in terms of the absorbance of this peak. When the polymerizable compound is an epoxy compound, an absorption peak based on the polymerizable groups (epoxy groups) can be observed near 750 cm⁻¹. Hence, the above unpolymerization ratio is preferably defined in terms of the absorbance of this peak.

A commercial infrared spectrophotometer may be used as the means for measuring the infrared absorption spectrum. The spectrophotometer may be either a transmission-type or reflection-type system. Suitable selection according to the form of the sample is preferred. Measurement may be carried out using, for example, an FTS-6000 infrared spectrophotometer manufactured by Bio-Rad.

In the case of a curing reaction based on an ethylenically unsaturated compound or a cyclic ether, the unpolymerization ratio may be quantitatively measured from the percent conversion of ethylenically unsaturated groups or cyclic ether groups.

The method used to semi-cure the undercoating liquid and/or the ink is exemplified by known thickening methods, e.g., (1) methods that use an agglomerating effects such as by furnishing a basic compound to an acidic polymer or by furnishing an acidic compound and a metal compound to a basic polymer; (2) methods wherein the undercoating liquid and/or the ink is prepared beforehand at a high viscosity, then the viscosity is lowered by adding thereto a low-boiling organic solvent, after which the low-boiling organic solvent is evaporated so as to return the liquid to its original high viscosity; (3) methods in which the undercoating liquid and/or the ink prepared at a high viscosity is first heated, then is cooled so as to return the liquid to its original high viscosity; and (4) methods in which the undercoating liquid and/or the ink is semi-cured through a curing reaction induced by exposing the undercoating liquid and/or the ink to active energy rays or heat. Of these, (4) methods in which the undercoating liquid and/or the ink is semi-cured through a curing reaction induced by exposing the undercoating liquid and/or the ink to active energy rays or heat are preferred.

“Methods in which the undercoating liquid and/or the ink is semi-cured through a curing reaction induced by exposing the undercoating liquid and/or the ink to active energy rays or heat” refers herein to methods in which the polymerization reaction on polymerizable compounds at the surface of the undercoating liquid and/or the ink furnished to the recording medium is carried out incompletely. At the surface of the undercoating liquid and/or the ink, compared with the interior thereof, the polymerization reaction tends to be inhibited by the influence of oxygen present in air. Therefore, by controlling the conditions of exposure to active energy rays or heat, it is possible to trigger the reaction for semi-curing the undercoating liquid and/or the ink.

The amount of energy required to semi-cure the undercoating liquid and/or the ink varies with the type and content of polymerization initiator. When the energy is applied by active energy rays, an amount of about 1 to about 500 mJ/cm² is generally preferred. When the energy is applied as heats from 0.1 to 1 second of heating under temperature conditions where the surface temperature of the recording medium falls within a temperature range of 40 to 80° C. is preferred.

The application of active energy rays or heat, such as with active rays or heating, promotes the generation of active species by decomposition of the polymerization initiator. At the same time, the increase in active species or the rise in temperature promotes the curing reaction through polymerization or crosslinking of polymerizable or crosslinkable materials induced by the active species.

A thickening (rise in thickness) may also be suitably carried out by exposure to active rays or by heating.

The inner layer of the semi-cured undercoat and/or ink droplets has a viscosity at 25° C. of preferably at least 5,000 mPa·s.

The surface layer of the semi-cured undercoat and/or ink droplets has a viscosity at 25° C. of preferably at least 100 mPa·s but not more than 5,000 mPa·s.

The viscosity at 25° C. of the inner layer of the semi-cured undercoat and/or ink droplets is preferably at least 1.5 times, more preferably at least 2 times, and even more preferably at least 3 times, the viscosity at 25° C. of the surface layer of the semi-cured undercoat and/or ink droplets.

By setting the viscosity within the foregoing ranges, the undercoat and/or ink droplets can be suitably semi-cured.

The degree of polymerization by polymerizable compounds at the surface of the semi-cured undercoating liquid (undercoat) and/or the ink droplets is preferably at least 1% but not more than 70%, more preferably at least 5% but not more than 60%, and even more preferably at least 10% but not more than 50%. Here, the degree of polymerization may be measured by a suitable technique such as infrared spectroscopy.

By setting the degree of polymerization within the foregoing range, the undercoat can be suitably semi-cured.

Moreover, by configuring the UV irradiation unit so as to include a plurality of linearly arrayed UV irradiators as in the present embodiment, i.e., in such a way that the recording medium is irradiated over its entire width with UV light by a plurality of UV irradiators, the regions that are UV-irradiated by the respective UV irradiators can be made smaller, enabling the use of low-cost light sources as the UV lamps, and also making it possible to use low-cost drive mechanisms. The cost of the ink-jet recording device can be reduced in this way. Of course, it is possible instead to have each UV irradiation unit composed of a single UV irradiator, although such an arrangement will increase the cost of the ink-jet recording device.

In the present embodiment, the UV irradiators are linearly arrayed as straight lines which are perpendicular to the direction of travel by the recording medium. However, it is also possible to array the UV irradiators at different positions in the direction of travel by the recording medium, such as in a staggered arrangement on a plurality of parallel straight lines which are perpendicular to the direction of travel.

UV irradiators may be used in the undercoating liquid semi-curing section.

Moreover, in the present embodiment, the UV lamps in the UV irradiators may be linearly arrayed on straight lines perpendicular to the direction of travel by the recording medium, or may be arrayed in a staggered arrangement on a plurality of parallel straight lines perpendicular to the direction of travel.

On the travel path by the recording medium, the UV irradiation unit corresponding to the recording head disposed on the furthest downstream side serves as the final UV irradiation unit for curing and, because it emits higher intensity UV light than the other UV irradiation units, has the ability to reliably cure images that have been formed on the recording medium.

The undercoating liquid semi-curing section and/or UV irradiation units may also be provided with shutters which open and close and are capable of shielding out UV light that is irradiated on the side of the recording medium P.

By providing a shutter and shielding out UV light that is irradiated, more UV light than necessary can be prevented from leaking to the recording medium P side, thus making it possible to prevent the recording heads from being irradiated by UV light reflected by the recording medium P and to prevent ink in the recording heads from curing. Moreover, by providing a shutter, it is possible to switch between UV light irradiation and non-irradiation without turning on and off the light sources such as UV lamps.

It is also desirable to subject regions in the vicinity of the UV irradiators 54 to antireflective treatment (e.g., black, delustering treatment).

In the ink-jet recording device 10 of the present embodiment, to provide the undercoat forming section with a simpler construction, the portion of the recording medium P which comes into contact with the coating roll in the undercoat forming section is transported with the side on which images are to be formed facing downward. However, the invention is not limited in this regard.

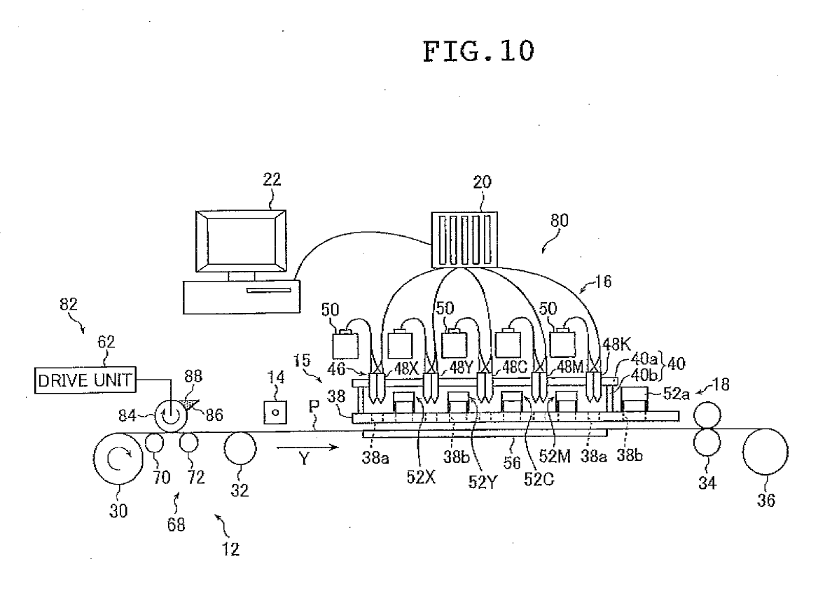

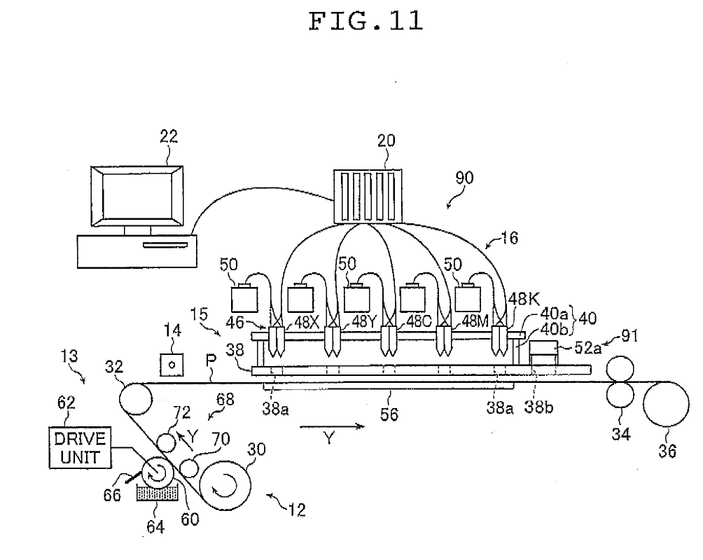

For example, as shown in FIG. 10, advantageous use can also be made of an ink-jet recording device 90 in which the recording medium P has a linear travel path.

An undercoat forming section 82 of the ink-jet recording device 80 is configured so that a blade 86 comes into touching contact with the surface of a coating roller 84 on a recovery roll 36 side thereof (i.e., the downstream side in the direction of travel by the recording medium P), thereby causing undercoating liquid to accumulate in a space that is formed above the area of touching contact between the coating roller 84 and the blade 86 (which space is referred to below as a “reservoir 88”).

A drive unit 62 causes the coating roll 84 to rotate in the opposite direction to the direction of travel by the recording medium P. If necessary, the undercoating liquid is supplied from a feed tank (not shown) to the reservoir 88.

The coating roll 84 in the undercoat forming section 32 passes through the reservoir 88 and a predetermined amount of undercoating liquid is retained on the surface thereof, following which the coating roll 84 comes into contact with the surface of the recording medium P and applies the undercoating liquid onto the surface of the recording medium P.

The ink-jet recording device 80 is also able, by causing the coating roll 84 to rotate in the opposite direction to the direction of travel by the recording medium P, to form on the recording medium P the undercoat U having an improved surface state. That is, the undercoat U having a low surface roughness can be formed on the recording medium P, thereby enabling the formation of high-resolution images.

Even when the undercoating liquid reservoir 88 is provided above the coating roll 84 as in the present embodiment, by having the blade 86 come into touching contact with the coating roll 84, the leakage of undercoating liquid from the reservoir 88 can be prevented, thus making it possible to prevent more undercoating liquid than necessary from being coated onto the recording medium P.

In the present embodiment, by disposing UV irradiators between recording heads of the respective ink colors and curing the image areas on the recording medium each time an image is recorded at each of the respective recording heads, as noted above, it is possible to prevent ink of different colors from intermingling, thus enabling higher resolution images to be formed. Accordingly, a UV irradiation unit was positioned at each of the recording heads. However, the present invention is not limited in this regard. To illustrate, in an alternative arrangement, a single UV irradiation unit may be disposed for a plurality of recording heads.

For example, advantageous use may also be made of an ink-jet recording device 90 in which, as shown in FIG. 11, an image fixing section 91 only includes a final UV irradiation unit for curing 52a.

In this ink-jet recording device 90, an undercoat forming section 12 coats an undercoating liquid onto the recording medium P, following which an undercoating liquid semi-curing section 14 exposes the top of the recording medium P to UV light, thereby semi-Curing the undercoating liquid. Next, an image is formed on the recording medium P by recording heads 48X, 48Y, 48C, 48M and 48K, subsequent to which the final UV irradiation unit for curing 52a exposes the top of the recording medium P to UV light, causing the image and the undercoating liquid to cure. In this way, it is possible to effectively record images on the recording medium P even with an arrangement in which a UV irradiator is not disposed for each recording head.

In the present embodiment, the recording head unit has recording heads of a total of five colors consisting of a special color (X) and yellow (Y), cyan (C), magenta (M) and black (K). However, it is also possible to employ a recording head unit having other combinations of heads, including a recording head unit having heads for only the four colors CMYK, or a recording head unit having heads for six or more colors, including another special color head. The recording heads of the respective colors may be disposed in any order without any particular limitation.

Nor is the invention limited to requiring the disposition of a plurality of recording heads. That is, the ink-jet recording device of the invention may be one which uses a single recording head to form an image on the recording medium, then irradiates the image with UV light to form a single-color image.

Here, as noted above, to give the image formed on the recording medium a higher resolution, it is preferable to semi-cure the undercoating liquid. However, the invention is not limited in this regard. It is possible to completely cure the undercoating liquid applied onto the recording medium, then eject ink droplets onto the recording medium (more precisely, onto the cured undercoat) so as to form an image. Alternatively, ink droplets may be ejected onto the recording medium (more precisely, onto the undercoat) without first curing the undercoating liquid applied onto the recording medium, so as to form an image, then irradiated with active light so as to cure both the image areas and The undercoat on the recording medium at the same time.

Even in cases where the undercoat is thus not semi-cured, when the recording medium p is coated with an undercoating liquid by using the coating roll 60 and having the coating roll 60 rotate in the opposite direction to the direction of travel by the recording medium P, the undercoat U having an improved surface state can be formed on the recording medium P, thus enabling high-resolution images to be obtained.

The method of semi-curing the undercoating liquid (undercoat) and/or ink is not limited to the above-described method. Other methods that may be used for this purpose include known thickening-methods, such as methods that use an agglomerating effect, such as by furnishing a basic compound to an acidic polymer or by furnishing an acidic compound and a metal compound to a basic polymer; methods wherein the undercoating liquid (ink) is prepared beforehand to a high viscosity, then the viscosity is lowered by adding thereto a low-boiling organic solvent, after which the low-boiling organic solvent is evaporated so as to return the liquid to its original high viscosity; methods in which the undercoating liquid (ink) prepared at a high viscosity is first heated, then is cooled so as to return the liquid to its original high viscosity; and methods in which the undercoating liquid (ink) is semi-cured through a curing reaction induced by applying heat to the undercoating liquid (ink).

Of these, methods in which the undercoating liquid and ink are semi-cured through a curing reaction induced by the application of heat or by irradiation with the above-described active energy rays are preferred.

In the present embodiment, an active ray-curable undercoating liquid and active ray-curable inks were used as the undercoating liquid and inks, and curing was effected by irradiating the undercoating liquid and inks with active rays. However, the invention is not limited in this regard. That is, use may be made of undercoating liquids and inks other than those which are active ray-curable. For example, images may be formed by means already known in the art using heat-curable inks. Likewise, a heat-curable liquid may be used as the undercoating liquid.

An ink-jet recording device according to still further embodiment of the invention is described below.

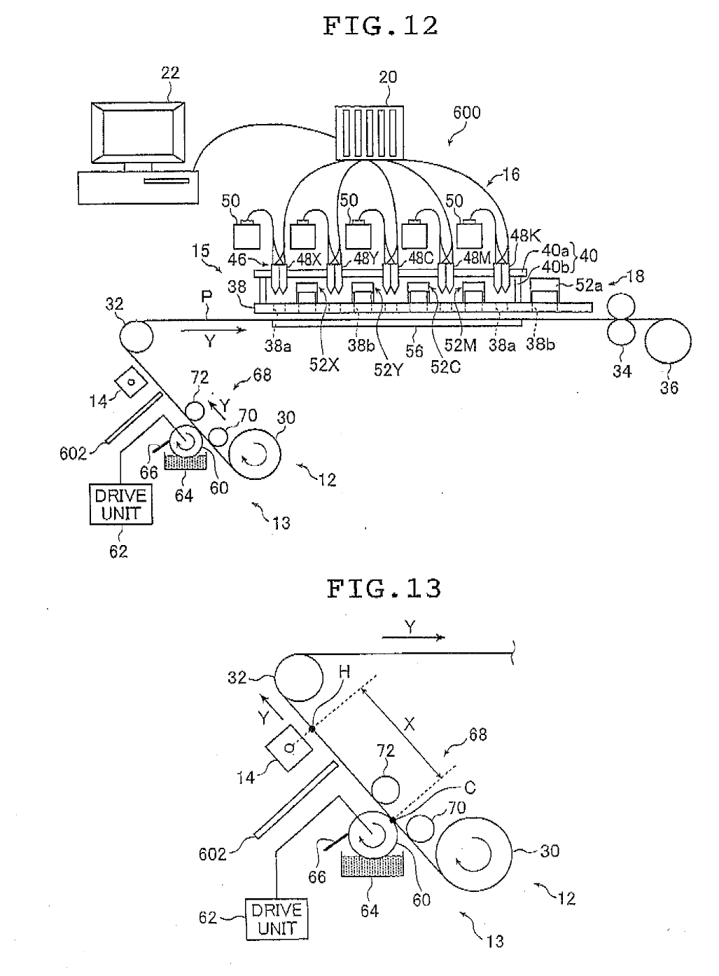

FIG. 12 is a front view showing, in simplified form, an ink-jet recording device 600 of the invention. FIG. 13 is an enlarged front view showing an undercoat forming section 13, an undercoating liquid semi-curing section 14 and their peripheral portions in the ink-jet recording device 600 shown in FIG. 12.

The ink-jet recording device 600 shown in FIG. 12 is configured in the same manner as the ink-jet recording device 10 shown in FIG. 1 aside from the position where the undercoating liquid semi-curing section 14 is arranged, the positional relation between the undercoat forming section 13 and the undercoating liquid semi-curing section 14, and a light shielding member 602 provided. Like elements in both embodiments are thus denoted by the same reference symbols and repeated explanations of such elements are omitted. The following description focuses on the distinctive features of the ink-jet recording device 600.

As shown in FIG. 12, the ink-jet recording device 600 has a transport section 12 which transports the recording medium P, the undercoat forming section 13 which coats the undercoating liquid onto the recording medium P, the undercoating liquid semi-curing section 14 which semi-cures the undercoating liquid that has been coated onto the recording medium P, a support section 15 disposed opposite a path of travel by the recording medium P which is transported by the transport section 12, an image recording section 16 which is supported by the support section 15 and which records an image on the recording medium P, an image fixing section 18 which is supported by the support section 15 and which fixes the image recorded on the recording medium P, and a control unit 20 which controls the ejection of ink droplets from the image recording section 16.

An input unit 22 is connected to the control unit 20 of the ink-jet recording device 600.

The transport section 12, which has a feed roll 30, a transport roll 32, a transport roller pair 34 and a recovery roll 36, feeds, transports and recovers the recording medium P.

Since the arrangement position and function of each element of the transport section 12 are the same as those in the transport section 12 of the above-mentioned ink-jet recording device 10, their detailed description is omitted.

The undercoat forming section 13 is situated between the feed roll 30 and the transport roll 32; that is, on the downstream side of the feed roll 30 and on the upstream side of the transport roll 32 in the direction of travel by the recording medium P.

The undercoat forming section 12 has a coating roll 60 for coating the undercoating liquid onto the recording medium P, a drive unit 62 which drives the coating roll 60, a reservoir 64 which supplies the undercoating liquid to the coating roll 60, a blade 66 which adjusts the amount of undercoating liquid picked up by the coating roll 60, and a positioning unit 68 which supports the recording medium P so that the recording medium P assumes a predetermined position relative to the coating roll 60.

Since each element of the undercoat forming section 13 is configured in the same manner as in the undercoat forming section 13 of the above-mentioned ink-jet recording device 10, its detailed description is omitted.

As mentioned above, in the undercoat forming section 13, the drive unit 62 causes the coating roll 60 to rotate in the direction opposite to the direction of travel by the recording medium P. After being immersed in the undercoating liquid which has accumulated in the reservoir 64, the surface of the rotating coating roll 60 comes into touching contact with the blade 66, thereby setting the amount of undercoating liquid retained on the surface to a fixed amount, then comes into contact with the recording medium P, thereby coating the undercoating liquid onto the recording medium P. By thus rotating the coating roll 60 in the direction opposite to the direction of travel by the recording medium P and coating the undercoating liquid onto the recording medium P, a layer of undercoating liquid (referred to below as the “undercoat”) that has been smoothened and has a good, even, coating surface state can be formed on the recording medium P.

The undercoat forming section 13 thus forms the undercoat on the surface of the recording medium P by rotating the coating roll 60 and coating the undercoating liquid onto the surface of the recording medium P.

Then, the undercoating liquid semi-curing section 14 has a UV lamp and is disposed so as to face the travel path of the recording medium P. The UV lamp is a light source which emits ultraviolet light and illustrative examples that may be used include metal halide lamps, high-pressure mercury vapor lamps and various other UV light sources.

The undercoating liquid semi-curing section 14 irradiates the entire width of the recording medium P which passes through a position opposed thereto with UV light.

The undercoating liquid semi-curing section 14 irradiates with UV light the recording medium P which passes through the position opposed thereto and has the undercoating liquid applied onto the surface thereof to make the undercoating liquid applied onto the surface of the recording medium P semi-cured. In short, the undercoating liquid semi-curing section 14 semi-cures the undercoating liquid applied onto the recording medium P.

The relation between the undercoat forming section 13 and the undercoating liquid semi-curing section 14 is described below.

As shown in FIG. 13, the undercoat forming section 13 and the undercoating liquid semi-curing section 14 are disposed at positions satisfying the relation:

X≦5V

where the length in the travel path of the recording medium P between a position C at which the undercoating liquid is applied to the recording medium P in the undercoat forming section 13 (hereinafter also referred to simply as “application position C”) and a position at which ultraviolet light emitted from the undercoating liquid semi-curing section 14 semi-cures the undercoating liquid applied to the recording medium P, in other words, a position H at which the recording medium P having the undercoating liquid applied thereto is irradiated with ultraviolet light from the undercoating liquid semi-curing section 14 (hereinafter also referred to simply as “semi-curing position H”) is denoted by X (mm) and the velocity at which the recording medium P is transported by the transport section 12 between the application position C and the semi-curing position H is denoted by V (mm/s).

More precisely, the “application position C” as used herein is a position on the most upstream side, in the direction of travel by the recording medium P, of the region where the undercoat forming section 13 applies the undercoating liquid to the recording medium P. In other words, the application position C is a position at which the undercoating liquid is first applied to the recording medium P transported from the feed roll 30.

The “semi-curing position H” is, more precisely, an intermediate point, in the direction of travel by the recording medium P, of the region on the recording medium P which is irradiated with ultraviolet light emitted from the undercoating liquid semi-curing section 14.

By disposing the undercoat forming section 13 and the undercoating liquid semi-curing section 14 at positions satisfying the relation: X≦5V, the undercoating liquid applied to the recording medium P can be semi-cured before permeating it, thus preventing the undercoating liquid from permeating the recording medium P. This point is described later in further detail.

Next, the light shielding member 602 which is a member for blocking out ultraviolet light or other active rays is disposed on the downstream side of the transport roll 60 of the undercoat forming section 13.

The light shielding member 602 blocks out ultraviolet light that was emitted from the UV lamp of the undercoating liquid semi-curing section 14 and leaked to the undercoat forming section 13 side, thereby preventing the ultraviolet light emitted from the undercoating liquid semi-curing section 14 from reaching the undercoat forming section 13. The undercoating liquid to be applied to the recording medium P is thus prevented from being cured by the ultraviolet light emitted from the undercoating liquid semi-curing section 14. The undercoat forming section 13 and the undercoating liquid semi-curing section 14 can be thus disposed in proximity to each other by arranging the light shielding member 602 on the downstream side of the undercoat forming section 13.

Since the support section 157 image recording section 16, image fixing section 18 and control unit 20 are configured in the same manner as the support section 15, image recording section 16, image fixing section 18 and control unit 20 of the above-mentioned ink-jet recording device 10, their detailed description is omitted.

The ink-jet recording device of the invention is described below in further detail by referring to the operation of the ink-jet recording device 600 that is, its recording action on the recording medium P.

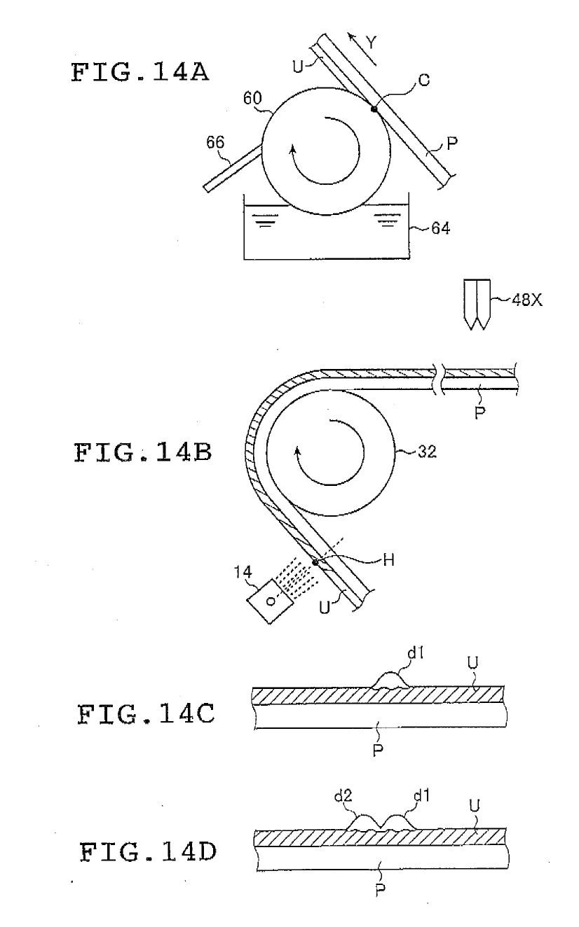

FIGS. 14A to 14D are views schematically showing steps of forming an image on a recording medium, respectively.

The recording medium P having been let out from the feed roll 30 is transported in a specified direction (direction “Y” in FIG. 14A) by rotation of the transport roll 32 and the transport roller pair 34. As described above, the recording medium P in this embodiment is a web with a certain length or more and is transported without being cut.

As shown in FIG. 14A, the recording medium P having been let out from the feed roll 30 comes into contact with the coating roll 60 of the undercoat forming section 13 and the undercoating liquid is applied onto the surface thereof to form an undercoat U.

The drive unit 62 causes the coating roll 60 to rotate in the direction opposite to the direction of travel by the recording medium P. More specifically, the drive unit 62 causes the coating roll 60 to rotate in the direction in which the surface portion where a fixed amount of the undercoating liquid is applied by immersion in the reservoir 64 comes into contact with the recording medium P from the downstream side in the direction of travel by the recording medium P. In other words, the drive unit 62 causes the coating roll 60 to rotate so that the direction of movement of the coating roll 60 surface and the direction of travel of the recording medium P are opposite to each other at the position where the coating roll 60 contacts the recording medium P.

The recording medium P on which the undercoat U has been formed by application of the undercoating liquid is further transported by the transport roll 32 and the transport roller pair 34 of the transport section 12 and passes through the position facing the undercoating liquid semi-curing section 14.

As shown in FIG. 14B, the undercoating liquid semi-curing section 14 irradiates with ultraviolet light, the recording medium P onto which the undercoating liquid has been applied and which is passing through the position facing the section 14, thereby semi-curing the undercoat U on the recording medium P (forming a semi-cured film).

In the ink-jet recording device 600 of the invention, the travel distance X of the recording medium P between the application position C and the semi-curing position 14 and the travel velocity V of the recording medium P satisfy the relation: X≦5V.

Therefore, within 5 seconds after the application of the undercoating liquid in the undercoat forming section 13, the recording medium P is irradiated with ultraviolet light on the surface having the undercoating liquid applied thereto, that is, the surface having the undercoat formed thereon.

The undercoating liquid applied to the recording medium P is thus semi-cured within 5 seconds after the application. In other words, the undercoat U on the recording medium P is semi-cured (the semi-cured film is formed) within 5 seconds after the formation of the undercoat U.

The recording medium P having thereon the semi-cured undercoating liquid is further transported by the transport roll 32 and the transport roller pair 34 of the transport section 12 and passes through the position facing a recording head 48X.

The recording head 48X ejects ink droplets from its ejection orifices to form an image on the recording medium P which is being transported by the transport section 12 and passing through the position opposed thereto.

More specifically, the recording head 48X ejects a first ink droplet d1 onto the recording medium P. As shown in FIG. 14C, the first ink droplet d1 ejected from the recording head 48X is deposited onto the surface of the undercoat U. The undercoat U is in a semi-cured state and has an uncured surface, and is therefore receptive to the ink droplet d1.

As shown in FIG. 14D, the recording head 48X ejects a second ink droplet d2 in proximity to the position where the previously ejected first ink droplet d1 was deposited. In this case, the undercoat U is also in a semi-cured state and has an uncured surface, and is therefore receptive to the ink droplet d2.

In the case where the ink droplets d1 and d2 have been deposited in proximity to each other on the recording medium P, a force acts to make the ink droplets d1 and d2 coalesce, but interference between the ink droplets having been deposited onto the recording medium P is suppressed by the resistance force of the undercoat U against coalescence of the ink droplets because the undercoat U is semi-cured and has an increased surface viscosity.

Ink droplets are thus ejected from the recording head 48X in accordance with the control by the control unit 20 and deposited onto the recording medium P to form an image.

The recording medium P having the image formed by the recording head 48X is further transported by the transport section 12 and passes through the position facing a UV irradiation unit 52X disposed downstream from the recording head 48X.

The UV irradiation unit 52X irradiates the recording medium P passing through the position opposed thereto with ultraviolet light to semi-cure the image formed by the recording head 48X on the recording medium P, that is, semi-cure the ink droplets having been deposited onto the recording medium P.

Thereafter, the recording medium P is further transported and passes in order through the positions facing a recording head 48Y, a UV irradiation unit 52Y, a recording head 48C, a UV irradiation unit 52C, a recording head 48M, a UV irradiation unit 52M, and a recording head 48K, respectively. As in the case where the recording medium P passed through the positions facing the recording head 48X and its corresponding UV irradiation unit 52X, formation of an image and semi-curing of the formed image are performed each time the recording medium P passes-through the positions facing the recording head of each color and its corresponding UV irradiation unit.

After an image has been formed by the recording head 48K, the recording medium P passes through the position facing a final UV irradiation unit for curing 52a.

The final UV irradiation unit for curing 52a irradiates the recording medium P with more intense ultraviolet light than the other UV irradiation units to cure the images on the recording medium P formed by the various recording heads including the image recorded by the recording head 48K as well as the undercoating liquid.

A color image is thus formed on the recording medium P.

The recording medium P having the color image formed thereon is further transported by the transport roll 32 and the transport roller pair 34 to be taken up onto the recovery roll 36.

The ink-jet recording device 600 thus forms images on the recording medium P.

By thus forming the undercoat on the recording medium with the ink-jet recording device 600, the ink droplets having been deposited onto the recording medium can be prevented from permeating the recording medium to cause image blurring, thus enabling a high-resolution image to be formed. It also becomes possible to use a recording medium which has a low adhesion to ink droplets, namely, may repel ink droplets having been deposited thereonto. In other words, image recording on various recording media such as metals absorbing no ink becomes possible.

In addition, since the travel velocity (mm/s) and the travel distance X (mm) satisfy the relation: X≦5V, the undercoating liquid applied to the recording medium P in the undercoat forming section 13 can be semi-cured in the undercoating liquid semi-curing section 14 within 5 seconds after the application of the undercoating liquid.

The undercoating liquid provided (applied in this embodiment) to the recording medium can be prevented from permeating the recording medium P. More specifically, the undercoating liquid is semi-cured within 5 seconds after its application to form the semi-cured film on the recording medium, whereby the undercoating liquid can be prevented from permeating the recording medium P.

Application of the undercoating liquid onto the recording medium P can prevent the undercoating liquid from permeating the recording medium P, thus keeping color changes from occurring from position to position on the recording medium due to permeation of the undercoating liquid into the recording medium P or portions where the liquid permeates from looking wet even after the liquid has been dried or cured. Unnecessary unevenness or gloss can be kept from occurring on the recording medium surface to enable production of higher quality prints.

Even in the case of using a highly permeable medium, the undercoating liquid having been semi-cured within 5 seconds after its application permeates the recording medium, thus preventing gloss, color unevenness or other defects from occurring on the recording medium. Therefore, image recording on various recording media becomes possible, which will offer a high degree of selectivity for the recording medium and a capability to produce higher-resolution and higher-quality prints. The “highly permeable medium” as used herein refers to a recording medium in which, when an undercoating liquid or an ink composition with a volume of 10 pL was dripped on the surface (on the recording medium), it takes at least 100 ms for the whole of the dripped liquid or ink composition to permeate the recording medium.

The relation between the travel velocity V (mm/s) and the travel distance X (mm) is adjusted by the position of the undercoat forming section 13 and the position of the undercoating liquid semi-curing section 14 (more specifically the position where ultraviolet light is applied), but this is not the sole case of the invention but this relation may be adjusted by the travel velocity V (mm/s). The semi-curing position H can also be adjusted by, for example, changing the direction in which ultraviolet light is emitted from the undercoating liquid semi-curing section.

The transport section 12 transports the recording medium P at a travel velocity V of preferably from 200 mm/s to 600 mm/s. Within this ranger high-resolution images can be formed with high efficiency on the recording medium. It becomes possible to produce prints at high speed, namely, to produce a large quantity of prints from the recording medium within a short period of time.

In the ink-jet recording device 600 of the invention, the relation between the travel distance X (mm) from the application position C to the semi-curing position H, and the travel velocity V (mm/s) more preferably satisfy the relation: X≦2V. When the travel velocity V (mm/s) and the travel distance X (mm) satisfy the above relation, the undercoating liquid applied to the recording medium P in the undercoat forming section 13 can be semi-cured by irradiating the recording medium P with ultraviolet light from the undercoating liquid semi-curing section 14 within 2 seconds from the undercoating liquid application.

This further ensures that the undercoating liquid is prevented from permeating the recording medium to achieve the above-mentioned effects more reliably and produce higher-resolution and higher-quality prints.

In this embodiment, by providing the light shielding member downstream from the undercoat forming section, in other words, between the undercoat forming section and the undercoating liquid semi-curing section, ultraviolet light from the undercoating liquid semi-curing section can be prevented from being applied to the undercoat forming section, resulting in improvement in the flexibility of the layout of the undercoating liquid semi-curing section. The undercoat forming section and the undercoating liquid semi-curing section may be disposed in proximity to each other.

The undercoat U with an improved surface state can be formed on the recording medium P by using the coating roll 60 as in the ink-jet recording device 10 in such a manner that the undercoating liquid is applied onto the recording medium P through its rotation in the direction opposite to the direction of travel by the recording medium P.

Because the surface of the undercoat can be given a smooth shape in this way, it is possible to prevent the visibility at the surface of the recording medium, and more precisely at the surface of the undercoat, from varying with position; that is, even when a white liquid is used as the undercoating liquid, it is possible to prevent the recording medium from being perceived as changing color with position and from being perceived as hazy. By thus preventing color irregularities and haze from arising in the recording medium, prints of a high resolution and a high quality can be produced.

Also, by using the coating roll 60 to coat the undercoating liquid, the undercoating liquid can be coated at a high speed, enabling productivity to be increased and also making it possible to simplify the device configuration while reducing the cost.

Even in the case where the undercoat forming section and the undercoating liquid semi-curing section are disposed, as in the ink-let recording device 600, at positions where the travel velocity V (mm/s) and the travel distance X (mm) satisfy the relation: X≦5V, the ink-jet recording device 600 is not limited to the above-mentioned form but may adopt any of various forms as in the ink-jet recording device 10.

In the ink-jet recording device 600, the recording medium P is transported in the direction in which the recording medium surface which comes into contact with the coating roll in the undercoat forming section to form an image thereon faces downward. However, this is not the sole case of the invention but the recording medium P may be transported along a linear travel path as in the above-mentioned ink-jet recording device 50, because the undercoat forming section can have a simpler structure.

In the ink-jet recording device 600, by disposing UV irradiators between recording heads of the respective ink colors and curing the image areas on the recording medium each time an image is recorded at each of the recording heads, as noted above, it is possible to prevent ink of different colors from intermingling, thus enabling higher-resolution images to be formed. Accordingly, a UV irradiation unit was positioned at each of the recording heads. However, the present invention is not limited in this regard. To illustrate, in an alternative arrangement, a single UV irradiation unit may be disposed for a plurality of recording heads.

For example, advantageous use may also be made of an ink-jet recording device in which an image fixing section 91 only includes a final UV irradiation unit for curing 52a as in the above-mentioned ink-jet recording medium 90.

The ink-jet recording device 600 is capable of forming the undercoat U with an improved surface state on the recording medium P, so the undercoating liquid is applied onto the recording medium P by using the coating roll 60 in the undercoat forming section 13 in such a manner that the coating liquid is applied onto the recording medium P through its rotation in the direction opposite to the direction of travel by the recording medium P. However, this is not the sole case of the invention, but any of various application methods satisfying the relation:

X≦5V

[where the distance of travel of the recording medium between the position C at which the undercoating liquid is applied onto the recording medium from an undercoating liquid applying means and the position H at which the recording medium having the undercoating liquid applied thereonto is irradiated with ultraviolet light from an undercoating liquid semi-curing section to semi-cure the undercoating liquid on the recording medium is denoted by X (mm) and the travel velocity off the recording medium P is denoted by V (mm/s)] may be used. Use may be made of undercoating liquid applying means making use of various techniques including roll coating performed by rotating the coating roll in the same direction as the direction of travel by the recording medium P, spray coating, gravure coating, air knife coating, extrusion coating, curtain coating, wire bar coating, and felt coating.

Also in the case of applying the undercoating liquid to the recording medium by any another method than the method using the coating roll, if the relation:

X≦5V

[where the distance of travel of the recording medium between the position C at which the undercoating liquid is applied onto the recording medium from an undercoating liquid applying means and the position H at which the recording medium having the undercoating liquid applied thereonto is irradiated with ultraviolet light from an undercoating liquid semi-curing section to semi-cure the undercoating liquid on the recording medium is denoted by X (mm) and the travel velocity of the recording medium P is denoted by V (mm/s)] is satisfied, the undercoating liquid can be prevented from permeating the recording medium P, thus offering the above-mentioned various effects such as a capability to form high-resolution images on the recording medium.

The digital label printer using the ink-jet recording device of the invention is described below.

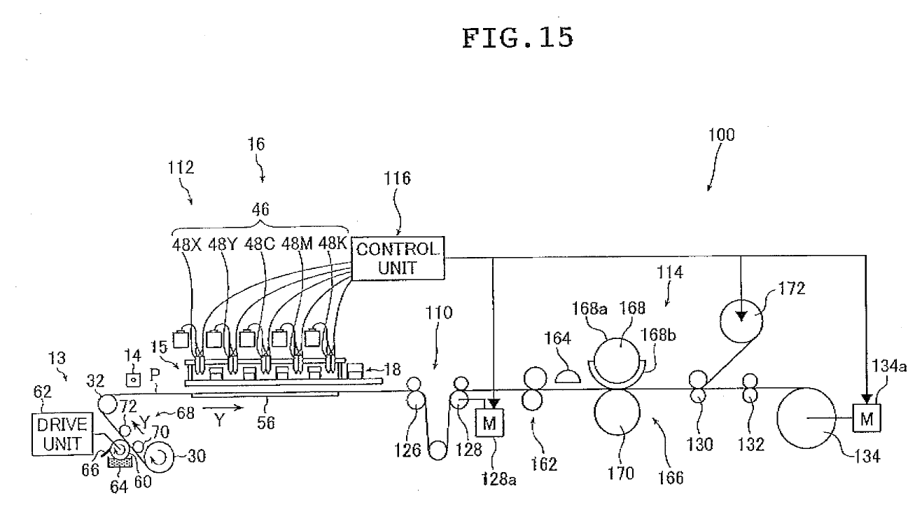

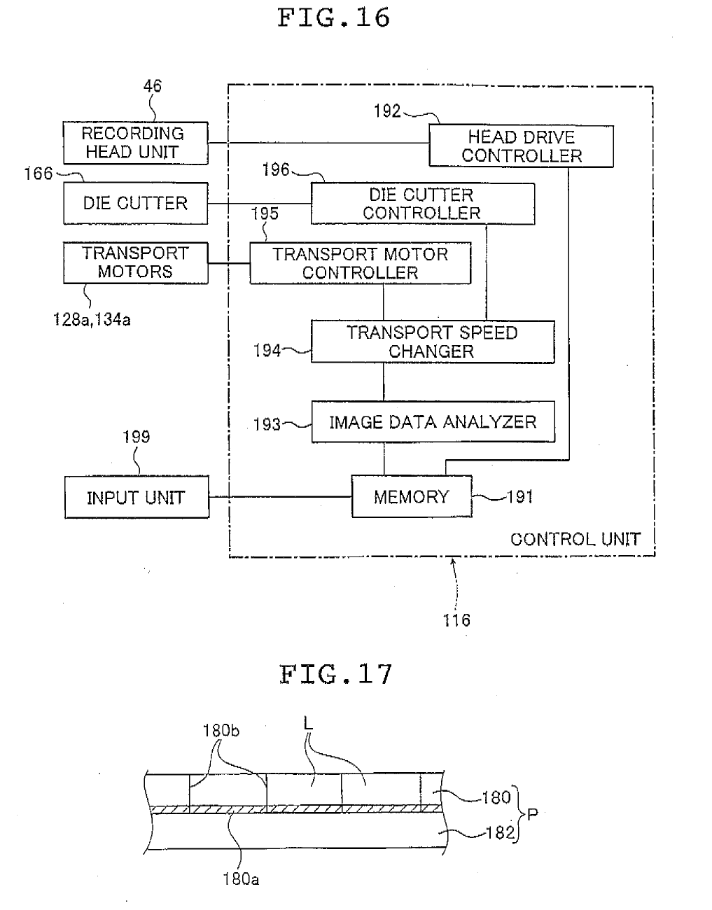

FIG. 15 is a front view showing, in simplified form, a digital label printer which uses an ink-jet recording device according to one embodiment of the invention, FIG. 16 is a block diagram illustrating a control unit for controlling the digital label printer shown in FIG. 15, and FIG. 17 is a longitudinal sectional view of a recording medium P for printing labels such as may be used in the digital label printer shown in FIG. 15.

A digital label printer in the present embodiment records an image onto a web-type recording medium P for printing labels (also referred to below as simply “recording medium”) at an image forming section, then makes label-shaped slits in the medium P with a die cutter in a post-treatment section. In addition, the printer carries out, as a subsequent step, a waste removal operation in which unnecessary portions of the pressure-sensitive adhesive sheet are peeled from the backing sheet (peel sheet) and removed.

In each of the embodiments appearing below, an active ray curing-type digital label printer which uses a UV-curable ink as the active ray-curable ink that cures upon exposure to active rays is described by way of illustration. However, the invention is not limited in this regard, and may be applied to digital label printers which use any of various kinds of active ray-curable inks, as well as to any other type of digital label printer.

Referring to FIG. 17, the recording medium P used in the present embodiment has a two-layer construction composed of a peel sheet 182 as a backing sheet on which is laminated a pressure-sensitive adhesive sheet 180 coated on the back side thereof with a pressure-sensitive adhesive 180a.

As shown in FIG. 15, a digital label printer 100 has a transport section 110; an undercoat forming section 13; an undercoating liquid semi-curing section 14; an image forming section 112 including a support section 15, an image recording section 16 and an image fixing section 18; a post-treatment section 114; and a control unit 116.

Here, the transport section 110 transports the web-type recording medium P for printing labels in a fixed direction (from left to right in FIG. 15). The image forming section 112 and the post-treatment sections 114 are arranged in this order in the direction of travel of the recording medium P; that is, in the upstream to downstream direction, more specifically in the order of the undercoat forming section 13, the undercoating liquid semi-curing section 14, the image forming section 112 and the post-treatment section 114. Although partially not shown in FIG. 15, the control unit 116 is connected to the undercoat forming section 13, the undercoating liquid semi-curing section 14, the transport section 110, the image forming section 112 and the post-treatment section 114, and controls their respective operations.

The transport section 110 has a feed roll 30, a transport roll 32, transport roller pairs 126, 128, 130 and 132, a product roll 134, and transport motors 128a and 134a.

The feed roll 30 has the web-type recording medium P for printing labels wound thereon in the form of a roll.

The transport roll 32 and the transport roller pairs 126, 128, 130 and 132 are arranged in this order from the upstream to the downstream side of the travel path of the recording medium P. The transport roll 32 and the transport roller pairs 126, 123, 130 and 132 let out the recording medium P from the feed roll 30, and transport the recording medium P in a given direction (in the present embodiment, from left to right in FIG. 15).

As in the ink-jet recording device 10 described above, the transport roll 32 changes the travel path of the recording medium P from the obliquely upward direction to the horizontal direction.

The product roll 134, which is disposed the furthest downstream on the recording medium P travel path, i.e., in the direction of transport, takes up the recording medium P that has been transported over the travel path by the transport roll 32 and the transport roller pairs 126, 126, 130 and 132 and has passed through the undercoat forming section 13, the undercoating liquid semi-curing section 14, the image forming section 112, and the post-treatment section 114.

The transport motors 128a and 134a are connected to, respectively, the transport roller pair 128 and the product roll 134, and rotatably drive the transport roller pair 128 and the product roll 134.

That is, in the present embodiment, the transport roller pair 128 and the product roll 134 connected to the transport motors 128a and 134a, respectively, are driven to rotate and thus serve as the drive rollers for transporting the recording medium P. The other transport roller pairs 126, 130 and 132 and the transport roll 32 are driven rollers which rotate with movement of the recording medium P and regulate the recording medium P on the travel path.

In the transport section 110, the transport motors 128a and 134a rotatably drive the transport roller pair 128 and the product roll 134. Through this arrangement, the recording medium P is let out from the feed roll 30, passes through the undercoat forming section 13, the undercoating liquid semi-curing section 14, the image forming section 112, and the post-treatment section 114, and is taken up onto the product roll 134.

In the present embodiment, a transport buffer is provided between the image forming section 112 and the post-treatment section 114.

By providing such a transport buffer, it is possible to absorb slack that arises in a web-type recording medium P for printing labels due to a difference between the transport speed in the image forming section 112 and that in the post-treatment section 114, thus enabling the labels to be efficiently produced.

The transport motors 128a and 134a are connected to a subsequently described transport motor controller 195 and their rotational speeds thereby controlled. This in turn controls the speed at which the web-type recording medium P for printing labels is transported by the transport section 110.

No particular limitation is imposed on the transport roller pairs which function as drive roller pairs. For example, transport motors may be provided for all the transport roller pairs, so that all the transport roller pairs function as drive roller pairs.

As described above, the undercoat forming section 13 includes a coating roll 60, a drive unit 62, a reservoir 64, a blade 66 and a positioning unit 68. The layout and function of each element of the undercoat forming section 13 are the same as those in the undercoat forming section 13 of the ink-jet recording device 10 as described above, and therefore their detailed description is omitted.

The coating roll 60 of the undercoat forming section 13 contacts the recording medium P as it is rotated in the direction opposite to the direction of travel by the recording medium P, whereby the undercoating liquid is applied onto the surface of the recording medium P.

The undercoat is thus formed on the surface of the recording medium P.

The undercoating liquid semi-curing section 14 is disposed on the downstream side of the undercoat forming section 13 in the direction of travel by the recording medium P. The layout and function of the undercoating liquid semi-curing section 14 in this embodiment are the same as those of the undercoating liquid semi-curing section 14 of the ink-jet recording device described above and therefore their detailed description is omitted here.

The undercoating liquid semi-curing section 14 semi-cures the undercoat by irradiating with ultraviolet light the recording medium P which has the undercoat formed thereon through application of the undercoating liquid and which is transported by the transport section 110 to pass through the position opposed thereto.

The image forming section 112 includes the support section 15, the image recording section 16 and the image fixing section 18.

The support section 15, the image recording section 16 and the image fixing section 18 are configured in the same manner as the support section 15, the image recording section 16 and the image fixing section 18 of the ink-jet recording device shown in FIG. 1 and therefore their detailed description is omitted.

Also in the image forming section 112, recording heads 48X, 48Y, 49C, 48M and 48K of a recording head unit 46 in the image recording section 16 are disposed on a head plate 40 supported by a body plate 38 of the support section 15 disposed so as to face the path of travel by the recording medium P. On the body plate 38 are disposed individually supported UV irradiators 54 of the UV irradiation units 52X, 52Y, 52C, 52M and UV irradiators 54a of the final UV irradiation unit for curing 52a.

As above, the recording heads 48X, 48Y, 48C, 48M and 48K as well as the UV irradiation units 52X, 52Y, 52C, 52M are arranged, from the upstream to the downstream side in the direction of travel by the recording medium P, in the following order: recording head 48X, UV irradiation unit 52X, recording head 48Y, UV irradiation unit 52Y, recording head 48C, UV irradiation unit 52C, recording head 48M, UV irradiation unit 52M, recording head 48K and final UV irradiation unit for curing 52a.

The image forming section 112 ejects ink droplets from each of the recording heads, then cures the ink droplets on the recording medium P by applying UV light from each of the UV irradiation units 52X, 52Y, 52C, 52M and 52a, thereby forming an image.

The post-treatment section 114 is disposed on, in the recording medium P travel direction, the downstream side of the UV irradiation unit 52a corresponding to the recording head 48K. It has a varnish coater 162 and an UV irradiator 164 for coating the image surface with a clear, active ray-curable liquid (in the present embodiment, a clear, UV-curable liquid) and improving the gloss, a die cutter 166 for making label-shaped slits in the web-type recording medium P, and a waste roll 172 for peeling off unnecessary portions of the recording medium P.

As described above, the transport buffer is provided between the UV irradiation unit 52a corresponding to the recording head 48K and the varnish coater 162.

The varnish coater 162 is a clear liquid feeding means which feeds active rays (in this embodiment, ultraviolet light) curable clear liquid (referred to below as “active ray-curable clear liquid” or simply “clear liquid”) to the surface of the recording medium P, and which is situated on the downstream side, in the travel direction of the recording medium P, of the UV irradiation unit 52a corresponding to the recording head 48K.

The varnish coater 162 has a pair of coating rolls to the surface of which adheres (on which has been impregnated) a UV-curable clear liquid, and which rotate in accordance (synchronous) with movement of the recording medium P while nipping the recording medium P, thereby coating the surface of the foil-stamped recording medium P (the side on which an image has been formed) with the UV-curable clear liquid.

Here, the clear liquid coated by the varnish coater 162 is an active ray-curable clear liquid which can be cured by exposure to ultraviolet light. Exemplary clear liquids include cationic-polymerizable compositions, radical-polymerizable compositions and aqueous compositions which contain as the primary ingredients at least a polymerizable compound and a photoinitiator. The clear liquid is described in detail later in the specification.

The UV irradiator 164 is disposed on the downstream side of the varnish coater 162 in the travel direction of the recording medium P. The UV irradiator 164 irradiates the surface of the recording medium P with active rays (in this embodiment, ultraviolet light), thereby curing the UV-curable clear liquid that has been coated onto the surface of the recording medium P. The UV irradiator 164 may have a structure in which a plurality of UV irradiators are linearly arranged as in the above-mentioned UV irradiation units. The UV irradiator 164 may also adopt various layouts such as the one shown in the UV irradiators 54 described above.

The UV-curable clear liquid is coated onto the surface of the recording medium P and cured, enabling luster to be imparted to the image side of the recording medium P and making it possible to improve the image quality.

The die cutter 166 makes slits 180b of a desired label shape in only the pressure-sensitive adhesive sheet 180 of a printed, web-type recording medium P for printing labels, as shown in FIG. 17. The die cutter 166 is situated on the downstream side of the UV irradiator 164 in the travel direction of the recording medium P, and has a cylinder cutter 168 disposed on the image-forming side of the recording medium P and an anvil roller 170 disposed on the opposite side of the recording medium P from the cylinder cutter 168.

The cylinder cutter 16R is composed of a cylinder 168a and a plurality of slitting blades 168b which axe wound around the cylindrical surface of the cylinder 168a and are formed according to the shape and arrangement of the labels.

The die cutter 166, while nipping the recording medium P between the cylinder cutter 168 and the anvil roller 170, undergoes an intermittently rocking rotation which is synchronous with the transport speed of the recording medium P, causing the slitting blades 168b to make label-shaped slits in only the pressure-sensitive adhesive sheet 180 of the recording medium P (see FIG. 17).

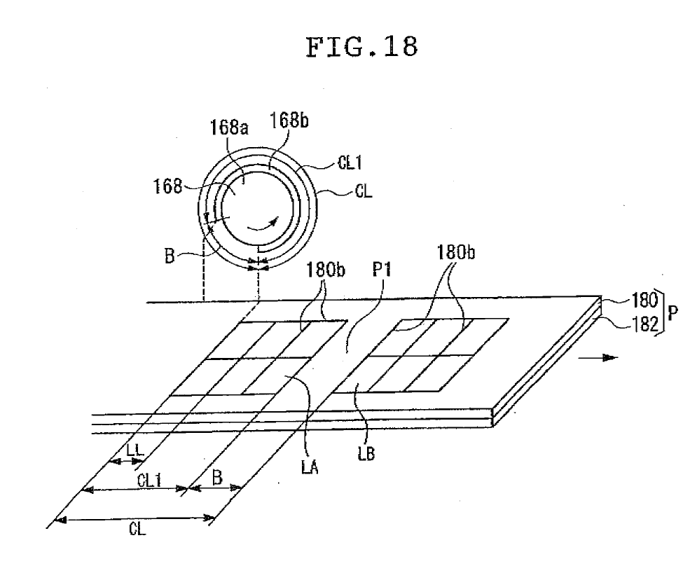

Here, referring to FIG. 18, if the cylindrical surface of the cylinder 168a has a length CL in the circumferential direction which is not an integral multiple of the length LL of the labels L, that is, if the length CL in the circumferential direction of the cylindrical surface of the cylinder 168a and the length CL1 of the slitting blades 168b do not agree, there arises on the cylindrical surface of the cylinder 168a a blank portion B where the slitting blades 168b cannot be provided.

In this case, when label-shaped slits 180b are formed by continuously rotating the die cutter 166, a large unnecessary portion P1 corresponding to the blank portion B ends up being formed between the group of labels LB in which slits 180b have been formed during the previous rotation of the die cutter 166 and the group of labels LA in which slits 180b have been formed during the present rotation, resulting in the generation of waste in the web-type recording medium P for printing labels.

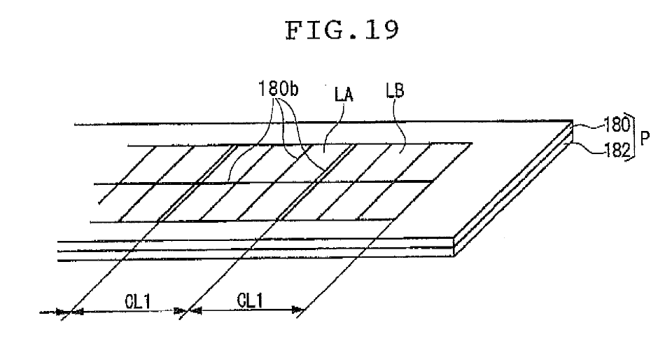

In the present embodiment, to eliminate the wasteful formation of unnecessary portions P1 in the recording medium P, the die cutter 166 is made to rotate with an intermittently rocking motion. In this way, as shown in FIG. 19, the next slits 180b can be made at the trailing end of the group of labels LB in which the previous slits 180b were made. In this way, even when the length CL in the circumferential direction of the cylindrical surface of the cylinder 168a is not an integral multiple of the length LL of the labels L, unnecessary portions P1 are not formed between the groups LB and LA of labels L, thus enabling a web-type recording medium P for printing labels to be efficiently used.

The waste roll 172 peels from the peel sheet 182 and takes up unnecessary portions (label borders) of the pressure-sensitive adhesive sheet 180 which do not form labels (finished product) L.

The thus taken up recording medium P after unnecessary portions have been peeled, that is, the recording medium P in a state where only the labels L remain adhering to the peel sheet 182, is when taken up onto the product roll 134, giving the final product.

Next, the control unit 116 which controls the transport section 110, the image forming section 112, and the post-treatment section 114 is described.

As shown in FIG. 16, the control unit 116 has a memory 191 which stores recording image data for ink ejection from the recording heads 49X, 48Y, 48C, 48M and 48K of the recording head unit 46, a head drive controller 192 for controlling the drive of the recording heads 48X, 48Y, 48C, 48M and 49K of the recording head unit 46 based on the recording image data, an image data analyzer 193 for analyzing the shapes of the labels L based on the image data stored in the memory 191, a transport speed changer 194 for changing the transport speed of the web-type recording medium P for printing labels based on the shapes of the labels L analyzed by the image data analyzer 193, the transport motor controller 195 for controlling the rotational speed of the transport motors 128a and 134a based on the transport speed changed by the transport speed changer 194, and a die cutter controller 196 for controlling the rotational speed of the die cutter 166 based on the transport speed changed by the transport speed changer 194.

In addition, an input unit 199 such as a computer is connected to the memory 191 of the control unit 116. The memory 191 stores recording image data that has been input from the input unit 199.

The head drive controller 192, based on the image data stored in the memory 191, selects ink droplet-ejection orifices in the recording heads 48X, 48Y, 48C, 48M and 48K of the recording head unit 46, computes the amount of ink droplets to be ejected, the ejection timing and other parameters, and controls the recording head unit 46 based on the computation results. To illustrate, in the case of piezoelectric ink-jet heads such as those in the present embodiment, in accordance with image data, the piezoelectric element to which a voltage will be applied is selected from among a plurality of ejection portions (nozzles), and the voltage to be applied, the period of application and the timing of such application are computed, Ejection signals are sent to the recording heads 48X, 48Y, 48C, 48M and 48K based on the computation results.

The image data analyzer 193 analyzes the shape of a label L from label edge data among the image data stored in the memory 191, and sends the results of analysis to the transport speed changer 194.

The transport speed changer 194 has pre-stored therein the transport speed optimal to post-treatment for each label L shape. Based on both the shape of the label L computed from the label edge data analyzed by and received from the image data analyzer 193 and the stored transport speed, the transport speed changer 194 computes the optimal transport speed of the recording medium P and sends the computation results to the transport motor controller 195 and the die cutter controller 196.

The transport motor controller 195 controls the rotational speeds of the transport motors 128a and 134a based on the optimal transport speed computed by the transport speed changer 194. In this way, the web-type recording medium P for printing labels is transported at the optimal speed.

The die cutter controller 196 controls the rotational speed of the die cutter 166 based on the optimal transport speed computed by the transport speed changer 194. Specifically, the die cutter controller 196 controls the rotational speed of the die cutter 166 so that the transport speed of the recording medium P and the circumferential velocity of the slitting blades 168b on the die cutter 166 are the same.

The control unit 116 thus changes or regulates, based on label shape data calculated from the label edge data, the transport speed of the recording medium P which is transported through the post-treatment section 114.

In addition, it is preferable for the transport speed changer 194 to control, based on the label L shape data, the transport speed of the recording medium P so as to slow the speed at positions of label portions that are vulnerable to the peeling of unnecessary portions. This helps prevent breakage or rupture from occurring when the waste is removed, enabling the reliable removal of unnecessary portions other than the label portions.

The conditions under which breakage or rupture tend to occur when unnecessary portions are peeled off differ depending on the material of which the pressure-sensitive adhesive paper is made. For example, breakage or rupture may occur when the width of the unnecessary portions is not more than 5 mm or when such portions have an acute angle of not more than 30°. It is advantageous to set in the transport speed changer 194 optimal peel rates that have been determined beforehand empirically under various conditions and to compute the optimal transport speed of the recording medium P while also taking into account these optimal peel rates.

Next, a method for producing labels with the digital label printer 100 is described.

Referring to FIG. 15, the recording medium P that has been let out from the feed roll 30 onto which it is wound into a roll is transported by the transport section 110 to the image forming section 112 after the undercoating liquid has been applied with the coating roll 60 of the undercoat forming section 13 and the undercoat has been semi-cured in the undercoating liquid semi-curing section 14.

The recording medium P transported to the image forming section 112 passes through the positions opposite the recording heads 48X, 48Y, 48C, 48M and 48K.

The recording heads 48X, 48Y, 49C, 48M and 48K eject, under control by the control unit 116, droplets of UV-curable ink onto the recording medium P passing through positions opposed thereto. The recording medium P onto which the ink has been ejected then travels further and passes through positions opposite the UV irradiators 54 and 54a of the corresponding UV irradiation units 52X, 52Y, 52C, 52M and 52a, where it is irradiated with ultraviolet light, thereby curing the ink.

That is, when the recording medium P passes through positions opposite the recording heads 48X, 48Y, 48C, 48M and 48K, ink droplets are ejected onto the recording medium P from the recording heads 48X, 48Y, 48C, 48M and 48K. The recording medium P is subsequently exposed to ultraviolet light from the UV irradiation units 52X, 52Y, 52C, 52M, causing the ink to cure. After the image formation with the recording head 48K, ultraviolet light is emitted from the final UV irradiation unit for curing 52a to ensure curing of the various inks and undercoating liquid. An image is thus formed on the surface of the recording medium P.

The recording medium P on which images have been formed is transported through the transport buffer to the post-treatment section 114, where a PV-curable clear liquid is applied by the varnish coater 162 to the surface of the recording medium P, then is cured by the UV irradiator 164.

The recording medium P that has been coated with the UV-curable clear liquid is transported to the die cutter 166, where slits 180b in the shape of labels L are made only in the pressure-sensitive adhesive sheet 180 by means of the cylinder cutter 168 and the anvil roller 170.

At this time, because the die cutter 166, as noted above, makes slits 180b in the shape of labels L while intermittently rocking, the slits 180b can be continuously formed. Waste from the recording medium P can thus be minimized.

Unnecessary portions (portions other than the labels L) of the pressure-sensitive adhesive sheet 130 of the recording medium P are peeled from the peel sheet 182 and taken up onto the waste roll 172. The recording medium P on which only the labels L remain affixed to the peel sheet 182 is taken up onto the product roll 134, thereby giving a final product.

As described above, the digital label printer 100 as well enables the undercoat formed to have a small surface roughness by applying the undercoating liquid onto the recording medium P as the coating roll 60 of the undercoat forming section 13 is rotated in the direction opposite to the direction of travel by the recording medium P. Therefore, images without unevenness can be formed on the recording medium to achieve production of high-resolution and high-quality labels.

Moreover, the digital label printer 100 of the present embodiment carries out peel processing in which the transport speed changer 194, based on label shape data, slows the transport speed of the recording medium P at positions of label portions which are vulnerable to the peeling of unnecessary portions, thereby preventing the breakage or rupture of the labels L during post-treatment (waste removal) and enabling the reliable removal of unnecessary portions other than the label portions. In this way, halting of the apparatus due to the breakage or rupture of labels L is eliminated, enhancing productivity and making it possible to inexpensively provide labels L.

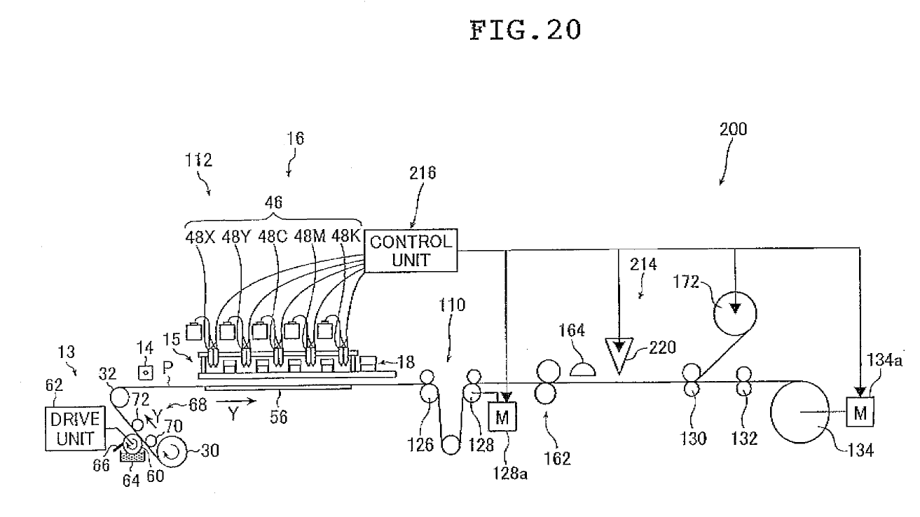

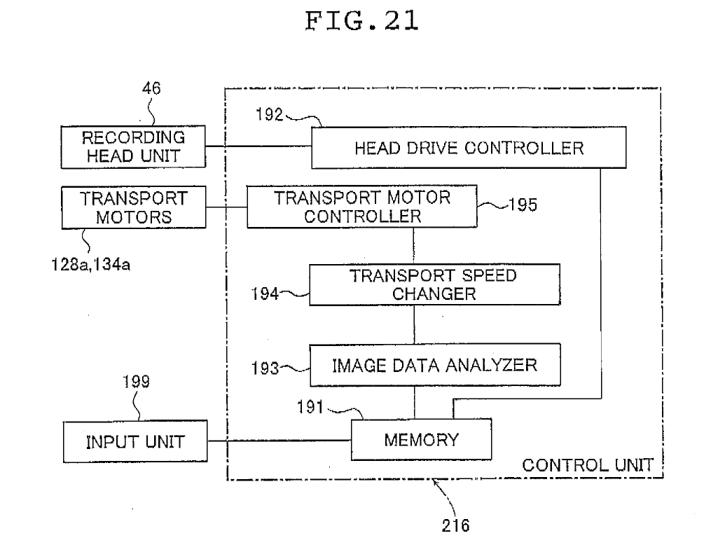

Another embodiment of a digital label printer is described below while referring to FIGS. 20 and 21.

FIG. 20 is a front view showing, in simplified form, another embodiment of a digital label printer which employs the ink-let recording device of the invention. FIG. 21 is a block diagram illustrating a control unit for controlling the digital label printer shown in FIG. 20.

A digital label printer 200 shown in FIG. 20 has an arrangement which, aside from a post-treatment section 214, is the same as that of the digital label printer 100 shown in FIG. 15. Like elements in both embodiments are thus denoted by the same reference symbols and repeated explanations of such elements are omitted below. The following description focuses on the distinctive features of the digital label printer 200.

As shown in FIG. 20, the post-treatment section 214 of the digital label printer 200 has a varnish coater 162, a UV irradiator 164, a laser cutter 220, and a waste roll 172. Because the varnish coater 162, the UV irradiator 164 and the waste roll 172 are the same as the varnish coater 162, the UV irradiator 164 and the waste roll 172 in the post-treatment section 114 of the digital label printer 100 shown in FIG. 15, detailed explanations of these elements are omitted below.

The laser cutter 220, like the die cutter 166 of the digital label printer 100 shown in FIG. 15, makes slits 180b of a desired label shape in only the pressure-sensitive adhesive sheet 180 of a printed, web-type recording medium P for printing labels. It is situated between the UV irradiator 164 and the waste roll 172.

The laser cutter 220 shines a laser at the traveling web-type recording medium P Fox printing labels, making label-shaped slits 180b in only the pressure-sensitive adhesive sheet 180.

A control unit 216 has a memory 191 which stores recording image data for ink ejection from recording heads 48X, 48Y, 48C, 48M and 48K of a recording head unit 46, a head drive controller 192 which sends the image data to be recorded to the recording heads 48X, 48Y, 48C, 48M and 48K of the recording head unit 46, an image data analyzer 193 which analyzes the shapes of the labels L, a transport speed changer 194 which changes the transport speed of the web-type recording medium P for printing labels based on the shapes of the labels L analyzed by the image data analyzer 193, a transport motor controller 195 which controls the rotational speed of transport motors 128a and 134a based on the transport speed changed by the transport speed changer 194. Hence, the control unit 216 in the present embodiment, aside from having no die cutter controller 196, is of substantially the same construction as the control unit 116 shown in FIG. 17.

The image data analyzer 193 analyzes the image densities of the label edges based on the image data stored in the memory 191 and sends the analysis result to the transport speed changer 194.

The transport speed changer 194 of the control unit 216 in this embodiment computes the transport speed of the recording medium P in accordance with the density in the image density data for the label edges to be cut by the laser cutter 220.

That is, the transport speed changer 194, which has previously stored therein the optimal post-treatment transport speeds for image densities, computes the optimal transport speed based on both the label edge image density that has been analyzed by the image data analyzer 193 and received therefrom and on the transport speeds stored in memory, then sends the computation results to the transport motor controller 195.

Specifically, control is effected so as to slow the transport speed of the recording medium P at positions in the label edge where the image density is high. In this way, in places where the image density is high, that is, where the label L has a high thickness, and which are thus difficult to cut through with a laser, slowing the transport speed allows more energy to be applied, enabling label-shaped slits 180b to be made in the pressure-sensitive adhesive sheet 180.

Here, at the transport speed changer 194, the conditions for setting the transport speed are not limited to the image density (i.e., the ink film thickness). For example, various other properties of the materials, such as the laser light-absorbing properties of the ink, may also be taken into account. The optimal transport speed may be determined empirically in advance for various conditions and set in the transport speed changer 194.

The transport motor controller 195 controls the rotational speed of the transport motors 128a and 134a based on the transport speeds that have been changed by the transport speed changer 194. Here, the web-type recording medium P for printing labels is transported at an optimal speed.

Next, a method for producing labels using this digital label printer 200 is described. Image formation in an image forming section 112 on the surface of the recording medium P that has been let out from a feed roll 30 is carried out in the same way as in the above-described digital label printer 100.

The recording medium P on which an image has been formed passes through a transport buffer and is transported to the post-treatment section 214, where a UV-curable clear liquid is coated onto the surface of the recording medium P using the varnish coater 162, then cured using the UV irradiator 164.

The recording medium P on which the UV-curable clear liquid has been coated is transported to the laser cutter 220, where it is irradiated with a laser so as to form slits 180b in the shape of labels L only in the pressure-sensitive adhesive sheet 130.

Next, unnecessary portions (portions other than the labels L) of the pressure-sensitive adhesive sheet 180 of the recording medium P are peeled from the peel sheet 182 and taken up by the waste roll 172. The recording medium P on which only the labels L remain affixed to the peel sheet 182 is wound onto a product roll 134, thereby giving a final product.

Here, in laser cutting, it is necessary to increase the energy in accordance with the thickness of the label L. The thicker the label L, the more energy is required.

When an active ray-curable ink is used, the cured ink that is formed on the pressure-sensitive adhesive sheet 190 swells outward. The swell height of the cured ink may be, for example, about 12 μm. In a color printed area where a plurality of inks (X, Y, C, M, K) are deposited on top of each other, this height becomes even greater. When active ray-curable ink is employed, because recording media P which do not absorb any ink whatsoever are commonly employed, the swell height may increase even further. Also, in areas of high image density, a large amount of ink is deposited. Hence, the swell height also increases, resulting in an even greater thickness. The minimum thickness of a recording medium P for printing labels is about 12 μm, which is thinner even than the ink thickness, further increasing the influence of the ink thickness.

The digital label printer 200 of the present embodiment deals with this problem in the post-treatment step by using the transport speed changer 194, which adjusts the transport speed of the recording medium P in accordance with the density in the image density data at the label edges; specifically, slows the transport speed of the recording medium P when cutting thick areas with the laser. By cutting areas where the image density is high and the ink such as active ray-curable ink has a large thickness at a slow speed with the laser cutter 220, slits can be reliably made in only the pressure-sensitive adhesive sheet and locally incomplete cuts can be prevented from occurring.

Labels can be efficiently produced without forming blank portions on the recording medium.

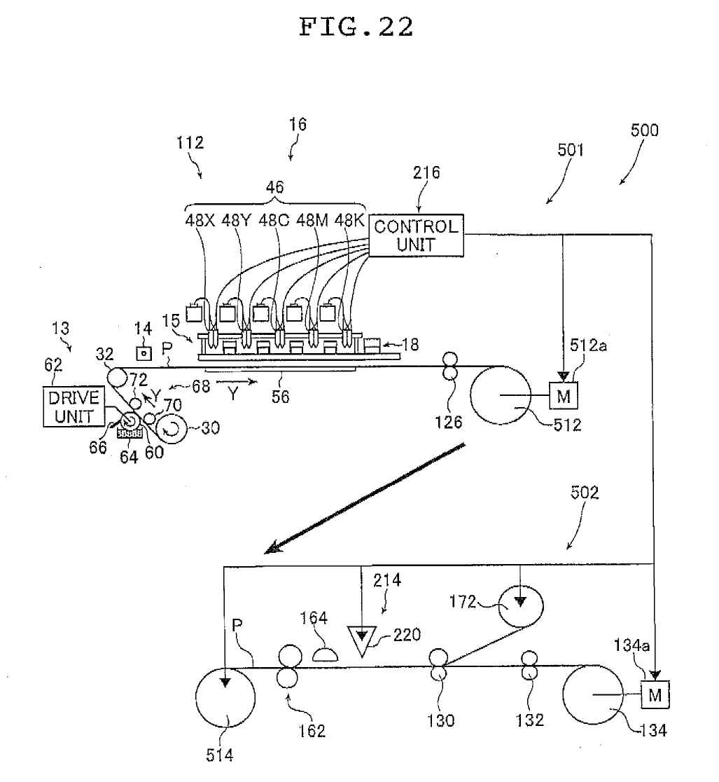

Next, yet another embodiment of a digital label printer is described below in conjunction with FIG. 22.

FIG. 22 is a front view showing, in simplified form, yet another embodiment of a digital label printer 500 which uses the ink-jet recording device of the invention.

In the digital label printer 500 shown in FIG. 22, the configuration of the respective sections, aside from an undercoat forming section 13 integrated with an image forming section 112 and a post-treatment section 214 being furnished as independent and discrete apparatus, is basically the same as that in the digital label printer 200 shown in FIG. 20. Like elements in both embodiments are thus denoted by the same reference symbols and repeated explanations of such elements are omitted below. The following description focuses on the distinctive features of the present digital label printer 500.

As shown in FIG. 22, the digital label printer 500 has a front-end processing unit 501 which includes the undercoat forming section 13 and the image forming section 112, and a back-end processing unit 502 which includes the post-treatment section 214.

A method for producing labels using the digital label printer 500 and the elements distinctive of the present digital label printer 500 are described below.

The recording medium P is set on a first feed roll 30 in the front-end processing unit 501, and is transported by a transport roll 32 and a transporter roller pair 126 to the undercoat forming section 13, where the undercoating liquid is applied to the recording medium P. The undercoat formed thereon is then semi-cured in the undercoating liquid semi-curing section 14. Thereafter, the recording medium P is transported to the image forming section 112. Next, using recording heads 48X, 48Y, 48C, 48M and 40K and UV irradiation units 52X, 52Y, 52C, 52M and 52a, an image is formed on the surface of the recording medium P that has been transported to the image forming section 112. The recording medium P on which the image has been formed is taken up onto a collecting roll 512. In the present embodiment, a drive motor 512a is provided for the collecting roll 512 so that the collecting roll 512 serves as a drive roll.

The recording medium P on which the image has been formed, i.e., the recording medium P that has been taken up onto the collecting roll 512, is then set on a second feed roll 514 in the back-end processing unit 502. The recording medium P that has been set on the second feed roll 514 is transported by transport roller pairs 130 and 132 to the post-treatment section 214.

The recording medium P on which the image has been formed has a UV-curable clear liquid applied thereto with a varnish coater 162, following which the recording medium P is irradiated with ultraviolet light from a UV irradiator 164, thereby curing the UV-curable clear liquid that has been applied.

Next, the recording medium P passes by a laser cutter 220 where slits corresponding to the shape of the labels L are made in only the pressure-sensitive adhesive sheet by the laser cutter 220, after which unnecessary portions of the pressure-sensitive adhesive sheet of the recording medium P are peeled from the peel sheet and wound onto a waste roll 172. At the same time, the recording medium P from which the unnecessary portions have been removed so as to leave only the label portions of the pressure-sensitive adhesive sheet 180 and the peel sheet 182, is wound onto a product roll 134, thereby giving a finished product.

In this embodiment as well, a transport speed changer 194 computes the optimal transport speed based on the label edge image density analyzed by an image data analyzer 193. A transport motor controller 195 controls the rotational speed of a transport motor 114a to the optimal transport speed that has been computed, and carries out transport of the recording medium P. That is, when the laser cutter 220 is used to cut areas where the label edges have a high image density, the transport motor controller 195 carries out control that slows the transport speed of the recording medium P.

In this way, by configuring the digital label printer as separate front-end and back-end processing units, the front-end processing steps of printing the labels L and smoothing the image surfaces, and the back-end processing steps of foil-stamping, clear liquid coating (glossy surface formation), slitting and waste removal can be carried out as separate operations, enabling the back-end processing of numerous different types of labels L to be carried out collectively.

The time required for printing is generally longer than the time required for waste removal and other back-end processing steps. Hence, a single back-end processing unit 502 is able to handle the output from a plurality of front-end processing units 501, making efficient processing possible.

Even in cases where the units are separated in this way, by controlling the transport speed in accordance with values obtained by computation based on image data, slits can be precisely made in only the pressure-sensitive adhesive sheet 180.

Each of the above-mentioned digital label printers has been described as a digital label printer using the ink-jet recording device 10, but the ink-jet recording device 600 may also be used in the same form in the digital label printers.

By forming the undercoat on the recording medium with a digital label printer using the ink-jet recording device 600, the ink droplets having been deposited onto the recording medium permeate it to prevent the image formed to be blurred, thus enabling a high-resolution image to be formed. Higher quality labels can be thus produced.

It becomes also possible to use a recording medium that has a low adhesion to ink droplets, namely, may repel deposited ink droplets. In other words, image recording on various recording media becomes possible, thus enabling labels to be produced from the various recording media.

Recording media, undercoats and inks that may be used with advantage in the ink-jet recording device of the invention are described below.

### (Physical Properties of Ink and Undercoat Liquid)

The physical properties of the ink (droplets) ejected onto the recording medium will differ with the device, although in general the viscosity at 25° C. is preferably from 5 to 100 mPa·s, and more preferably from 10 to 80 mPa·s. The viscosity at 25° C. before internal curing of the undercoat liquid is preferably from 10 to 500 mPa·s, and more preferably from 50 to 300 mPa·s.

In the practice of the invention, in order to form dots of the intended size on the recording medium, it is preferable for the undercoat liquid to include a surfactant, and more preferable that it satisfy conditions (A), (B) and (C) below.

(A) The undercoat liquid has a lower surface tension than any of the inks ejected onto the recording medium.
(B) At least one surfactant included in the undercoat liquid satisfies the relationship

γs(0)−γs(saturation)>0 (mN/m).

(C) The surface tension of the undercoat liquid satisfies the relationship

γs<(γs(0)+γs(saturation)^{max})/2.

Here, γs represents the surface tension of the undercoat liquid, γs (0) is the surface tension of the liquid from which all the surfactants in the undercoat liquid composition have been excluded, γs (saturation) is the surface tension of the liquid obtained by adding one of the surfactants included in the undercoat liquid to the above “liquid from which all the surfactants in the undercoat liquid composition have been excluded” and increasing the concentration of that surfactant until the surface tension reaches saturation, and γs (saturation)^{max} is the largest of the γs (saturation) values obtained for all the surfactants included in the undercoat liquid that satisfy above condition (B).

### Condition (A):

In the practice of the invention, as explained above, to form ink dots of the desired size on the recording medium, it is preferable for the surface tension γs of the undercoat liquid to be lower than the surface tension γk of any of the inks.

Also, to more effectively prevent expansion of the ink dots in the time interval between deposition and exposure, it is more preferable for γs<γk−3 (mN/m), and even more preferable for γs<γk−5 (mN/m).

When a full-color image is formed (printed), to enhance the sharpness of the image, the surface tension γs of the undercoat liquid is preferably lower than the surface tension of an ink containing a colorant having a high luminosity factor, and more preferably lower than the surface tension of all inks. Examples of colorants having a high luminosity factor include colorants which have magenta, black and cyan colors.

Moreover, for proper ejection, the ink surface tension γk and the undercoat liquid surface tension γs should satisfy the above-indicated relationship, with each being preferably within a range of from 15 to 50 mN/m, more preferably within a range of from 18 to 40 mN/m, and most preferably within a range of from 20 to 38 mN/m.

By having the surface tensions for both the ink and the undercoat liquid be at least 15 mN/m, the ink droplets to be ejected by the ink-jet heads can be suitably formed, making it possible to prevent improper ejection from occurring. That is, the ink droplets can be suitably ejected. Also, by having the surface tensions for both the undercoat liquid and the ink be up to 50 mN/m, the wettability with the ink-jet heads can be increased, enabling suitable ejection of the ink droplets. That is, the improper ejection of droplets can be prevented from occurring. By having the surface tensions for both be within a range of from 18 to 40 mN/n, and especially within a range of from 20 to 38 mN/m, the above effects can be better achieved and the ink droplets can be reliably ejected.

In the present embodiment, the surface tensions are values measured by the Wilhelmy plate method at a liquid temperature of 20° C. and 60% relative humidity using a commonly used surface tensiometer (e.g., the CBVP-Z surface tensiometer manufactured by Kyowa Interface Science Co., Ltd.).

### Conditions (B) and (C):

In the present invention, the undercoat liquid preferably includes one or more surfactants. By including one or more surfactants in the undercoat liquid, ink dots of the desired size can be more reliably formed on the recording medium. Moreover, it is preferable for the one or more surfactants included in the undercoat liquid to satisfy the following condition (B).

γs(0)−γs(saturation)>0 mN/m Condition (B)

In addition, it is preferable for the surface tension of the undercoat liquid to satisfy the following condition (C).

γs<(γs(0)+γs(saturation)^{max})/2 Condition (C)

As mentioned above, γs represents the surface tension of the undercoat liquid, γs (0) is the surface tension of the liquid from which all the surfactants in the undercoat liquid composition have been excluded, γs (saturated) is the surface tension of the liquid obtained by adding one of the surfactants included in the undercoat liquid to the above “liquid from which all the surfactants in the undercoat liquid composition have been excluded” and increasing the concentration of that surfactant until the surface tension reaches saturation, and γs (saturation)^{max} is the largest of the γs (saturation) values obtained for all the surfactants included in the undercoat liquid that satisfy above condition (B).

The above γs (0) value is obtained by measuring the surface tension of the liquid from which all the surfactants in the undercoat liquid composition have been excluded. The above γs (saturation) value is obtained by adding to the above “liquid from which all the surfactants in the undercoat liquid composition have been excluded” one of the surfactants included in the undercoat liquid and, while increasing the concentration of that surfactant present in the liquid in increments of 0.01 wt %, measuring the surface tension of the liquid when the amount of change in surface tension with respect to the change in surfactant concentration falls below 0.01 mN/m.

The above values of γs (0), γs (saturation) and γs (saturation)^{max} are described more fully below.

For example, when the ingredients making up the undercoat liquid (Example 1) are a high-boiling solvent (diethyl phthalate, available from Wako Pure Chemical Industries, Ltd.) a polymerizable material (dipropylene glycol diacrylate; available from Akcros Chemicals Ltd.), a polymerization initiator (TPO, Initiator 1 shown below), a fluorocarbon surfactant (Megaface F475, available from Dainippon Ink & Chemicals, Inc.) and a hydrocarbon surfactant (sodium di-(2-ethylhexyl)sulfosuccinate), the γs (0), γs (saturation)¹ (when a fluorocarbon surfactant has been added), γs (saturation)² (when a hydrocarbon surfactant has been added), γs (saturation) and γs (saturation)^{max} values are as indicated below.

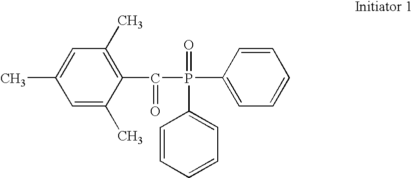

Namely, the value for γs (0), which is the surface tension of the liquid from which all the surfactants in the undercoat liquid have been excluded, is 36.7 mN/m. When the above fluorocarbon surfactant is added to this liquid, the saturation value γs (saturation)¹ for the surface tension of the liquid when the surfactant concentration has been increased is 20.2 mN/m. Similarly, when the hydrocarbon surfactant is added to this liquid, the saturation value γs (saturation)² for the surface tension of the liquid when the surfactant concentration has been increased is 30.5 mN/m.

Because the undercoat liquid (Example 1) includes two types of surfactants which satisfy above condition (B), γs (saturation) can have two values: one for when a fluorocarbon surfactant is added (γs saturation)¹, and another for when a hydrocarbon surfactant is added (γs (saturation)². Because γs (saturation)^{max} is the largest value among γs (saturation)¹ and γs (saturation)₂, in this case it is the γs (saturation)² value.

The above values are summarized below.

γs (0)=36.7 mN/m

γs (saturation)¹=20.2 mN/m (when fluorocarbon surfactant is added)

γs (saturation)²=30.5 mN/m (when hydrocarbon surfactant is added)

γs (saturation)^{max}=30.5 mN/m

From the above results, it is preferable for the surface tension γs of the undercoat liquid in the foregoing example to satisfy the following relationship:

γs<(γs(0)+γs(saturation)^{max})/2=33.6 mN/m.

With regard to above condition (C), to more effectively prevent ink droplet expansion during the period between deposition and exposure, it is preferable for the surface tension of the undercoat liquid to satisfy the relationship:

γs<γs(0)−3×(γs(0)−γs(saturation)^{max})/4,

and especially preferable for it to satisfy the relationship:

γs<γs(saturation)^{max}.

While it suffices for the compositions of the ink and the undercoat liquid to be selected so that the desired surface tension is obtainable, it is preferable for these liquids to include a surfactant. As already explained, to form ink dots of the desired size on the recording medium, it is preferable for the undercoat liquid to include at least one surfactant. A description of the surfactant follows below.

### (Surfactant)

The surfactant used in the invention is typically a substance having a strong surface activity with respect to at least one solvent from among hexane, cyclohexane, p-xylene, toluene, ethyl acetate, methyl ethyl ketone, butyl carbitol, cyclohexanone, triethylene glycol monobutyl ether, 1,2-hexanediol, propylene glycol monomethyl ether, isopropanol, methanol, water, isobornyl acrylate, 1,6-hexanediol diacrylate and polyethylene glycol diacrylate; preferably a substance having a strong surface activity with respect to at least one solvent from among hexane, toluene, propylene glycol monomethyl ether, isobornyl acrylate, 1,6-hexanediol diacrylate and polyethylene glycol diacrylate; more preferably a substance having a strong surface activity with respect to at least one solvent from among propylene glycol monomethyl ether, isobornyl acrylate, 1,6-hexanediol diacrylate and polyethylene glycol diacrylate; and most preferably a substance having a strong surface activity with respect to at least one solvent from among isobornyl acrylate, 1,6-hexanediol diacrylate and polyethylene glycol diacrylate.

Whether or not a particular compound is a substance having a strong surface activity with respect to the solvents listed above can be determined by the following procedure.

One solvent is selected from the solvents listed above, and the surface tension γₛₒₗᵥₑₙₜ (0) for that solvent is measured. The compound is added to the same solvent as that for which γₛₒₗᵥₑₙₜ (0) was determined and, as the concentration of the compound is increased in increments of 0.01 wt %, the surface tension γₛₒₗᵥₑₙₜ (saturation) of the solution when the change in surface tension with respect to the change in compound concentration falls below 0.01 mN/m is measured. If the relationship between γₛₒₗᵥₑₙₜ (0) and γₛₒₗᵥₑₙₜ (saturation) satisfies the condition

γₛₒₗᵥₑₙₜ(0)−γₛₒₗᵥₑₙₜ (saturation)>1 (mN/m),

it can be concluded that the compound is a substance having a strong surface activity with respect to the solvent.

Specific examples of surfactants which may be included in the undercoat liquid include anionic surfactants such as dialkylsulfosuccinic acid salts, alkylnaphthalenesulfonic acid salts, and fatty acid salts, nonionic surfactants such as polyoxyethylene alkyl ethers, polyoxyethylene alkylallyl ethers, acetylene glycols and polyoxyethylene polyoxypropylene block copolymers; cationic surfactants such as alkylamine salts and quaternary ammonium salts; and fluorocarbon surfactants. Other suitable surfactants include those mentioned in, for example, JP 62-173463 A and JP 62-183457 A.

### (Cure Sensitivity of Ink and Undercoat Liquid)

In the practice of the invention, the cure sensitivity of the ink is preferably comparable to or higher than the cure sensitivity of the undercoat liquid. The cure sensitivity of the ink is more preferably higher than the cure sensitivity of the undercoat liquid but not more than four times the cure sensitivity of the undercoat liquid, and even more preferably higher than the cure sensitivity of the undercoat liquid but not more than two times the cure sensitivity of the undercoat liquid.

As used herein, “cure sensitivity” refers to the amount of energy required for complete curing when the ink and/or the undercoat liquid is cured using a mercury vapor lamp (e.g., a ultrahigh-pressure, high-pressure or moderate-pressure mercury-vapor lamp; preferably an ultrahigh-pressure mercury vapor lamp). A smaller amount of energy means a higher cure sensitivity. Accordingly, a two-fold cure sensitivity means that the amount of energy required for complete curing is one-half as large.

Also, reference herein to a cure sensitivity as being “comparable” signifies that the difference in the cure sensitivities of the two liquids being compared is less than 2-fold, and preferably less than 1.5-fold.

### (Recording Medium)

The recording medium used in the ink-jet recording device of the present embodiment may be a permeable recording medium, an impermeable recording medium or a slowly permeable recording medium. Of these, the advantageous effects of the invention can be more clearly achieved with the use of an impermeable or slowly permeable recording medium. As used herein, “permeable recording medium” refers to a recording medium in which, when a 10 pL (picoliter) droplet is deposited on the recording medium, permeation of all the liquid takes not more than 100 ms. “Impermeable recording medium” refers herein to a recording medium in which a droplet substantially does not permeate. “Substantially does not permeate” connotes here a permeability of a droplet after 1 minute of not more than 5%. Also, “slowly permeable recording medium” refers herein to a recording medium in which, when a 10 pL droplet is deposited on the recording medium, permeation of all the liquid takes 100 ms or more.

Illustrative examples of permeable recording media include plain paper, porous paper, and recording media capable of absorbing other liquids.

Illustrative examples of impermeable or slowly permeable recording media include art paper, plastic, rubber, resin-coated paper, glass, metal, ceramic and wood. In the practice of the invention, composite recording media in which a plurality of these materials are combined may also be used for the purpose of adding the functionality thereof.

For plastic recording media, any suitable plastic may be used. Illustrative examples include polyesters such as polyethylene terephthalate and polybutadiene terephthalate, polyolefins such as polyvinyl chloride, polystyrene, polyethylene, polyurethane and polypropylene; and also acrylic resins, polycarbonate, acrylonitrile-butadiene-styrene copolymers, diacetate, triacetate, polyimide, cellophane and celluloid. The thickness and shape of the recording medium when a plastic is used are not subject to any particular limitation. That is, The recording medium may be in the form of a film-like, card-like or block-like shape, and may be either clear or opaque.

It is preferable to use as this plastic recording medium any of various types of film-like, non-absorbing plastics employed in soft packaging; or films made thereof. Illustrative examples of such plastic films include PET films, OPS films, OPP films, PNy films, PVC films, PE films, TAC films and PP films. Other plastics that may be used include polycarbonate, acrylic, ABS, polyacetal and PVA. Use may also be made of rubber.

Illustrative examples of resin-coated paper-type recording media include clear polyester films, opaque polyester films, opaque polyolefin resin films, and paper substrates laminated on both sides with a polyolefin resin. The use of a paper substrate laminated on both sides with a polyolefin resin is especially preferred.

Metal recording media are not subject to any particular limitation. For example, suitable use can be made of aluminum, iron, gold, silver, copper, nickel, titanium, chromium, molybdenum, silicon, lead, zinc and stainless steel, as well as composite materials thereof.

In addition, it is also possible to use as the recording medium read-only optical disks such as CD-ROMs and DVD-ROMs, write-once optical disks such as CD-Rs and DVD-Rs, and rewritable optical disks. In such cases, the image is preferably recorded on the “label” side of the disk.

### (Ink and Undercoat Liquid)

Inks and undercoat liquids suitable for use in the invention are described in detail below.

The ink, which has at least a composition suitable for forming images, includes at least one polymerizable or crosslinkable material, and optionally includes as well a polymerization initiator, a hydrophilic solvent, a colorant and other ingredients.

The undercoat liquid includes at least one polymerizable or crosslinkable material, and optionally includes as well a polymerization initiator, a hydrophilic solvent, a colorant and other ingredients. It is preferable for the undercoat liquid to be formulated so as to have a different composition than the ink.

The polymerization initiator is preferably a compound which is capable of initiating a polymerization reaction or crosslinking reaction under the influence of active energy rays. An undercoat liquid that has been applied to the coating medium can in this way be cured by exposure to active energy rays.

The undercoat liquid and/or the ink preferably includes a radical-polymerizable composition. As used herein “radical-polymerizable compositions” refers to a composition which includes at least one radical-polymerizable material and at least one radical polymerization initiator. Because the undercoat liquid and/or ink includes a radical-polymerizable composition, the undercoat liquid and/or ink curing reaction can be carried out at a high sensitivity in a short period of time.

Moreover, it is preferable for the ink to include a colorant. It is preferable for the undercoat liquid which is used in combination with this ink to either have a composition that includes no colorant or includes less than 1 wt % of colorant, or to have a composition that includes a white pigment as the colorant.

The various ingredients which make up the ink and/or undercoat liquid are described below.

### (Polymerizable or Crosslinkable Material)

The polymerizable or crosslinkable material has the function of triggering a polymerization or crosslinking reaction with initiating species such as radicals generated from, for example, the subsequently described polymerization initiator, and thus causing the composition containing these to cure.

The polymerizable or crosslinkable material employed may be a polymerizable or crosslinkable material which elicits a known polymerizable or crosslinking reaction such as a radical polymerization reaction and a dimerization reaction, Illustrative examples include addition-polymerizable compounds having at least one ethylenically unsaturated double bond, high molecular-weight compounds having pendant maleimide groups, and high-molecular-weight compounds having a pendant cinnamyl, cinnamylidene or chalcone group with a photodimerizable unsaturated double bond adjacent to an aromatic ring. Of these, an addition-polymerizable compound having at least one ethylenically unsaturated double bond is preferred. Selection from among compounds having at least one, and preferably two or more, terminal ethylenically unsaturated bonds (monofunctional or polyfunctional compounds) is especially preferred. More specifically, suitable selection may be made from among such compounds that are well-known in the industrial field of the invention, including those having the chemical form of, for example, monomers, prepolymers (i.e., dimers, trimers and oligomers) and mixtures thereof, as well as copolymers thereof.

The polymerizable or crosslinkable materials may be used singly or as a combination of two or more thereof.

The use as the polymerizable or crosslinkable material in the invention of, in particular, any of various known radical-polymerizable monomers in which a polymerization reaction is triggered by an initiating species generated from a radical initiator is preferred.

Examples of radical-polymerizable monomers include (meth)acrylates, (meth)acrylamides, aromatic vinyls, vinyl ethers and compounds having internal double bonds (e.g., maleic acid). Here, “(moth) acrylate” refers to either or both “acrylate” and “methacrylate,” and “(meth)acryl” refers to either or both “acryl” and “methacryl.”

Illustrative examples of (meth)acrylates are as follows:

Specific examples of monofunctional (meth)acrylates include hexyl (meth)acrylate, 2-ethylhexyl (moth)acrylate, tert-octyl (meth)acrylate, isoamyl (meth)acrylate, decyl (meth)acrylate, isodecyl (meth)acrylate, stearyl (meth)acrylate, isostearyl (meth)acrylate, cyclohexyl (meth)acrylate, 4-n-butylcyclohexyl (meth)acrylate, bornyl (meth)acrylate, isobornyl (meth)acrylate, benzyl (meth)acrylate, 2-ethyl hexyl diglycol (meth)acrylate, butoxyethyl (meth)acrylate, 2-chloroethyl (meth)acrylate, 4-bromobutyl (meth)acrylate, cyanoethyl (meth)acrylate, benzyl (meth)acrylate, butoxymethyl (meth)acrylate, 3-methoxybutyl (meth)acrylate, alkoxymethyl (meth)acrylate, alkoxyethyl (meth)acrylate, 2-(2-methoxyethoxy)ethyl (meth)acrylate, 2-(2-butoxyethoxy)ethyl (meth)acrylate, 2,2,2-trifluoroethyl (meth)acrylate, 1H,1H, 2H,2H-perfluorodecyl (meth)acrylate, 4-butylphenyl (meth)acrylate, phenyl (meth)acrylate, 2,4,5-tetramethylphenyl (meth)acrylate, 4-chlorophenyl (meth)acrylate, phenoxymethyl (meth)acrylate, phenoxyethyl (meth)acrylate, glycidyl (meth)acrylate, glycidyloxybutyl (meth)acrylate, glycidyloxyethyl (meth)acrylate, glycidyloxypropyl (meth)acrylate, tetrahydrofurfuryl (meth)acrylate, hydroxyalkyl (moth)acrylate, 2-hydroxyethyl (meth)acrylate, 3-hydroxypropyl (meth)acrylate, 2-hydroxypropyl (meth)acrylate, 2-hydroxybutyl (meth)acrylate, 4-hydroxybutyl (meth)acrylate, dimethylaminoethyl (meth)acrylate, diethylaminoethyl (meth)acrylate, dimethylaminopropyl (meth)acrylate, diethylaminopropyl (meth)acrylate, trimethoxysilylpropyl (meth)acrylate, trimethylsilylpropyl (meth)acrylate, polyethylene oxide monomethyl ether (meth)acrylate, oligoethylene oxide monomethyl ether (meth)acrylate, polyethylene oxide (meth)acrylate, oligoethylene oxide (meth)acrylate, oligoethylene oxide monoalkyl ether (meth)acrylate, polyethylene oxide monoalkyl ether (meth)acrylate, dipropylene glycol (meth)acrylate, polypropylene oxide monoalkyl ether (meth)acrylate, oligopropylene oxide monoalkyl ether (meth)acrylate, 2-methacryloyloxyethylsuccinic acid, 2-methacryloyloxyhexahydrophthalic acid, 2-methacryloyloxyethyl-2-hydroxypropylphthalate, butoxydiethylene glycol (meth)acrylate, trifluoroethyl (meth)acrylate, perfluorooctylethyl (meth)acrylate, 2-hydroxy-3-phenoxypropyl (meth)acrylate, EO-modified phenol (meth)acrylate, EO-modified cresol (meth)acrylate, EO-modified nonylphenyl (meth)acrylate, PO-modified nonylphenyl (meth)acrylate and EO-modified 2-ethylhexyl (meth)acrylate.

Specific examples of difunctional (meth)acrylate, include 1,6-hexanediol di(meth)acrylate, 1,10-decanediol di(meth)acrylate, neopentyl glycol di(meth)acrylate, 2,4-dimethyl-1,5-pentanediol di(meth)acrylate, butylethylpropanediol di(meth)acrylate, ethoxylated cyclohexanemethanol di(meth)acrylate, polyethylene glycol di(meth)acrylate, oligoethylene glycol di(meth)acrylate, ethylene glycol di(meth)acrylate, 2-ethyl-2-butylbutanediol di(meth)acrylate, hydroxypivalic acid neopentyl glycol di(meth)acrylate, EO-modified bisphenol A di(meth)acrylate, bisphenol F polyethoxy di(meth)acrylate, polypropylene glycol di(meth)acrylate, oligopropylene glycol di(meth)acrylate, 1,4-butanediol di(meth)acrylate, 2-ethyl-2-butylpropanediol di(meth)acrylate, 1,9-nonane di(meth)acrylate, propoxylated ethoxylated bisphenol A di(meth)acrylate and tricyclodecane di(meth)acrylate.

Specific examples of trifunctional (meth)acrylates include trimethylolpropane tri(meth)acrylate, trimethylolethane tri(meth)acrylate, the alkylene oxide-modified-tri(meth)acrylate of trimethylolpropane, pentaerythritol tri(meth)acrylate, dipentaerythritol tri(meth)acrylate, trimethylolpropane tris((meth)acryloyloxypropyl)ether, isocyanuric acid alkylene oxide-modified tri(meth)acrylate, propionic acid dipentaerythritol tri(meth)acrylate, tris((meth)acryloyloxyethyl)isocyanurate, hydroxypivalaldehyde-modified dimethylolpropane tri(meth)acrylate, sorbitol tri(meth)acrylate, propoxylated trimethylolpropane tri(meth)acrylate and ethoxylated glycerol triacrylate.

Specific examples of tetrafunctional (meth)acrylates include pentaerythritol tetra(meth)acrylate, sorbitol tetra(meth)acrylate, ditrimethylolpropane tetra(meth)acrylate, propionic acid dipentaerythritol tetra(meth)acrylate and ethoxylated pentaerythritol tetra(meth)acrylate.

Specific examples of pentafunctional (meth)acrylates include sorbitol penta(meth)acrylate and dipentaerythritol penta(meth)acrylate.

Specific examples of hexafunctional (meth)acrylates include dipentaerythritol hexa (meth)acrylate, sorbitol hexa(meth)acrylate, the alkylene oxide-modified hexa(meth)acrylate of phosphazene, and captolactone-modified dipentaerythritol hexa(meth)acrylate.

Examples of (meth)acrylamides include (meth)acrylamide, N-methyl (meth)acrylamide, N-ethyl (meth)acrylamide, N-propyl (meth)acrylamide, N-n-butyl (meth)acrylamide, N-t-butyl (meth)acrylamide, N-butoxymethyl (meth)acrylamide, N-isopropyl (meth)acrylamide, N-methylol (meth)acrylamide, N,N-dimethyl (meth)acrylamide, N,N-diethyl (meth)acrylamide and (meth)acryloylmorpholine.

Examples of aromatic vinyls include styrene, methylstyrene, dimethylstyrene, trimethylstyrene, ethylstyrene, isopropylstyrene, chloromethylstyrene, methoxystyrene, acetoxystyrene, chlorostyrene, dichlorostyrene, bromostyrene, methyl vinylbenzoate, 3-methylstyrene, 4-methylstyrene, 3-ethylstyrene, 4-ethylstyrene, 3-propylstyrene, 4-propylstyrene, 3-butylstyrene, 4-butylstyrene, 3-hexylstyrene, 4-hexylstyrene, 3-octylstyrene, 4-octylstyrene, 3-(2-ethylhexyl)styrene, 4-(2 ethylhexyl)styrene, allylstyrene, isopropenylstyrene, butenylstyrene, octenylstyrene, 4-t-butoxycarbonylstyrene, 4-methoxystyrene and 4-t-butoxystyrene.

Vinyl ethers are exemplified by monovinyl ethers such as methyl vinyl ether, ethyl vinyl ether, propyl vinyl ether, n butyl vinyl ether, t-butyl vinyl ether, 2-ethylhexyl vinyl ether, n-nonyl vinyl ether, lauryl vinyl ether, cyclohexyl vinyl ether, cyclohexyl methyl vinyl ether, 4-methylcyclohexyl methyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexyl methyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether and phenoxypolyethylene glycol vinyl ether.

Examples of polyvinyl ethers include divinyl ethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ether and bisphenol F alkylene oxide divinyl ether; and other polyvinyl ethers such as trimethylolethane trivinyl ether, trimethylolpropane trivinyl ether, ditrimethylolpropane tetravinyl ether, glycerol trivinyl ether, pentaerythritol tetravinyl ether, dipentaerythritol pentavinyl ether, dipentaerythritol hexavinyl ether, ethylene oxide adducts of trimethylolpropane trivinyl ether, propylene oxide adducts of trimethylolpropane trivinyl ether, ethylene oxide adducts of ditrimethylolpropane tetravinyl ether, propylene oxide adducts of ditrimethylolpropane tetravinyl ether, ethylene oxide adducts of pentaerythritol tetravinyl ether, propylene oxide adducts of pentaerythritol tetravinyl ether, ethylene oxide adducts of dipentaerythritol hexavinyl ether and propylene oxide adducts of dipentaerythritol hexavinyl ether.

From the standpoint of such considerations as curability, adhesion to the recording medium and surface hardness of the formed image, it is preferable to use as the vinyl ether compound a di- or trivinyl ether compound. The use of a divinyl ether compound is especially preferred.

In addition to the above, other examples of radical-polymerizable monomers include vinyl esters (e.g. vinyl acetate, vinyl propionate, vinyl versatate), allyl esters (e.g., allyl acetate), halogen-bearing monomers (e.g., vinylidene chloride, vinyl chloride), vinyl cyanides (e.g., (meth)acrylonitrile), and olefins (e.g., ethylene, propylene).

Of the above, from the standpoint of the cure rate, it is preferable to use (meth)acrylates and (meth)acrylamides as the radical-polymerizable monomer. The use of (meth)acrylates having a functionality of 4 or more is especially preferred for achieving a good cure rate. In addition, from the standpoint of the viscosity of the ink composition, the use of a polyfunctional (meth)acrylate in combination with a monofunctional or bifunctional (meth)acrylate or (meth)acrylamide is preferred.

The content of the polymerizable or crosslinkable material in the ink and the undercoat liquid is preferably in a range of 50 to 99.6 wt %, more preferably in a range of 70 to 99.0 wt %, and even more preferably in a range of 80 to 99.0 wt %, based on the weight of the total solids in each droplet.

The content in a droplet, based on the total weight of each droplet, is preferably in a range of 20 to 98 wt %, more preferably in a range of 40 to 95 wt %, and most preferably in a range of 50 to 90 wt %.

### (Polymerization Initiator)

It is preferable for at least the undercoat liquid, or for both the ink and the undercoat liquid, to include at least one polymerization initiator. This initiator is a Compound which generates initiating species such as radicals when the energy of active rays, heat or both is applied thereto, thereby initiating and promoting a polymerization or crosslinking reaction of the above-described polymerizable or crosslinkable material so as to effect curing.

The polymerizable material preferably includes a polymerization initiator which triggers radical polymerization. A photopolymerization initiator is especially preferred.

Photopolymerization initiators are compounds which incur a chemical change due to the action of light or to interactions with the electronically excited state of a sensitizing dyer and generates at least one of the following; a radical, an acid or a base. Of such compounds, a photoradical generator is preferred for initiating polymerization by the simple means of exposure to light.

The photopolymerization initiator used in the invention may be suitably selected from among those having sensitivity to the active rays used for exposure, such as 400 nm to 200 nm ultraviolet light, far-ultraviolet light, g-line radiation, h-line radiation, i-line radiation, KrF excimer laser light, ArF excimer laser light, electron beams, x-rays, molecular beams and ion beams.

Any photopolymerization initiator known to those skilled in the art may be used without limitation. Numerous examples are mentioned in, for example, B. M. Monroe et al.: Chemical Revue 93, 435 (1993); R. S. Davidson: Journal of Photochemistry and Biology A: Chemistry 73, 81 (1993); J. P. Faussier: “Photoinitiated Polymerization-Theory and Applications,” in Rapra Review Reports, Vol. 9, Rapra Technology, Ltd. (1998); and M. Tsunooka et al.: Prog. Polym. Sci. 21, 1 (1996). In addition, use may also be made of the group of compounds mentioned in, for example, F. D. Saeva: Topics in Current Chemistry 156, 59 (190); G. G. Maslak: Topics in Current Chemistry 168, 1 (1993); H. B. Shuster et al.: JACS 112, 6329 (1990), and I. D. F. Eaton et al.: JACS 102, 3298 (1980), which undergo oxidative or reductive bond cleavage through interactions with the electronically excited state of the sensitizing dye.

Preferred photopolymerization initiators include (a) aromatic ketones, (b) aromatic onium salt compounds, (c) organic peroxides, (d) hexaarylbiimidazole compounds, (e) ketoxime ester compounds, (f) borate compounds, (g) azinium compounds, (h) metallocene compounds, (i) active ester compounds, and (j) compounds having carbon-halogen bonds.

Preferred examples of aromatic ketones (a) include the compounds having a benzophenone skeleton or a thioxanthone skeleton mentioned on Pages 77 to 117 of Radiation Curing in Polymer Science and Technology by J. P. Fouassier and J. F. Rabek (1993). More preferred examples of aromatic ketones (a) include the α-thiobenzophonone compounds mentioned in JP 47-6416 B, the benzoin ether compounds mentioned in JP 47-3981 B, the α-substituted benzoin compounds mentioned in JP 47-22326 B, the benzoin derivatives mentioned in JP 47-23664 B, the aroylphosphonic acid esters mentioned in JP 57-30704 A, the dialkoxybenzophenones mentioned in JP 60-26483 B, the benzoin ethers mentioned in JP 60-26403 B and 62-81345 A, the α-aminobenzophenones mentioned in JP 1-34242 B, U.S. Pat. No. 4,318,791 and EP 0284561 A, the p-di(dimethylaminobenzoyl) benzenes mentioned in JP 2-211452 A, the thio-substituted aromatic ketones mentioned in JP 61-194062 A, the acylphosphine sulfides mentioned in JP 2-9597 B, the acylphosphines mentioned in JP 2-9596 B, the thioxanthones mentioned in JP 63-61950 B, and the coumarins mentioned in JP 59-42864 B.

Exemplary aromatic onium salt compounds (b) include aromatic onium salts of periodic table group V, VI, and VII elements such as nitrogen, phosphorus, arsenic, antimony, bismuth, oxygen, sulfur, selenium, tellurium and iodine. Preferred examples include iodonium salts mentioned in EP 104143 B, U.S. Pat. No. 4,837,124, JP 2-150848 A and JP 2-96514 A; sulfonium salts mentioned in EP 370693B, EP 233567 Br EP 297443 B, EP 297442 B, SE 279210 B, EP 422570 B, U.S. Pat. No. 3,902,144, U.S. Pat. No. 4,933,377, U.S. Pat. No. 4,760,013, U.S. Pat. No. 4,734,444 and U.S. Pat. No. 2,833,827; diazonium salts (e.g., benzenediazonium salts which may be substituted), diazonium salt resins (e.g., formaldehyde resins of diazodiphenylamine), N-alkoxypyridinium salts (such as those mentioned in U.S. Pat. No. 4,743,528, JP 63-138345 A, JP 63-142345 A, JP 63-142346 A and JP 46-42363 B, a specific example being 1-methoxy-4-phenylpyridinium tetrafluoroborate), and the compounds mentioned in JP 52-147277 B, JP 52-14278 B and JP 52-14279 B. A radical or an acid is generated as the active species.

Exemplary organic peroxides (c) include substantially all organic compounds having one or more oxygen-oxygen bond in the molecule. For example, it is preferable to use a peroxidized ester such as 3,3′,4,4′-tetrakis(t-butylperoxycarbonyl)benzophenone, 3,3′,4,4′-tetrakis(t-amylperoxycarbonyl)benzophenone, 3,3′,4,4′-tetrakis(t-hexylperoxycarbonyl)benzophenone, 3,3′,4,4′-tetrakis(t-octylperoxycarbonyl)benzophenone, 3,3′,4,4′-tetrakis(cumylperoxycarbonyl)benzophenone, 3,3′,4,4′-tetrakis (p-isopropylcumylperoxycarbonyl)benzophenone and di-t-butyldiperoxyisophthalate.

Exemplary hexaarylbiimidazoles (d) include the lophine dimers mentioned in JP 45-37377B and JP 44-86516 B, such as 2,2′-bis(o-chlorophenyl)-4,4′,5,5′-tetraphenylbiimidazole, 2,2′-bis(c-bromophenyl)-4,4′,5,5′-tetraphenylbiimidazole, 2,2′-bis(o,p-dichlorophenyl)-4,4′,5,5′-tetraphenylbiimidazole, 2,2′-bis(o-chlorophenyl)-4,4′,5,5′-tetrakis (m-methoxyphenyl)biimidazole, 2,2′-bis(o,o′-dichlorophenyl)-4,4′,5,5′-tetraphenylbiimidazole, 2,2′-bis(o-nitrophenyl)-4,4′,5,5′-tetraphenylbiimidazole, 2,2′-bis o-methylphenyl)-4,4′,5,5′-tetraphenylbiimidazole and 2,2′-bis(o-trifluorophenyl)-4,4′,5,5′-tetraphenylbiimidazole.

Exemplary ketoxime esters (e) include 3-benzoyloxyliminobutan-2-one, 3-acetoxyiminobutan-2-one, 3-propionyloxyiminobutan-2-one, 2-acetoxyiminopentan-3-one, 2-acetoxyimino-1-phenylpropan-1-one, 2-benzoyloxyimino-1-phenylpropan-1-one, 3-p-toluenesulfonyloxyiminobutan-2-one and 2-ethoxyoarbonyloxyimino-1-phenylpropane-1-one.

Exemplary borate compounds (f) include the compounds mentioned in U.S. Pat. No. 3,567,453, U.S. Pat. No. 4,343,991, EP 103,772 B and EP 109,773 B.

Exemplary azinium salt compounds (g) include the group of compounds having N—O bonds mentioned in JP 63-138345 A, JP 63-142345 A, JP 63-142346 A, JP 63-143537 A and JP 46-42363 B.

Exemplary metallocene compounds (h) include the titanocene compounds mentioned in JP 59-152396 A, JP 61-151197 A, JP 63-41484 A, JP 2-249 A, JP 2-4705 A, and the iron-arene complexes mentioned in JP 1-304453 A and JP 1-152109 A.

Specific examples of titanocene compounds include dicyclopentadienyl titanium dichloride, dicyclopentadienyl titanium bisphenyl, dicyclopentadienyl titanium bis-2,3,4,5,6-pentafluorophen-1-yl, dicyclopentadienyl titanium bis-2,3,5,6-tetrafluorophen-1-yl, dicyclopentadienyl titanium bis-2,4,6-trifluorophen-1-yl, dicyclopentadienyl titanium 2,6-difluorophen-1-yl, dicyclopentadienyl titanium bis-2,4-difluorophen-1-yl, dimethylcyclopentadienyl titanium bis-2,3,4,5,6-pentafluorophen-1-yl, dimethylcyclopentadienyl titanium bis-2,3,5,6-tetrafluorophen-1-yl, dimethyloyclopentadienyl titanium bis-2,4-difluorophen-1-yl, bis(cyclopentadienyl)-bis(2,6-difluoro-3-(pyr-1-yl)phenyl)titanium, bis(cyclopentadienyl)bis[2,6-difluoro-3-(methylsulfonamide) phenyl] titanium, bis(cyclopentadienyl)bis[2,6-difluoro-3-(N-butylbiaroylamino) phenyl] titanium.

Exemplary active ester compounds (i) include the nitrobenzyl ester compounds mentioned in EP 0290750 B, EP 046083 B, EP 156153 B, EP 271851 B, EP 0386313 B, U.S. Pat. No. 3,901,710, U.S. Pat. No. 4,181,531, JP 60-198538 A and JP 53-133022 A; the iminosulfonate compounds mentioned in EP 0199672 B, EP 84514 B, EP 199672 B, EP 044115 B, EP 0101122 B, U.S. Pat. No. 4,618,564, U.S. Pat. No. 4,371,605, U.S. Pat. No. 4,431,774, JP 64-18143 A, JP 2-245756 A, and JP 4-365048 A; and the compounds mentioned in JP 62-6223 B, JP 63-14340 B and JP 59-174831 A.

Preferred examples of compounds having carbon-halogen bonds (j) include the compounds mentioned by Wakabayashi et al. in Bull. Chem. Soc. Japan 42, 2924 (1969), the compounds mentioned in GB 1388492 B, the compounds mentioned in JP 55-133428 A, and the compounds mentioned in DE 3337024 B.

Additional examples include the compounds mentioned by F. C. Schaefer et al. in J. Org. Chem. 29, 1527 (1964), the compounds mentioned in JP 62-58241 A, the compounds mentioned in JP 5-281726 A, compounds such as those mentioned in DE 2641100 B, the compounds mentioned in DE 3333450 B, the groups of compounds mentioned in DE 3021590 B and the groups of compounds mentioned in DE 3021599 B.

Illustrative, non-limiting examples of the photopolymerization initiator used in the invention include the following compounds.

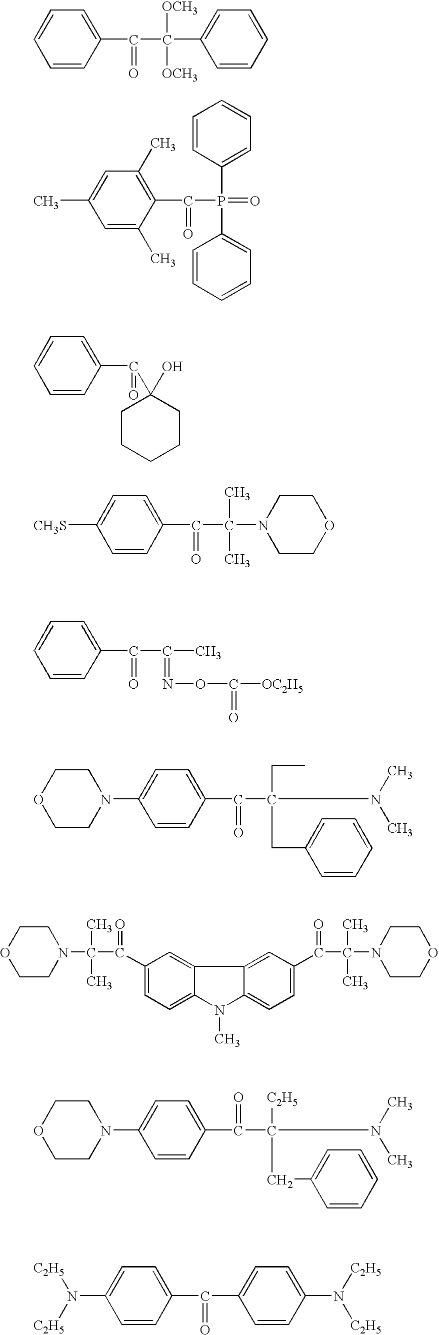

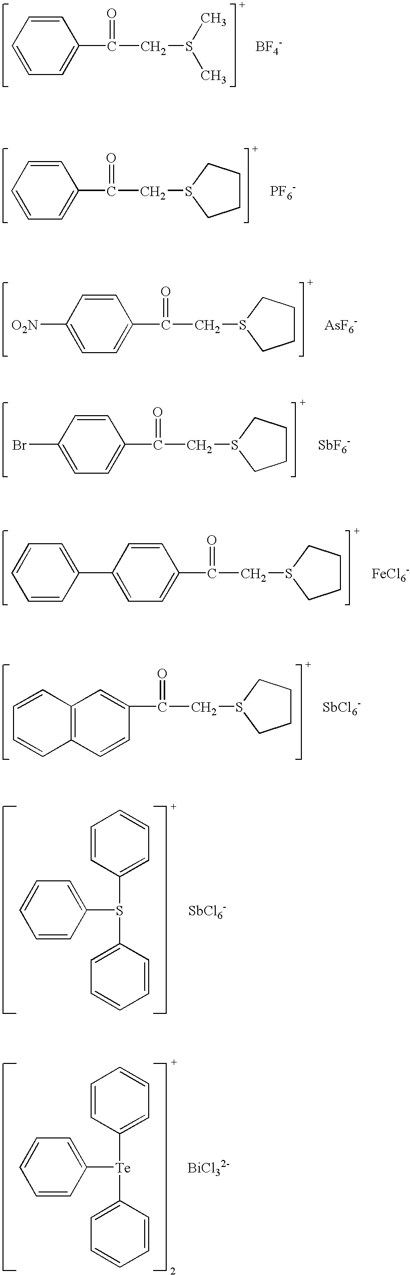

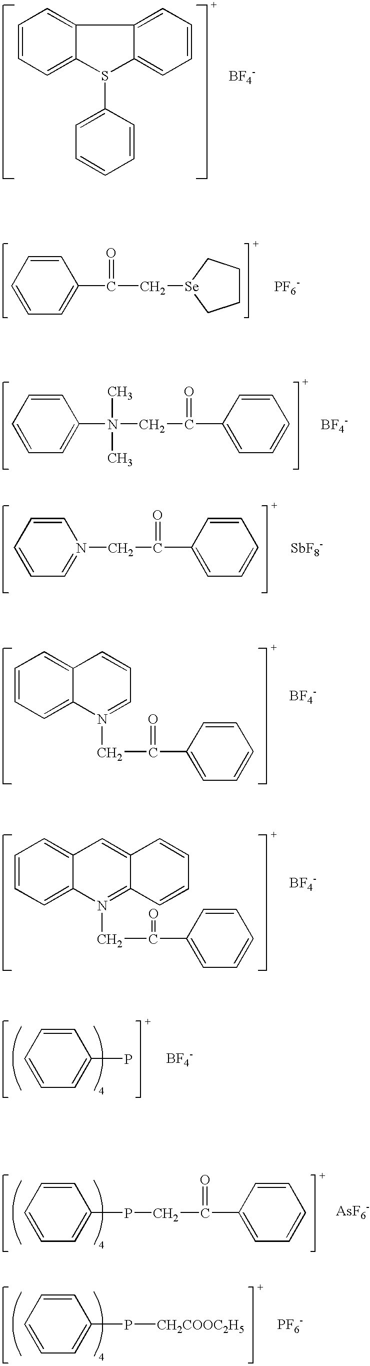

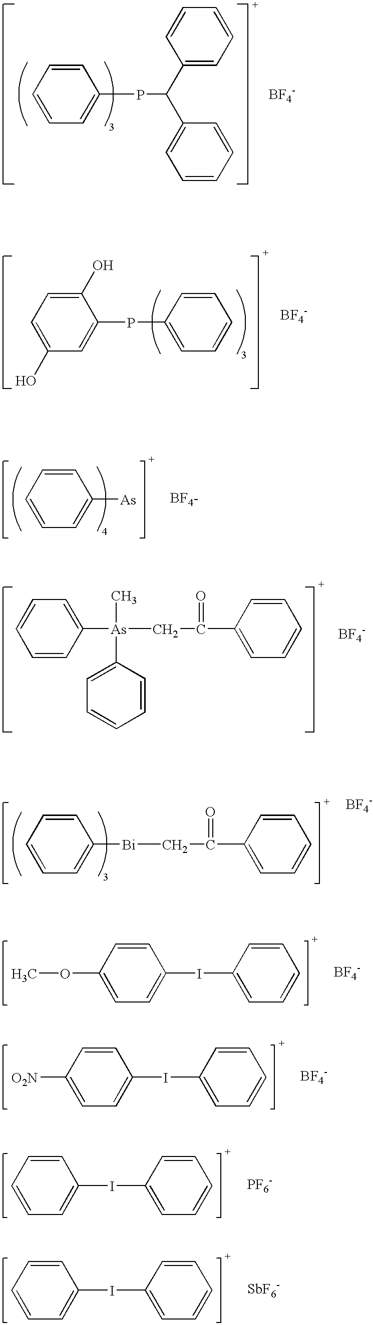

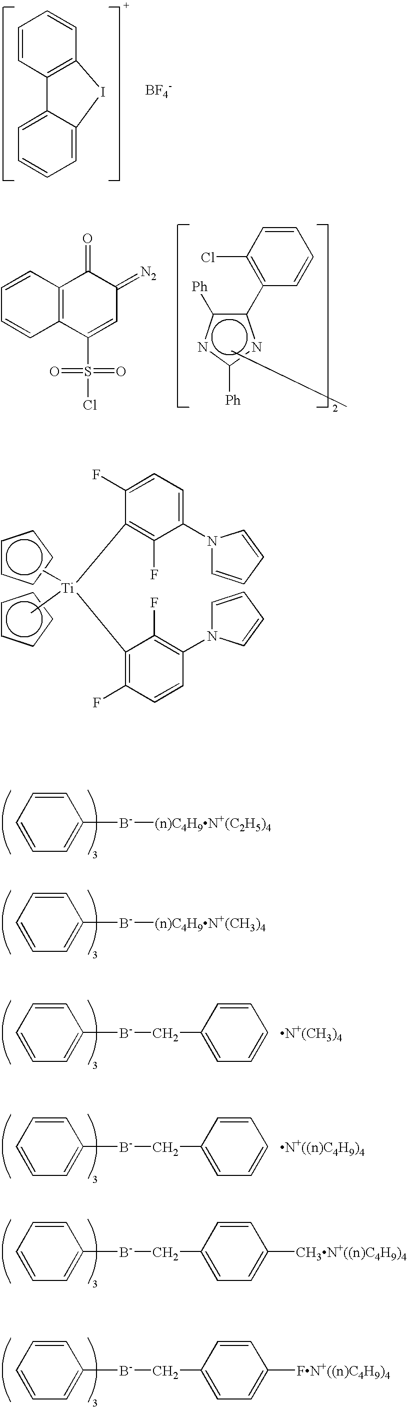

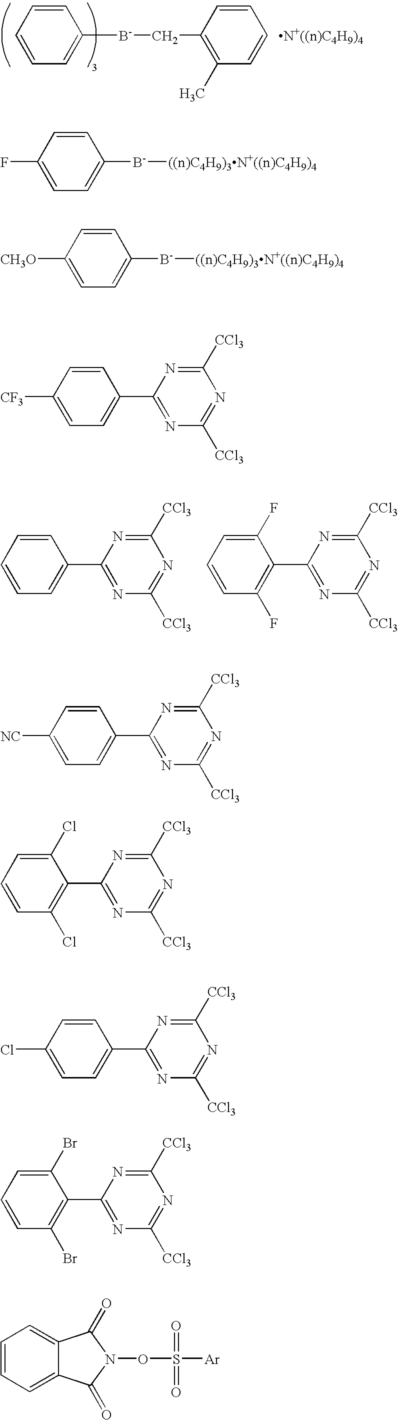

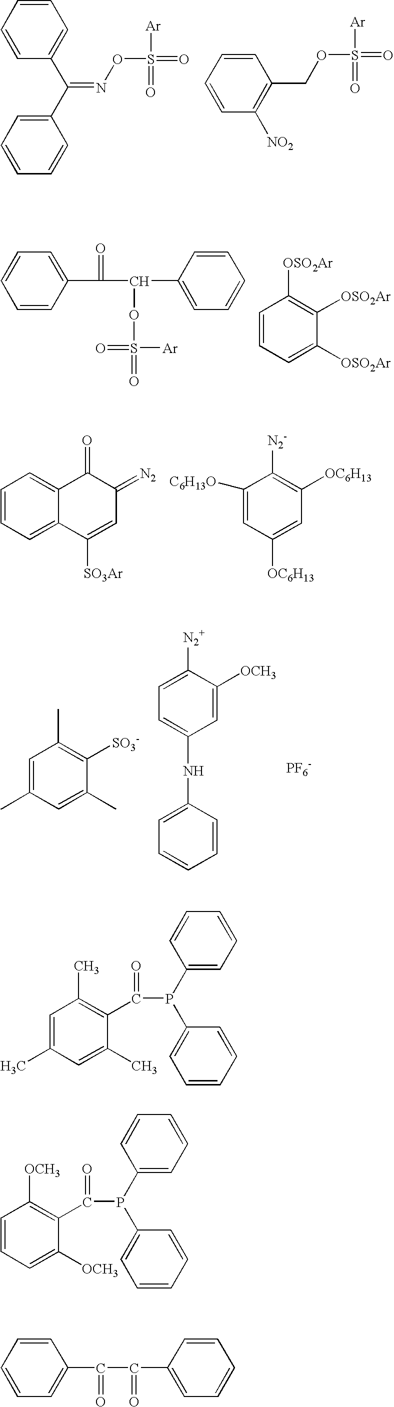

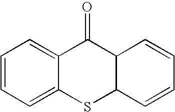

It is desirable for the polymerization initiator to have an excellent sensitivity, although from the standpoint of storage stability, the use of an initiator which does not trigger thermal decomposition at temperatures up to 80° C. is preferred.

The polymerization initiator may be used singly or as a combination of two or more thereof. To enhance the sensitivity, a known sensitizer may be used together with the initiator, insofar as the objects of the invention are attainable.

For a good stability over time, curability and cure rate, the content of the initiator in the undercoat liquid is preferably within a range of 0.5 to 20 wt %, more preferably 1 to 15 wt %, and most preferably 3 to 10 wt, based on the polymerizable material in the undercoat liquid. By setting the content within the above range, problems such as deposition and separation over time, and deterioration in properties, including the strength and scuff resistance of the ink after curing, can be suppressed.

In addition to being included in the Undercoat liquid, the polymerization initiator may also be included in the ink. If such an initiator is included in the ink, the initiator may be suitably selected and included within a range that enables the storage stability of the ink to be maintained at a desired level. In such a case, it is advantageous for the initiator content, based on the polymerizable or crosslinkable compound in the ink, to be set in a range of preferably 0.5 to 20 wt %, and more preferably 1 to 15 wt %.

### (Sensitizing Dye)

It is desirable to add a sensitizing dye to the ink and/or undercoat liquid in order to enhance the sensitivity of the photopolymerization initiator. Preferred sensitizing dyes are exemplified by those compounds among the following which have an absorption wavelength in the range of 350 nm to 450 nm: polycyclic aromatic compounds (e.g., pyrene, perylene, triphenylene), xanthenes (e.g., fluorescein, eosin, erythrosine, rhodamine B, rose bengal), cyanines (erg., thiacarbocyanine, oxacarbocyanine), merocyanines (e.g., merocyanine, carbomerocyanine), thiazines (e.g., thionine, methylene blue, toluidine blue), acridines (e.g., acridine orange, chloroflavine, actiflavine), anthraquinones (e.g., anthraquinone), squaliums (e.g., squalium) and coumarins (e.g., 7-diethylamino-4-methylcoumarin).

More preferred examples of sensitizing dyes include compounds having the general formulas IX to XIII below.

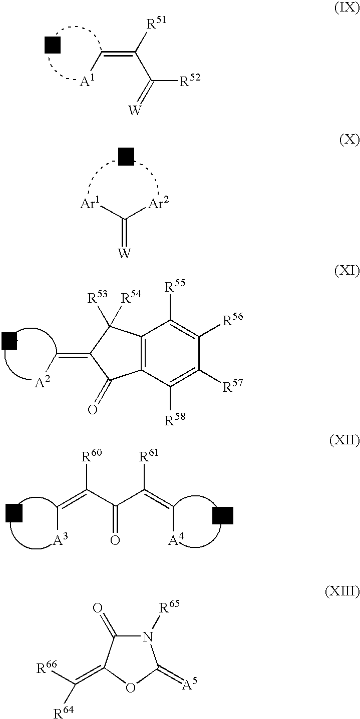

In formula IX, A¹ represents a sulfur atom or —NR⁵⁰—, and R⁵⁰ is an alkyl or aryl group; L² is a non-metallic atomic group which forms, together with the neighboring A¹ and the neighboring carbon atom, the basic nucleus of the dye. R⁵¹ and R⁵² are each independently a hydrogen atom or a monovalent non-metallic atomic group, and may bond together to form the acidic nucleus of the dye. W is an oxygen atom or a sulfur atom.

In formula X, Ar¹ and Ar² are each independently an aryl group, and are linked through -L³-. Here, -L³- represents —O— or —S—. W is the same as in general formula IX.

In formula XI, A² represents a sulfur atom or —NR⁵⁹—, and L⁴ is a non-metallic atomic group which forms, together with the neighboring A² and carbon atom, the basic nucleus of the dye. R⁵³, R⁵⁴, R⁵⁵, R⁵⁶, R⁵⁷ and R⁵⁸ are each independently a monovalent non-metallic atomic group, and R⁵⁹ is an alkyl or aryl group.

In formula XII, A³ and A⁴ each independently represent —S—, —NR⁶²— or —NR⁶³—; R⁶² and R⁶³ are each independently a substituted or unsubstituted alkyl group or a substituted or un-substituted aryl group; L⁵ and L⁶ are each independently a non-metallic atomic group which forms, together with the neighboring A³ and A⁴ and the neighboring carbon atom, the basic nucleus of the dye, and R⁶⁰ and R⁶¹ are each independently a hydrogen atom or a monovalent non-metallic atomic group, or may bond together to form an aliphatic or aromatic ring.

In formula XIII, R⁶⁶ is an aromatic ring or hetero ring which may be substituted; and A⁵ is an oxygen atom, a sulfur atom or —NR⁶⁷—. R⁶⁴, R⁶⁵ and R⁶⁷ are each independently a hydrogen atom or a monovalent nonmetallic atomic group, and R⁶⁷ may bond with R⁶⁴ and R⁶⁵ may bond with R⁶⁷ to form, respectively, an aliphatic or aromatic ring.

Preferred examples of compounds having general formulas IX to XIII include compounds A-1 to A-20 shown below.

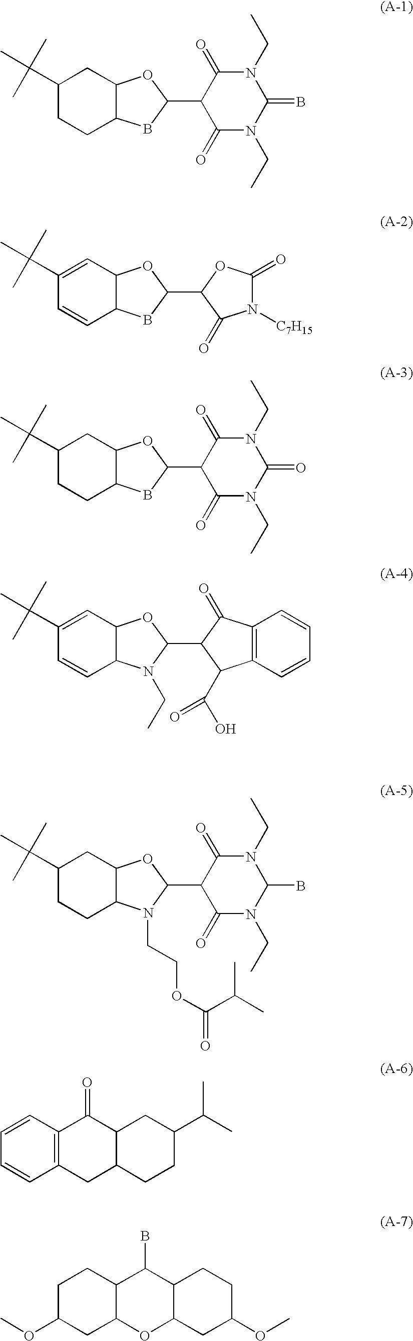

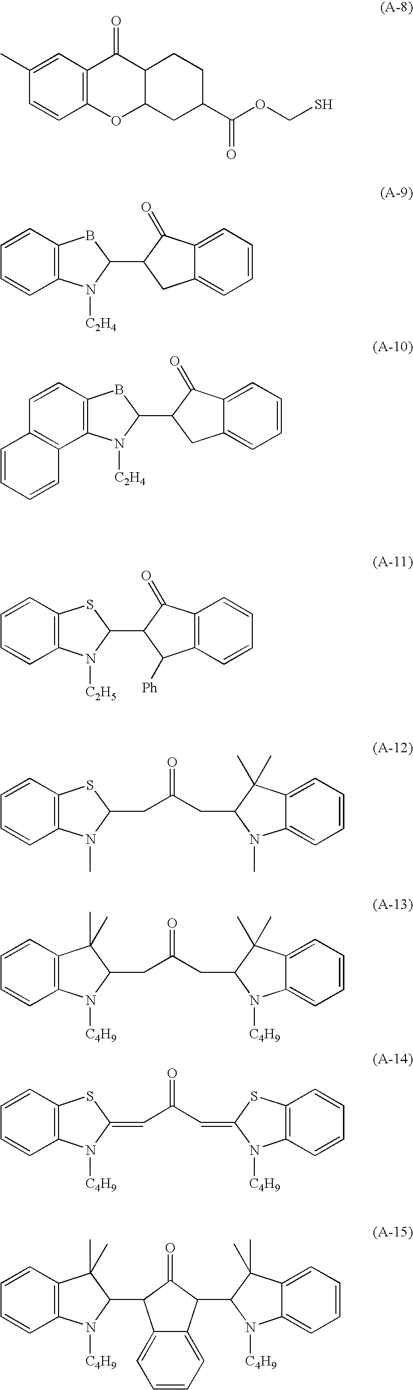

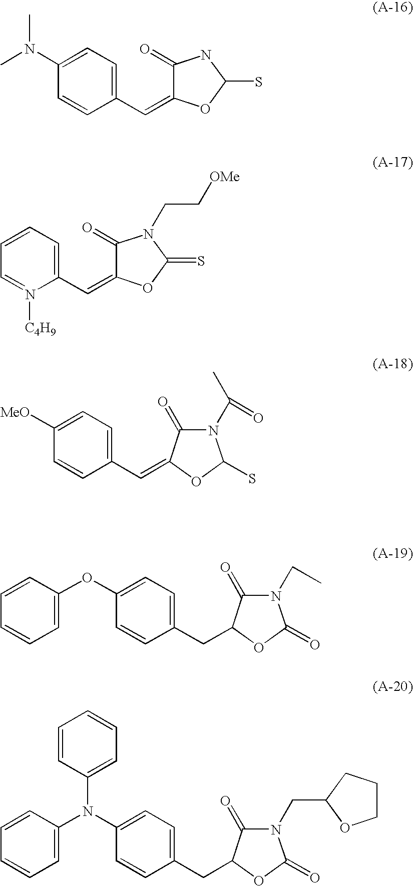

### (Co-Sensitizer)

It is also desirable to add to the ink and/or undercoat liquid, as a co-sensitizer, a known compound which acts to, for example, further enhance the sensitivity or suppress the inhibition of polymerization by oxygen.

Exemplary co-sensitizers include compounds mentioned in, for example, M. R. Sander et al.: Journal of Polymer Society 10, 3173 (1972); JP 44-20189 B, JP 51-32102 A, JP 52-134692 A, JP 59-138205 A, JP 60-84305 A, JP 62-18537 A, JP 64-33104 A, and Research Disclosure 33825. Specific examples include triethanolamine, ethyl p-dimethylaminobenzoate, p-formyldimethylaniline and p-methylthiodimethylaniline.

Other exemplary co-sensitizers include the thiol compounds mentioned in JP 53-702 A, JP 55-500806 B and JP 5-142772 A, and the disulfide compounds mentioned in JP 56-75643 A. Specific examples of these include 2-mercaptobenzothiazole, 2-mercaptobenzoxazole, 2-mercaptobenzimidazole, 2-mercapto-4-(3H)-quinazoline and β-mercaptonaphthalene.

Still further examples include amino acid compounds (e.g., N-phenylglycine), the organometallic compounds mentioned in JP 48-42965 B (e.g., tributyltin acetate), hydrogen donors mentioned in JP 55-34414 B, the sulfur compounds mentioned in JP 6-309727 A (e.g., trithiane), the phosphorus compounds mentioned in JP 6-250387 A (e.g., diethylphosphite) and the Si—H and Ge—H compounds mentioned in JP 8-65779 A.

### (Colorants)

At least the ink, or both the ink and the undercoat liquid, include at least one colorant. Colorants may be included not only in the ink, but also in the undercoat liquid and in other liquids.

The colorants used are not subject to any particular limitation, and may be suitably selected from among, for example, known water-soluble dyes, oil-soluble dyes and pigments. Of these, in cases where the ink and the undercoat liquid are composed of water-insoluble organic solvent systems capable of suitably achieving the objects of the invention, it is preferable for the colorant to be an oil-soluble dye or a pigment which can be easily dispersed or dissolved uniformly in the water-insoluble medium.

The colorant content of the ink is preferably from 1 to 30 wt %, more preferably from 1.5 to 25 wt %, and most preferably from 2 to 15 wt %. When a white pigment is included as a colorant in the undercoat liquid, the colorant content in the undercoat liquid is preferably from 2 to 45 wt %, and more preferably from 4 to 35 wt %.

Pigments suitable for use in the invention are described below.

### Pigments:

The use of a pigment as the colorant is preferred.

The pigment used may be either an organic pigment or an inorganic pigment. Preferred black pigments include carbon black pigments. Black pigments and pigments in the three primary colors of cyan, magenta and yellow are generally used. Pigments having other hues, such as red, green, blue, brown and white; metal luster pigments such as those of gold and silver colors; and colorless or light-colored extender pigments may also be used according to the intended purpose.

Organic pigments are not limited as to their hue. Exemplary organic pigments include perylene, perinone, quinacridone, quinacridonequinone, anthraquinone, anthanthrone, benzimidazolone, disazo condensation, disazo, azo, indanthrone, phthalocyanine, triarylcarbonium, dioxazine, aminoanthraquinone, diketopyrrolopyrrole, thioindigo, isoindoline, isoindolinone, pyranthrone, isoviolanthrone pigments and mixtures thereof.

Specific examples include perylene pigments such as C.I. Pigment Red 190 (C.I. No. 71140), C.I. Pigment Red 224 (C.I. No. 71127) and C.I. Pigment Violet 29 (C.I. No. 71129); perinone pigments such as C.I. Pigment Orange 43 (C.I. No. 71105) and C.I. Pigment Red 194 (C.I. No. 71100), quinacridone pigments such as C.I. Pigment Violet 19 (C.I. No. 73900), C.I. Pigment Violet 42, C.I. Pigment Red 122 (C.I. No. 73915), C.I. Pigment Red 192, C.I. Pigment Red 202 (C.I. No. 73907), C.I. Pigment Red 207 (C.I. No. 73900, 73906) and C.I. Pigment Red 209 (C.I. No. 73905); quinacridonequinone pigments such as C.I. Pigment Red 206 (C.I. No. 73900/73920), C.I. Pigment Orange 48 (C.I. No. 73900/73920) and C.I. Pigment Orange 49 (C.I. No. 73900/73920); anthraquinone pigments such as C.I. Pigment Yellow 147 (C.I. No. 60645); anthanthrone pigments such as C.I. Pigment Red 168 (C.I. No. 59300); benzimidazolone pigments such as C.I. Pigment Brown 25 (C.I. No. 12510), C.I. Pigment Violet 32 (C.I. No. 12517), C.I. Pigment Yellow 180 (C.I. No. 21290), C.I. Pigment Yellow 181 (C.I. No. 11777), C.I. Pigment Orange 62 (C.I. No. 11775) and C.I. Pigment Red 105 (C.I. No. 12516); disazo condensation pigments such as C.I. Pigment Yellow 93 (C.I. No. 20710), C.I. Pigment Yellow 94 (C.I. No. 20038), C.I. Pigment Yellow 95 (C.I. No. 20034), C.I. Pigment Yellow 128 (C.I. No. 20037), C.I. Pigment Yellow 166 (C.I. No. 20035), C.I. Pigment Orange 34 (C.I. No. 21115), C.I. Pigment Orange 13 (C.I. No. 21110), C.I. Pigment Orange 31 (C.I. No. 20050), C.I. Pigment Red 144 (C.I. No. 20735), C.I. Pigment Red 166 (C.I. No. 20730), C.I. Pigment Red 220 (C.I. No. 20055), C.I. Pigment Red 221 (C.I. No. 20065), C.I. Pigment Red 242 (C.I. No. 20067), C.I. Pigment Red 248, C.I. Pigment Red 262 and C.I. Pigment Brown 23 (C.I. No. 20060); disazo pigments such as C.I. Pigment Yellow 13 (C.I. No. 21100), 0.1. Pigment Yellow 83 (C.I. No. 21108) and C.I. Pigment Yellow 188 (C.I. Nor. 21094); azo pigments such as C.I. Pigment fed 187 (C.I. No. 12486), C.I. Pigment Red 170 (C.I. No. 12475), C.I. Pigment Yellow 74 (C.I. No. 11714), 0.1. Pigment Yellow 150 (C.I. No. 48545), C.I. Pigment Red 48 (C.I. No. 15865), C.I. Pigment Red 53 (C.I. No. 15585), C.I. Pigment Orange 64 (C.I. No. 12760) and C.I. Pigment Red 247 (C.I. No. 15915); indanthrone pigments such as C.I. Pigment Blue 60 (C.I. No. 69800); phthalocyanine pigments such as CIT. Pigment Green 7 (C.I. No. 74260), C.I. Pigment Green 36 (C.I. No. 74265), C.I. Pigment Green 37 (C.I. No. 74255), C.I. Pigment Blue 16 (C.I. No. 74100), C.I. Pigment Blue 75 (C.I. No. 74160:2) and 15 (C.I. No. 74160); triarylcarbonium pigments such as C.I. Pigment Blue 56 (C.I. No. 42800) and C.I. Pigment Blue 61 (C.I. No. 42765:1), dioxazine pigments such as C.I. Pigment Violet 23 (C.I. No. 51319) and C.I. Pigment Violet 37 (C.I. No. 51345); aminoanthraquinone pigments such as C.I. Pigment Red 177 (C.I. No. 65300); diketopyrrolopyrrole pigments such as C.I. Pigment Red 254 (C.I. No. 56110), C.I. Pigment Red 255 (C.I. No. 561050), C.I. Pigment Red 264, C.I. Pigment Red 272 (C.I. No. 561150), C.I. Pigment Orange 71 and C.I. Pigment Orange 73; thioindigo pigments such as C.I. Pigment Red 88 (C.I. No. 73312); isoindoline pigments such as C.I. Pigment Yellow 139 (C.I. No. 56298) and C.I. Pigment Orange 66 (C.I. No. 48210); isoindolinone pigments such as C.I. Pigment Yellow 109 (C.I. No. 56294) and C.I. Pigment Orange 61 (C.I. No. 11295); pyranthrone pigments such as C.I. Pigment Orange 40 (C.I. No. 59700) and C.I. Pigment Red 216 (C.I. No. 59710); and isoviolanthrone pigments such as C.I. Pigment Violet 31 (C.I. No. 60010).

A combination of two or more organic pigments or organic pigment solid solutions may be used for the colorant.

In addition, any of the following may be used: particles composed of a core of e.g., silica, alumina or resin on the surface of which is fixed a dye or pigment, dyes that have been rendered into insoluble lakes, colored emulsions, and colored latexes. Resin-coated pigments may also be used. These are called microencapsulated pigments, and are commercially available from, for example, Dainippon Ink & Chemicals, Inc. and Toyo Ink Manufacturing Co., Ltd.

For a good balance of optical density and storage stability, the volume-average particle size of the pigment particles included in the liquid is preferably in a range of from 10 to 250 nm, and more preferably from 50 to 200 nm. Here, the volume-average particle size of the pigment particles may be measured by a particle size distribution analyzer such as the LB-500 manufactured by Horiba, Ltd.

A single colorant may be used alone or two or more colorants may be used in admixture. Differing colorants may be used for the respective droplets and liquids that are deposited, or the same colorant may be used.

### (Other Components)

Known additives and ingredients other than those described above may also be used in the ink and/or undercoat liquid in accordance with the intended purpose,

### Storage Stabilizer:

It is preferable to add a storage stabilizer to the ink and undercoat liquid (especially the ink) in order to inhibit undesirable polymerization during storage. It is desirable for the storage stabilizer to be used in the presence of a polymerizable or crosslinkable material. Also, it is advantageous for the storage stabilizer to be soluble in the droplet or liquid which includes it or in another ingredient present therein.

Exemplary storage stabilizers include quaternary ammonium salts, hydroxylamines, cyclic amides, nitrites, substituted ureas, heterocyclic compounds, organic acids, hydroquinone, hydroquinone monoethers, organic phosphines and copper compounds. Specific examples include benzyltrimethylammonium chloride, diethylhydroxylamine, benzothiazole, 4-amino-2,2,6,6-tetramethylpiperidine, citric acid, hydroquinone monomethyl ether, hydroquinone monobutyl ether and copper naphthenate.

It is preferable to suitably adjust the amount of storage stabilizer added based on the activity and polymerizability of the polymerization initiator or the polymerizability of the crosslinkable material, and on the type of storage stabilizer. However, for a good balance of storage stability and curability, it is advantageous to set the solids equivalent of the storage stabilizer in the liquid to from 0.005 to 1 wt %, more preferably from 0.01 to 0.5 wt %, and even more preferably from 0.01 to 0.2 wt %.

### Conductive Salts:

Conductive salts are solid compounds which enhance the electrical conductivity. In the practice of the invention, owing to the concern that deposition may occur during storage, it is preferable for substantially no conductive salt to be used. However, in cases where the solubility is good because the solubility of the conductive salt has been increased or a conductive salt having a high solubility in the liquid component is used, a suitable amount of conductive salt may be added.

Exemplary conductive salts include potassium thiocyanate, lithium nitrate, ammonium thiocyanate and dimethylamine hydrochloride.

### Solvents:

In the invention, a known solvent may be used if necessary. The solvent may be used for such purposes as to improve the polarity, viscosity and surface tension of the liquid (ink), to improve the solubility or dispersibility of the colored material, to adjust the electrical conductivity, and to adjust the printability.

For quick-drying properties and to record high-quality images having uniform line widths, it is preferable that the solvent be a water-insoluble liquid which contains no aqueous medium. Hence, a composition which uses a high-boiling organic solvent is desirable.

It is preferable for the high-boiling organic solvent to have an excellent compatibility with the components of the liquid, especially the monomer.

Specific examples of preferred solvents include tripropylene glycol monomethyl ether, dipropylene glycol monomethyl ether, propylene glycol monomethyl ether, ethylene glycol monobutyl ether, diethylene glycol monobutyl ether, triethylene glycol monobutyl ether, ethylene glycol monobenzyl ether and diethylene glycol monobenzyl ether.

Known solvents also include low-boiling organic solvents with boiling points of up to 100° C., However, owing to concerns over the adverse effects of solvents on curability and taking into account also environmental contamination by low-boiling organic solvents, it is desirable not to use such solvents. If a low-boiling organic solvent is used, the solvent is preferably a highly safe solvent. A “highly safe solvent” refers herein to a solvent having a high control level (the “control level” is an indicator used in the Working Environment Evaluation Standards issued by the Japanese Ministry of Health, Labor and Welfare) of preferably at least 100 ppm, and more preferably at least 200 ppm. Exemplary solvents of this type are alcohols, ketones, esters, ethers and hydrocarbons. Specific examples include methanol, 2-butanol, acetone, methyl ethyl ketone, ethyl acetate and tetrahydrofuran.

The solvent may be used singly or as combinations of two or more. When water and/or a low-boiling organic solvent are used, the amount in which both are used is preferably from 0 to 20 wt %, and more preferably from 0 to 10 wt %, based on each liquid (ink or undercoat liquid). The substantial absence of such solvents is especially preferred. The substantial absence of water in the ink and undercoat liquid used in the invention improves stability over time with respect to clouding of the liquid caused by, for example, a loss of homogeneity and dye deposition over time, and is also able to increase dryability when used on an impermeable or a slowly permeable recording medium. Here, “substantial absence” signifies that the presence of such solvent as an inadvertent impurity is allowable.

### Other Additives:

Use can also be made of known additives such as polymers, surface tension adjusters, ultraviolet light absorbers, antioxidants, discoloration inhibitors and pH adjusters.

Known compounds may be suitably selected and used as the surface tension adjusters, ultraviolet light absorbers, antioxidants, discoloration inhibitors and pH adjusters. For example, use may be made of the additives mentioned in JP 2001-181549 A.

In addition to the above, a pair of compounds which, when mixed, react to form an agglomerate or thicken may be separately included in the ink and undercoat liquid according to the invention. This pair of compounds has the characteristic of either rapidly forming an agglomerate or rapidly thickening the liquid, thereby more effectively inhibiting the coalescence of mutually neighboring droplets.

Examples of reactions between the pair of compounds include acid-base reactions, hydrogen bonding reactions between a carboxylic acid and an amide group-bearing compound, crosslinking reactions such as between boronic acid and a diol, and reactions involving electrostatic interactions between cations and anions.

Although embodiments of the ink-jet recording device of the present invention have been described for illustrative purposes, those skilled in the art will appreciate that various modifications and improvements are possible without departing from the scope and spirit of the invention as disclosed in the accompanying claims.

What is claimed is:

1. An ink-jet recording device comprising:
transport means for transporting a recording medium,
undercoating liquid applying means for applying an undercoating liquid to said recording medium transported by said trans-port means; and
image forming means that is disclosed downstream of said undercoating liquid applying means in a direction of travel by the recording medium, and has an ink-jet head which ejects an ink containing at least a colorant to form an image on said recording medium to which said undercoating liquid has been applied;
wherein said undercoating liquid applying means has a coating roll for applying the undercoating liquid to the recording medium, and a drive unit which rotates said coating roll in a direction opposite to the direction in which said transport means transports the recording medium.

2. The ink-jet recording device of claim 1, wherein said drive unit rotates said coating roll so as to satisfy a condition 0.5≦W/V≦5.0, where V is a velocity of travel in millimeters per second by said recording medium when passing through a position in proximity to said undercoating liquid applying means and W is a circumferential velocity in millimeters per second of said coating roll.

3. The ink-jet recording device of claim 1, wherein said coating roll has on a surface thereof recessed features which retain the undercoating liquid.

4. The ink-jet recording device of claim 1, further comprising positioning means which is disposed upstream or downstream or both upstream and downstream of said coating roll and on a side of the recording medium opposite to a side to be coated with said undercoating liquid, and which supports said recording medium from the side opposite to the side to be coated with said undercoating liquid.

5. The ink-jet recording device of claim 1, wherein said undercoating liquid is a liquid which cures on exposure to active energy rays, said device further comprising undercoating liquid semi-curing means which is disposed on a downstream side of said undercoating liquid applying means in the direction of travel by the recording medium, and which irradiates with active energy rays the undercoating liquid coated onto said recording medium so as to semi-cure the undercoating liquid coated onto said recording medium.

6. The ink-jet recording device of claim 5, wherein a travel distance X and a travel velocity V satisfy a relation X≦5V, where X is the travel distance in millimeters that said recording medium is transported by said transport means from an undercoating liquid applying position where said undercoating liquid applying means applies the undercoating liquid to an irradiation position where the undercoating liquid is irradiated with the active energy rays emitted by said undercoating liquid semi-curing means, and V is the velocity of travel in millimeters per second by the recording medium between said undercoating liquid applying position and said irradiation position owing to said transport means.

7. An ink-jet recording device comprising;
transport means for transporting a recording medium;
undercoating liquid applying means for applying an undercoating liquid to be cured by exposure to active energy rays onto one side of said recording medium which is transported by said transport means;
undercoating liquid semi-curing means which is disclosed downstream of said undercoating liquid applying means in a direction of travel by said recording medium, and which irradiates with the active energy rays said recording medium to which the undercoating liquid has been applied, thereby semi-curing the undercoating liquid applied to said recording medium; and
image forming means that is disposed downstream of said undercoating liquid semi-curing means in the direction of travel by the recording medium, and has an ink-jet head which ejects an ink containing at least a colorant to form an image on said recording medium to which the undercoating liquid has been applied:
wherein a travel distance X and a travel velocity V satisfy a relation X≦5V, where X is the travel distance in millimeters that said recording medium is transported by said transport means from an undercoating liquid applying position where said undercoating liquid applying means applies the undercoating liquid to an irradiation position where the undercoating liquid is irradiated with the active energy rays emitted by said undercoating liquid semi-curing means, and V is the velocity of travel in millimeters per second by the recording medium between said undercoating liquid applying position and said irradiation position owing to said transport means.

8. The ink-jet recording device of claim 7, wherein, when a liquid droplet having a viscosity of 10 mPa·s and a volume of 10 pL is deposited on said recording medium, a time required by an entire liquid droplet to pass through said recording medium is at least 100 Ms.

9. The ink-jet recording device of claims 7, further comprising shielding means which is disposed between said undercoating liquid applying means and said undercoating liquid semi-curing means, and shields against the active energy rays which are irradiated from said undercoating liquid semi-curing means toward said undercoating liquid applying means.

10. The ink-jet recording device of claim 1, wherein the ink ejected from said ink-jet head is an ink which cures on exposure to active energy rays, and wherein said image forming means further has image curing means which irradiates with the active energy rays the image formed on said recording medium and thereby cures the ink constituting said image.

11. The ink-jet recording device of claim 10, wherein said image forming means has at least two ink-jet heads which eject inks of differing colors, said device further comprising ink semi-curing means which is disposed between said at least two ink-jet heads, and semi-cures ink constituting an image formed by one of said at least two ink-jet heads disposed upstream from said ink semi-curing means in the direction of travel by the recording medium.

12. The ink-jet recording device of claim 1, wherein said undercoating liquid includes a radical-polymerizable composition.
